(19) United States
(12) Patent Application Publication
(10) Pub. No.: US 2026/0333327 A1
(43) Pub. Date: Oct. 22, 2026

(54) RESOURCE ALLOCATION METHOD AND COMMUNICATION APPARATUS

(71) Applicant: HUAWEI TECHNOLOGIES CO., LTD., Shenzhen (CN)

(72) Inventors: Dongdong Wei, Shenzhen (CN); Hao Tang, Shanghai (CN); Jianglei Ma, Ottawa (CA); Xi Zhang, Beijing (CN)

(21) Appl. No.: 19/464,791

(22) Filed: Jan. 30, 2026

Related U.S. Application Data
(63) Continuation of application No. PCT/CN2023/110403, filed on Jul. 31, 2023.

(51) Int. Cl. H04W 72/0453; H04W 72/23

(52) U.S. Cl. CPC H04W 72/0453; H04W 72/23

(57) ABSTRACT

A resource allocation method and a communication apparatus. A scaling factor of a frequency domain resource allocation unit is determined. A size of the frequency domain resource allocation unit is determined based on the scaling factor and a preconfigured size of the frequency domain resource allocation unit. A first apparatus determines the scaling factor, and determines the size of the frequency domain resource allocation unit based on the scaling factor and the preconfigured size of the frequency domain resource allocation unit to change an actual granularity of frequency domain resource allocation.

### CROSS-REFERENCE TO RELATED APPLICATIONS

This application is a continuation of International Application No. PCT/CN2023/110403, filed on Jul. 31, 2023, the disclosure of which is hereby incorporated by reference in its entirety.

### TECHNICAL FIELD

This application relates to the communication field, and in particular, to a resource allocation method and a communication apparatus.

### BACKGROUND

When sending and receiving data, a terminal device needs to first determine a transport block size (TBS), to correctly perform encoding and decoding. The terminal device may receive a resource allocation indication from a network device, and determine an allocated time-frequency resource, to determine the TBS based on the allocated time-frequency resource.

Currently, the 3rd generation partnership project (3GPP) defines two types of resource allocation modes: a resource allocation type 0 and a resource allocation type 1. However, the resource allocation modes do not meet further requirements of services.

### SUMMARY

Embodiments of this application provide a resource allocation method and a communication apparatus, to avoid a waste of an allocated resource or reduce indication overheads for frequency domain resource allocation, and therefore meet a further requirement of a service for reliability.

To achieve the foregoing objective, this application uses the following technical solutions.

According to a first aspect, a resource allocation method is provided. The method may be performed by a first apparatus, may be performed by a component of the first apparatus, for example, a processor, a chip, or a chip system of the first apparatus, or may be implemented by a logical module or software that can implement all or a part of functions of the first apparatus. An example in which the method is performed by the first apparatus is used below for description. The method includes: determining a scaling factor of a frequency domain resource allocation unit, and determining a size of the frequency domain resource allocation unit based on the scaling factor and a preconfigured size of the frequency domain resource allocation unit.

In this embodiment of this application, the first apparatus may determine the scaling factor, and determine the size of the frequency domain resource allocation unit based on the scaling factor and the preconfigured size of the frequency domain resource allocation unit, so that an actual granularity of frequency domain resource allocation can be changed, to improve flexibility of the frequency domain resource allocation. Further, the flexibility of the frequency domain resource allocation is improved, so that a waste of an allocated resource can be avoided, or indication overheads for the frequency domain resource allocation can be reduced, to meet a further requirement of a service for reliability. Therefore, the further requirement of the service can be met according to the resource allocation method provided in this embodiment of this application.

With reference to the first aspect, in a possible implementation, the first apparatus may be a terminal device or a module or unit of the terminal device. For example, the first apparatus may be a chip, a chip system, a chip circuit, or a circuit of the terminal device. To be specific, when receiving a frequency domain resource allocation indication from a network, the first apparatus may determine the scaling factor of the frequency domain resource allocation unit, and determine the actual granularity of the frequency domain resource allocation based on the scaling factor and the preconfigured size of the frequency domain resource allocation unit.

With reference to the first aspect, in a possible implementation, the scaling factor is preconfigured, or the scaling factor is indicated. In other words, the scaling factor may be agreed on in a protocol. In this way, indication overheads for the scaling factor can be reduced. Alternatively, the scaling factor may be indicated by the network, so that the network can flexibly adjust the actual granularity of the frequency domain resource allocation based on a requirement of a service. For example, service types in the network include a small data service and a large data service, and the network may indicate a value range of the scaling factor based on the service type, to flexibly adjust the actual granularity of the frequency domain resource allocation. For example, when the service type is the small data service, the network may indicate a scaling factor for scaling down a preconfigured granularity of the frequency domain resource allocation; or when the service type is the large data service, the network may indicate a scaling factor for scaling up a preconfigured granularity of the frequency domain resource allocation. It may be understood that the scaling factor may alternatively be negotiated between the first apparatus and the network. For example, the first apparatus and a network device may negotiate a specific value of the scaling factor.

With reference to the first aspect, in a possible implementation, determining the scaling factor of the frequency domain resource allocation unit includes: determining the scaling factor from a candidate scaling factor set based on a configured frequency range FR and/or a configured subcarrier spacing SCS, where the candidate scaling factor set includes at least two scaling factors. The configured FR and/or SCS may be configured by the network. For example, the network device may configure the FR and/or the SCS for the first apparatus. The FR may fall within FR1, FR2, or FR2-2. The SCS may be 15 kHz, 30 kHz, 60 kHz, 120 kHz, or 240 kHz. The candidate scaling factor set may be preconfigured. For example, one or more candidate scaling factor sets may be predefined in a protocol. The scaling factors in the candidate scaling factor set include at least one of the following types of scaling factors: a scaling factor for scaling up the preconfigured granularity of the frequency domain resource allocation, a scaling factor for scaling down the preconfigured granularity of the frequency domain resource allocation, or a scaling factor for not changing the preconfigured granularity of the frequency domain resource allocation. In other words, the first apparatus may select an appropriate scaling factor from the candidate scaling factor set based on the configured FR and/or the configured SCS, so that the granularity of the frequency domain resource allocation matches the service requirement.

With reference to the first aspect, in a possible implementation, determining the scaling factor from the candidate scaling factor set based on the configured FR and/or the configured SCS includes: determining the scaling factor from the candidate scaling factor set based on a correspondence between the FR and the scaling factor and/or a correspondence between the SCS and the scaling factor. For example, when the scaling factor is a ratio between the actual granularity of the frequency domain resource allocation and the preconfigured granularity of the frequency domain resource allocation, a scaling factor corresponding to FR1 is less than a scaling factor corresponding to FR2, and the scaling factor corresponding to FR2 is less than a scaling factor corresponding to FR2-2. For another example, when the SCS is less than or equal to 60 kHz, a corresponding scaling factor is 1, and a larger SCS indicates a larger value of the scaling factor. In other words, the first apparatus may further select a more appropriate scaling factor from the candidate scaling factor set based on the correspondence between the FR and the scaling factor and/or the correspondence between the SCS and the scaling factor, so that the granularity of the frequency domain resource allocation better matches the requirement of the service.

According to a second aspect, a resource allocation method is provided. The method may be performed by a second apparatus, may be performed by a component of the second apparatus, for example, a processor, a chip, or a chip system of the second apparatus, or may be implemented by a logical module or software that can implement all or a part of functions of the second apparatus. An example in which the method is performed by the second apparatus is used below for description. The method includes: determining a size of a frequency domain resource allocation unit; generating indication information, where the indication information indicates a scaling factor of the frequency domain resource allocation unit; and sending the indication information.

In this embodiment of this application, the second apparatus may flexibly indicate the scaling factor of the frequency domain resource allocation unit based on a service type, so that a receiver of the indication information determines the size of the frequency domain resource allocation unit based on the scaling factor and a preconfigured size of the frequency domain resource allocation unit, to change an actual granularity of frequency domain resource allocation, and therefore improve flexibility of the frequency domain resource allocation. Further, the flexibility of the frequency domain resource allocation is improved, so that a waste of an allocated resource can be avoided, or indication overheads for the frequency domain resource allocation can be reduced, to meet a further requirement of a service for reliability. Therefore, the further requirement of the service can be met according to the resource allocation method provided in this embodiment of this application.

With reference to the second aspect, in a possible implementation, the second apparatus may be a network device or a module or unit of the network device. For example, the second apparatus may be a chip, a chip system, a chip circuit, or a circuit of the network device. It should be understood that the second apparatus may select, based on the service type, network load, or the like, a scaling factor for scaling up a preconfigured granularity of the frequency domain resource allocation or a scaling factor for scaling down the preconfigured granularity of the frequency domain resource allocation, to flexibly adjust the actual granularity of the frequency domain resource allocation.

With reference to the second aspect, in a possible implementation, the indication information includes first indication information and second indication information, the first indication information indicates a candidate scaling factor set, the second indication information is for determining the scaling factor from the candidate scaling factor set, and the candidate scaling factor set includes at least two scaling factors. The candidate scaling factor set may be configured by a network by using higher layer signaling, and the higher layer signaling may be radio resource control RRC signaling. When the scaling factor is a ratio between the actual granularity of the frequency domain resource allocation and the preconfigured granularity of the frequency domain resource allocation, the candidate scaling factor set may be [1, 4, 8], [1, 2, 4, 8], [0.5, 1], [0.25, 1], [0.125, 1], [0.25, 0.5, 1, 2, 4], [0.25, 0.5, 1, 2, 4, 8], or the like. Certainly, the first indication information may alternatively indicate a plurality of candidate scaling factor sets. Further, the second indication information may include an ID or an index of the scaling factor in the candidate scaling factor set. The ID of the scaling factor in the candidate scaling factor set may be agreed on in a protocol. For example, in the candidate scaling factor set [1, 2, 4, 8], it may be agreed on in the protocol that an ID corresponding to the scaling factor 1 is an ID 1, an ID corresponding to the scaling factor 2 is an ID 2, and so on. In this way, a value of a scaling factor corresponding to an ID in the candidate scaling factor set may be determined based on the ID. Alternatively, an index corresponding to each scaling factor in the candidate scaling factor set may be agreed on in a protocol. For example, in the candidate scaling factor set [1, 2, 4, 8], an index corresponding to the scaling factor 1 is #1, and an index corresponding to the scaling factor 2 is #2. In this way, a scaling factor corresponding to an index in the candidate scaling factor set may be determined based on the index. It may be understood that, alternatively, a bit sequence may be agreed on in a protocol to indicate the scaling factor in the candidate scaling factor set. For example, in the candidate scaling factor set [1, 2, 4, 8], a bit sequence 00 may indicate 1, a bit sequence 01 may indicate 2, a bit sequence 10 may indicate 4, and a bit sequence 11 may indicate 8. Certainly, a bit sequence having more bits may indicate the scaling factor. For example, a bit sequence 000 indicates 1. Alternatively, the second indication information may implicitly indicate the scaling factor in the candidate scaling factor set. For example, the second indication information may be the indication overheads for the frequency domain resource allocation. It may be understood that when a size of a bandwidth part BWP is determined, a length of a bitmap (for example, bit overheads of a frequency domain resource assignment FDRA field) indicating an allocated resource block group RBG varies with the scaling factor. Therefore, the scaling factor may be determined from the candidate scaling factor set by using bit overheads of indication information for the frequency domain resource allocation in downlink control information DCI. In other words, the second apparatus may configure the candidate scaling factor set by using the first indication information, and indicate the specific scaling factor in the candidate scaling factor set by using the second indication information, to indicate the scaling factor, so that overheads of the second indication information can be reduced, to improve reliability of the second indication information.

With reference to the second aspect, in a possible implementation, the first indication information is carried in RRC signaling, and the second indication information is carried in DCI or a media access control control element MAC CE. To be specific, the candidate scaling factor set may be configured by using the RRC signaling, to increase effective duration of the configured candidate scaling factor set; and the second indication information may be carried in the DCI or the MAC CE, so that the scaling factor can be dynamically indicated. Therefore, this is applicable to a service scenario in which the actual granularity of the frequency domain resource allocation is frequently changed in an RRC connection period.

With reference to the second aspect, in a possible implementation, the second indication information is carried in 2^{nd}-stage DCI. It should be understood that when the scaling factor is indicated by the DCI, 2-stage DCI may be used for indication. The 2-stage DCI includes 1^{st}-stage DCI and the 2^{nd}-stage DCI, and the 1^{st}-stage DCI indicates a time-frequency resource position for receiving the 2^{nd}-stage DCI. In other words, the time-frequency resource position for the 2^{nd}-stage DCI may be determined by using the 1^{st}-stage DCI, to avoid blind detection performed by a first apparatus on the 2^{nd}-stage DCI. Further, the second indication information is carried in the 2^{nd}-stage DCI, so that a volume of data carried in the 2^{nd}-stage DCI can be reduced. To be specific, the second indication information is carried in the 2^{nd}-stage DCI, so that blind detection complexity of obtaining the second indication information by the first apparatus can be reduced, to reduce power consumption.

With reference to the second aspect, in a possible implementation, the indication information is carried in an RRC setup message, an RRC resume message, or an RRC reconfiguration message. To be specific, the scaling factor indicated by the indication information may remain effective in an RRC connection period, and the scaling factor does not need to be indicated during each time of scheduling. This is applicable to a service scenario in which the scaling factor does not need to be frequently changed in the RRC connection period but the actual granularity of the frequency domain resource allocation is changed by using RRC signaling due to movement, energy saving, a service requirement change, or the like. For example, during initial access or location update of the first apparatus, the first apparatus may set up an RRC connection to the second apparatus, and the second apparatus may include the indication information in the RRC setup message or the RRC reconfiguration message, to indicate the scaling factor to the first apparatus. In other words, the scaling factor indicated by the RRC setup message may be used in the RRC connection period to perform frequency domain resource allocation. For another example, the first apparatus may enter an RRC inactive (RRC_INACTIVE) state from an RRC connected (RRC_CONNECTED) state due to a current service cause, an energy saving requirement, or the like. Therefore, when the first apparatus resumes an RRC connection, the second apparatus may include the indication information in the RRC resume message, to indicate the scaling factor to the first apparatus. For still another example, due to poor radio link quality, a handover, or the like, the first apparatus and the second apparatus may re-establish an RRC connection through an RRC reconfiguration procedure, and the second apparatus may include the indication information in the RRC reconfiguration message, to indicate the scaling factor to the first apparatus.

With reference to the first aspect or the second aspect, in a possible implementation, the size of the frequency domain resource allocation unit is a granularity of frequency domain resource allocation, and the scaling factor is for determining a ratio between an actual granularity of the frequency domain resource allocation and a preconfigured granularity of the frequency domain resource allocation. In other words, the ratio between the actual granularity of the frequency domain resource allocation and the preconfigured granularity of the frequency domain resource allocation may be determined based on the scaling factor and the preconfigured granularity of the frequency domain resource allocation. That is, the actual granularity of the frequency domain resource allocation is a value obtained by scaling up or scaling down the preconfigured granularity of the frequency domain resource allocation. For example, the scaling factor may be a logarithmic value of the actual granularity with a base of the preconfigured granularity of the frequency domain resource allocation, in other words, the ratio between the actual granularity of the frequency domain resource allocation and the preconfigured granularity of the frequency domain resource allocation may be determined by using n=logₚ P′·n is the scaling factor, P′ is the actual granularity of the frequency domain resource allocation, namely, the size of the frequency domain resource allocation unit, and P is the preconfigured granularity of the frequency domain resource allocation, namely, the preconfigured size of the frequency domain resource allocation unit. It may be understood that, according to n=logₚ P′, it may be determined that the ratio between the actual granularity of the frequency domain resource allocation and the preconfigured granularity of the frequency domain resource allocation is Pⁿ⁻¹. In other words, the actual granularity of the frequency domain resource allocation is P′=P″. For another example, the scaling factor may alternatively be a logarithmic value of a ratio of P′ to P with a base of 2, in other words, the ratio between the actual granularity of the frequency domain resource allocation and the preconfigured granularity of the frequency domain resource allocation may be determined by using

$$n = {log}_{2} \frac{{P}^{′}}{P} .$$

The actual granularity of the frequency domain resource allocation is P′=P·2″. In other words, an adjustment amplitude of the ratio of P′ to P is 2ⁿ. It should be understood that the actual granularity P′ of the frequency domain resource allocation may be a rounded value. The rounded value may be a ceiling value or a floor value.

With reference to the first aspect or the second aspect, in a possible implementation, the size of the frequency domain resource allocation unit is a granularity of frequency domain resource allocation, and the scaling factor is a ratio between an actual granularity of the frequency domain resource allocation and a preconfigured granularity of the frequency domain resource allocation. In other words, a ratio of scaling up or scaling down the preconfigured granularity of the frequency domain resource allocation may be determined based on the scaling factor and the preconfigured granularity of the frequency domain resource allocation, to determine the actual granularity of the frequency domain resource allocation. That is, the preconfigured size of the frequency domain resource allocation unit is scaled up or scaled down by using the scaling factor, to flexibly adjust the size of the frequency domain resource allocation unit. For example,

$$n = \frac{{P}^{′}}{P} ,$$

and the actual granularity of the frequency domain resource allocation is P′=P·n, where P′ may be a ceiling value or a floor value of P·n. For another example,

$$n = \frac{P}{{P}^{′}} ,$$

and the actual granularity

$${P}^{′} = \frac{P}{n} ,$$

of the frequency domain resource allocation is where P′ may be a ceiling value or a floor value of P/n.

With reference to the first aspect or the second aspect, in a possible implementation, the frequency domain resource allocation unit is a resource block RB or an RBG. To be specific, the preconfigured size of the frequency domain resource allocation unit may be an original RBG size or an original RB size. Therefore, when the frequency domain resource allocation is performed at a granularity of the RBG (to be specific, in a case corresponding to a resource allocation type 0), or the frequency domain resource allocation is performed at a granularity of the RB (to be specific, in a case corresponding to a resource allocation type 1), the original RBG size or the original RB size may be scaled up or scaled down by using the scaling factor to obtain an RBG size or an RB size, to flexibly adjust the granularity of the frequency domain resource allocation, and improve the flexibility of the frequency domain resource allocation.

With reference to the first aspect or the second aspect, in a possible implementation, the frequency domain resource allocation unit includes an RBG and an RB. In other words, an RBG size and an RB size may be both scaled up or scaled down by using the scaling factor.

With reference to the first aspect or the second aspect, in a possible implementation, a value of the scaling factor is greater than 1. To be specific, when the scaling factor is the ratio between the actual granularity of the frequency domain resource allocation and the preconfigured granularity of the frequency domain resource allocation, if the scaling factor is greater than 1, the preconfigured granularity of the frequency domain resource allocation, for example, the original RBG size or the original RB size, may be scaled up, so that the actual granularity of the frequency domain resource allocation becomes larger. Further, the actual granularity of the frequency domain resource allocation becomes larger, so that the indication overheads for the frequency domain resource allocation can be reduced, to improve reliability of the indication overheads (for example, the DCI) for the frequency domain resource allocation and a channel (for example, a physical downlink control channel PDCCH) that carries the indication overheads for the frequency domain resource allocation.

With reference to the first aspect or the second aspect, in a possible implementation, a value of the scaling factor is less than 1. To be specific, when the scaling factor is the ratio between the actual granularity of the frequency domain resource allocation and the preconfigured granularity of the frequency domain resource allocation, if the scaling factor is less than 1, the preconfigured granularity of the frequency domain resource allocation, for example, the original RBG size or the original RB size, may be scaled down, so that the actual granularity of the frequency domain resource allocation becomes smaller. Further, the actual granularity of the frequency domain resource allocation becomes smaller, so that the actual granularity is applicable to, for example, a small data service, to avoid the waste of the allocated resource, and improve network quality.

According to a third aspect, a resource allocation method is provided. The method may be performed by a first apparatus, may be performed by a component of the first apparatus, for example, a processor, a chip, or a chip system of the first apparatus, or may be implemented by a logical module or software that can implement all or a part of functions of the first apparatus. An example in which the method is performed by the first apparatus is used below for description. The method includes: receiving indication information, and determining a size of a frequency domain resource allocation unit based on the indication information. The indication information indicates that the size of the frequency domain resource allocation unit is a rounded value of a ratio of a size of a BWP to N, and Nis an integer greater than or equal to 1.

For technical effects of the third aspect, refer to the first aspect. Details are not described herein again.

According to a fourth aspect, a resource allocation method is provided. The method may be performed by a second apparatus, may be performed by a component of the second apparatus, for example, a processor, a chip, or a chip system of the second apparatus, or may be implemented by a logical module or software that can implement all or a part of functions of the second apparatus. An example in which the method is performed by the second apparatus is used below for description. The method includes: generating indication information, and sending the indication information. The indication information indicates that a size of a frequency domain resource allocation unit is a rounded value of a ratio of a size of a BWP to N, and Nis an integer greater than or equal to 1.

For technical effects of the fourth aspect, refer to the second aspect. Details are not described herein again.

With reference to the third aspect or the fourth aspect, in a possible implementation, the BWP may be an initial BWP or an active BWP. For example, when an RRC connection has not been set up between the second apparatus and the first apparatus, for example, during initial access, the BWP may be an initial BWP corresponding to a control resource set (CORSET) 0 or an initial BWP configured in remaining minimum system information (RMSI). For another example, in a period in which an RRC connection has been set up between the second apparatus and the first apparatus, the BWP may be an active BWP. It may be understood that the first apparatus may be a terminal device or a module or unit of the terminal device. For example, the first apparatus may be a chip, a chip system, a chip circuit, or a circuit of the terminal device. The second apparatus may be a network device or a module or unit of the network device. For example, the second apparatus may be a chip, a chip system, a chip circuit, or a circuit of the network device. It may be further understood that the rounded value of the ratio of the size of the BWP to N may be a ceiling value or a floor value. For example, when the size of the BWP is 275 RBs, and N is 2, the rounded value of the ratio of the size of the BWP to N may be [275/2]=138 or [275/2]=137. In this way, a frequency domain resource may be divided into two segments, where a granularity of one segment is 137 RBs, and a granularity of the other segment is 138 RBs. In other words, in this embodiment of this application, the BWP may be divided into N segments, and a granularity of frequency domain resource allocation is approximately 1/N of the size of the BWP. If a value of N is large, the granularity of the frequency domain resource allocation is small, and is applicable to a small data service, to avoid a waste of an allocated resource. If a value of N is small, the granularity of the frequency domain resource allocation is large, and is applicable to an application scenario with a small quantity of served terminal devices, to reduce indication overheads for the frequency domain resource allocation, and further improve reliability.

With reference to the third aspect or the fourth aspect, in a possible implementation, that the indication information indicates that the size of the frequency domain resource allocation unit is the rounded value of the ratio of the size of the BWP to N includes: The indication information indicates that a frequency domain resource allocation type is a first resource allocation type, and a size that is of the frequency domain resource allocation unit and that corresponds to the first resource allocation type is the rounded value of the ratio of the size of the BWP to N. To be specific, a new resource allocation type may be agreed on in a protocol on a basis of a resource allocation type 0 and a resource allocation type 1, and a granularity that is of the frequency domain resource allocation and that corresponds to the new resource allocation type is the rounded value of the ratio of the size of the BWP to N. It should be understood that a frequency domain resource allocation unit (namely, a granularity of frequency domain resource allocation) corresponding to the first resource allocation type may be referred to as a fraction-bandwidth part (fraction-BWP, F-BWP). Certainly, the F-BWP is merely an example of a name. The frequency domain resource allocation unit corresponding to the first resource allocation type may alternatively have another name. This is not specifically limited in embodiments of this application. Further, the first resource allocation type may also be referred to as a resource allocation type 2. Certainly, the resource allocation type 2 is merely an example, and the first resource allocation type may alternatively have another name, for example, a resource allocation type 3. This is not specifically limited in embodiments of this application. For example, it may be agreed on in a protocol that uplink frequency domain resource allocation and the downlink frequency domain resource allocation support the following three resource allocation types:
1. resource allocation type 0: frequency domain resource allocation is performed based on an RBG in the resource allocation type;
2. resource allocation type 1: frequency domain resource allocation is performed based on an RB in the resource allocation type; and
3. first resource allocation type: frequency domain resource allocation is performed based on the F-BWP in the resource allocation type.

With reference to the third aspect or the fourth aspect, in a possible implementation, the frequency domain resource allocation unit is an RBG, and that the indication information indicates that the size of the frequency domain resource allocation unit is the rounded value of the ratio of the size of the BWP to N includes: The indication information indicates that a configuration of the RBG is a first configuration, and an RBG size corresponding to the first configuration is the rounded value of the ratio of the size of the BWP to N. In other words, a new RBG configuration may be agreed on in a protocol on a basis of the resource allocation type 0, and an RBG size corresponding to the new RBG configuration is the rounded value of the ratio of the size of the BWP to N. It may be understood that a newly added RBG configuration, namely, the first configuration, may be agreed on in a protocol on a basis of an RBG configuration 1 and an RBG configuration 2. For example, as enumerated in Table A, N=2, and the RBG size corresponding to the first configuration is a ceiling value of the ratio of the size of the BWP to 2.

TABLE A

| Size of the | RBG | RBG | First |
|---|---|---|---|
| BWP (quantity | configuration 1 | configuration 2 | configuration |
| of RBs) | (quantity of RBs) | (quantity of RBs) | (quantity of RBs) |
| 1 to 36 | 2 | 4 | ceil(BWP/2) |
| 37 to 72 | 4 | 8 | ceil(BWP/2) |
| 73 to 144 | 8 | 16 | ceil(BWP/2) |
| 145 to 275 | 16 | 16 | ceil(BWP/2) |

It should be understood that the foregoing table is merely an example, and N may alternatively be another value, for example, 1, 3, 4, or 5. In addition, different size ranges of the BWP in the foregoing table may correspond to different values of N. For example, when the size of the BWP is 1 to 36 RBs, the range corresponds to ceil (BWP/2); or when the size of the BWP is 37 to 72 RBs, the range corresponds to ceil (BWP/4). This is not specifically limited.

It should be further understood that the first configuration may also be referred to as an RBG configuration 3. Certainly, the RBG configuration 3 is merely an example, and the first configuration may alternatively have another name. This is not specifically limited in embodiments of this application.

With reference to the third aspect or the fourth aspect, in a possible implementation, the frequency domain resource allocation unit is an RBG, and that the indication information indicates that the size of the frequency domain resource allocation unit is the rounded value of the ratio of the size of the BWP to N includes: The indication information indicates that a type of the RBG is a first type, and an RBG size corresponding to the first type is the rounded value of the ratio of the size of the BWP to N. In other words, a new RBG type may be agreed on in a protocol on a basis of the resource allocation type 0, and an RBG size corresponding to the new RBG type is the rounded value of the ratio of the size of the BWP to N. It may be understood that it may be agreed on in a protocol that RBGs in the resource allocation type 0 include two RBG types: a type corresponding to an original RBG and the new RBG type, namely, the first type. For example, the type corresponding to the original RBG may be referred to as an RBG type 1, and the first type may be referred to as an RBG type 2. The RBG type 2 may include at least one RBG configuration, and different RBG configurations may correspond to different values of N. For example, table B enumerates that in the RBG type 2, an RBG size corresponding to an RBG configuration 1 is ceil (BWP/2), and an RBG size corresponding to an RBG configuration 2 is ceil (BWP/4).

TABLE B

| Size of the BWP | RBG configuration 1 | RBG configuration 2 |
|---|---|---|
| (quantity of RBs) | (quantity of RBs) | (quantity of RBs) |
| 1 to 275 | ceil(BWP/2) | ceil(BWP/4) |

It should be understood that the foregoing table is merely an example, and N may alternatively be another value, for example, 1, 3, 4, or 5. In addition, different size ranges of the BWP in the foregoing table may correspond to different values of N. For example, when the size of the BWP is 1 to 36 RBs, the range corresponds to ceil (BWP/2); or when the size of the BWP is 37 to 72 RBs, the range corresponds to ceil (BWP/4). This is not specifically limited. Further, the RBG type 2 may alternatively include one RBG configuration, or may include three, four, or more configurations. This is not specifically limited in this embodiment of this application.

It should be further understood that the RBG type 1 and the RBG type 2 are examples of names, and the type corresponding to the original RBG and the first type may have other names. For example, the original RBG may alternatively be referred to as an RBG definition type 1 or an RBG type 0, and the first type may alternatively be referred to as an RBG definition type 1 or an RBG type 1. This is not specifically limited in embodiments of this application.

With reference to the third aspect or the fourth aspect, in a possible implementation, a size of a 1^{st} RBG within the BWP is the same as a size of an RBG other than a last RBG and the 1^{st} RBG within the BWP. To be specific, when the RBG size is the rounded value of the ratio of the size of the BWP to N, determining of the size of the 1^{st} RBG within the BWP is irrelevant to a frequency domain start position of the BWP, and the size of the 1^{st} RBG may be the same as a size of a middle RBG.

With reference to the third aspect, in a possible implementation, the method according to the third aspect further includes: receiving resource allocation indication information. The resource allocation indication information includes first resource allocation indication information and second resource allocation indication information, the first resource allocation indication information indicates a candidate time-frequency resource set, and the second resource allocation indication information is for determining an allocated time-frequency resource from the candidate time-frequency resource set. A frequency domain resource in the candidate time-frequency resource set is a frequency domain resource determined based on the size of the frequency domain resource allocation unit.

With reference to the fourth aspect, in a possible implementation, the method according to the fourth aspect further includes: sending resource allocation indication information. The resource allocation indication information includes first resource allocation indication information and second resource allocation indication information, the first resource allocation indication information indicates a candidate time-frequency resource set, and the second resource allocation indication information is for determining an allocated time-frequency resource from the candidate time-frequency resource set. A frequency domain resource in the candidate time-frequency resource set is a frequency domain resource determined based on the size of the frequency domain resource allocation unit.

In other words, during resource allocation indication, the candidate time-frequency resource set may be configured by using the first resource allocation indication information, and a specific time-frequency resource in the candidate time-frequency resource set may be indicated by the second resource allocation indication information, so that both a frequency domain resource and a time domain resource can be indicated by one field, to reduce indication overheads for resource allocation and improve reliability.

For example, the candidate time-frequency resource set may include a plurality of time-frequency resources (or referred to as a plurality of groups of time-frequency resources), and each of the plurality of time-frequency resources may include a timing parameter, a time domain mapping type, an indication parameter for time domain resource allocation, and an indication parameter for frequency domain resource allocation. The timing parameter may be a slot offset k0 (for a downlink direction) or k2 (for an uplink direction) in “time domain resource allocation” below, the time domain mapping type may be a mapping type A or a mapping type B, and the indication parameter for the time domain resource allocation may be an SLIV. Further, the indication parameter for the frequency domain resource allocation may indicate at least one of the N segments of frequency domain resources within the BWP. It may be understood that because the size of the frequency domain resource allocation unit is the rounded value of the ratio of the size of the BWP to N, the BWP may be divided into the N segments, so that during the frequency domain resource allocation, only a specific segment or specific segments in the N segments need to be indicated as an allocated frequency domain resource. In other words, there are 2^{N}−1 selections in a possible selection set corresponding to the allocated frequency domain resource, and the indication overheads for the frequency domain resource allocation are N bits.

With reference to the third aspect or the fourth aspect, in a possible implementation, the first resource allocation indication information is carried in radio resource control RRC signaling, and the second resource allocation indication information is carried in downlink control information DCI. In other words, the candidate time-frequency resource set may be configured by using the RRC signaling, to be specific, the first resource allocation indication information is sent once to make the candidate time-frequency resource set effective in an RRC connection period. In this way, during each time of resource allocation, the second resource allocation indication information may be sent by using the DCI to complete time-frequency resource allocation, to reduce the indication overheads for the resource allocation and improve the reliability.

According to a fifth aspect, an information receiving method is provided. The method may be performed by a first apparatus, may be performed by a component of the first apparatus, for example, a processor, a chip, or a chip system of the first apparatus, or may be implemented by a logical module or software that can implement all or a part of functions of the first apparatus. An example in which the method is performed by the first apparatus is used below for description. The method includes: receiving indication information, and determining, based on the indication information, whether there is a demodulation reference signal DMRS in a time domain unit scheduled by using the indication information. The indication information indicates whether there is a DMRS in the time domain unit scheduled by using the indication information.

In this embodiment of this application, the first apparatus may receive the indication information, and determine, based on the indication information, whether there is a DMRS in the time domain unit scheduled by using the indication information. In other words, there may be or may not be a DMRS in the scheduled time domain unit. This can improve flexibility of a DMRS design. Further, the flexibility of the DMRS design is improved, so that DMRS redundancy can be avoided, and time domain resource utilization during data transmission is improved, to meet a further requirement of a service for a data transmission rate. Therefore, the further requirement of the service can be met according to the information receiving method provided in this embodiment of this application.

According to a sixth aspect, an information sending method is provided. The method may be performed by a second apparatus, may be performed by a component of the second apparatus, for example, a processor, a chip, or a chip system of the second apparatus, or may be implemented by a logical module or software that can implement all or a part of functions of the second apparatus. An example in which the method is performed by the second apparatus is used below for description. The method includes: generating indication information, and sending the indication information. The indication information indicates whether there is a DMRS in a time domain unit scheduled by using the indication information.

In this embodiment of this application, the second apparatus may send the indication information, so that a receiver of the indication information can determine, based on the indication information, whether there is a DMRS in the time domain unit scheduled by using the indication information. In other words, there may be or may not be a DMRS in the scheduled time domain unit. This can improve flexibility of a DMRS design. Further, the flexibility of the DMRS design is improved, so that DMRS redundancy can be avoided, and time domain resource utilization during data transmission is improved, to meet a further requirement of a service for a data transmission rate. Therefore, the further requirement of the service can be met according to the information sending method provided in this embodiment of this application.

With reference to the fifth aspect or the sixth aspect, in a possible implementation, the indication information may be carried in DCI, or the indication information may be a field in DCI. One time domain unit is scheduled by using the DCI. The time domain unit may be a slot. It may be understood that, as evolution occurs, the time domain unit may alternatively be a time unit, for example, a non-slot, with a granularity smaller than the slot; or the time domain unit may be a time unit, for example, a subframe, with a granularity greater than the slot. This is not specifically limited in embodiments of this application. Further, the DCI includes a field indicating whether there is a DMRS (DMRS on/off), in other words, the field indicates whether there is a DMRS in the scheduled time domain unit. That is, there may be or may not be a DMRS in the scheduled slot or non-slot, so that the flexibility of the DMRS design can be improved. Further, the flexibility of the DMRS design is improved, so that the DMRS redundancy can be avoided, and the time domain resource utilization during the data transmission is improved, to meet the further requirement of the service for the data transmission rate.

With reference to the fifth aspect or the sixth aspect, in a possible implementation, that the indication information indicates whether there is a DMRS in the time domain unit scheduled by using the indication information includes: The indication information indicates that there is a DMRS every K time domain units in Y time domain units scheduled by using the indication information, where K is an integer greater than 1, and Y is an integer greater than K. In other words, when the indication information is for scheduling a plurality of time domain units, the indication information may indicate that the DMRS is distributed in a comb pattern in the plurality of slots, that is, there is no DMRS in a part of slots. In this way, the flexibility of the DMRS design can be further improved. It may be understood that, that there is a DMRS every K time domain units may mean: There is a DMRS in an i^{th} time domain unit in the K time domain units, where 1≤i≤K. i may be agreed on in a protocol, may be negotiated between the first apparatus and the second apparatus in advance, or may be indicated by the second apparatus. This is not specifically limited in this embodiment of this application. It should be understood that, that there is a DMRS every K time domain units in the Y time domain units may be replaced with: There is a DMRS at an interval of j time domain units in the Y time domain units, where 1≤j<Y. In other words, K may be equal to j+1. It may be understood that K may also represent a comb parameter.

With reference to the fifth aspect or the sixth aspect, in a possible implementation, the indication information includes first indication information and second indication information, the first indication information indicates a candidate scheduling configuration set, and the second indication information is for determining Y and K from the candidate scheduling configuration set. For example, the candidate scheduling configuration set may include a plurality of scheduling configurations. Each of the plurality of scheduling configurations may include the Y scheduled time domain units and a value of K. The Y time domain units may be Y scheduled slots, and the value of K may indicate spaced distribution of the DMRS in time domain. In other words, the candidate scheduling configuration set may be first configured by using the first indication information, and then the second indication information indicates that there is a DMRS every K time domain units in the Y scheduled time domain units. In this way, indication overheads can be reduced.

With reference to the fifth aspect or the sixth aspect, in a possible implementation, the first indication information is carried in RRC signaling, and the second indication information is carried in DCI. In other words, the candidate scheduling configuration set may be configured by using the RRC signaling, to be specific, the first indication information is sent once to make the candidate scheduling configuration set effective in an RRC connection period. In this way, during each time of scheduling, the DCI may indicate that there is a DMRS every K time domain units in the Y time domain units, to reduce indication overheads and improve reliability.

With reference to the fifth aspect or the sixth aspect, in a possible implementation, the indication information further indicates that there is a DMRS every M frequency domain units in S frequency domain units scheduled by using the indication information, where M is an integer greater than 1, and S is an integer greater than M. For example, the frequency domain unit may be an RBG, an RB, or an F-BWP. It may be understood that, that there is a DMRS every M frequency domain units may mean: There is a DMRS in an r^{th} frequency domain unit in the M frequency domain units, where 1≤r≤M. r may be agreed on in a protocol, may be negotiated between the first apparatus and the second apparatus in advance, or may be indicated by the second apparatus. This is not specifically limited in this embodiment of this application. It should be understood that, that there is a DMRS every M frequency domain units in the S frequency domain units may be replaced with: There is a DMRS at an interval of t frequency domain units in the S frequency domain units, where 1≤t<S. In other words, M may be equal to t+1.

In other words, the indication information may indicate comb-pattern distribution of the DMRS in a plurality of RBs, that is, there is no DMRS in a part of RBs. In this way, the flexibility of the DMRS design can be further improved, and frequency domain resource utilization during the data transmission can be improved.

With reference to the fifth aspect or the sixth aspect, in a possible implementation, the DMRS includes a front-loaded DMRS and/or an additional DMRS. In other words, the indication information may indicate whether there is a front-loaded DMRS and/or an additional DMRS in the scheduled time domain unit, to further improve the flexibility of the DMRS design.

With reference to the fifth aspect, in a possible implementation, the method according to the fifth aspect further includes: sending capability information. The capability information includes at least one of the following: information indicating whether receiving of downlink scheduling without a DMRS is supported, information indicating a quantity of time domain units of the downlink scheduling without a DMRS, information indicating whether storage of a channel estimation result is supported, or information indicating duration for storing the channel estimation result. The channel estimation result is a channel estimation result determined based on a DMRS. It may be understood that when configuring the indication information, a network may configure the indication information based on a capability of the first apparatus, for example, whether the first apparatus supports downlink transmission without a DMRS. Further, because the DMRS may not be sent in a part of slots, it means that the first apparatus needs to cache a channel estimation result determined based on a previous DMRS, to demodulate data. To be specific, the first apparatus reports the capability information, so that the network can configure a DMRS distribution status in time domain and/or frequency domain based on the capability information reported by the first apparatus, and indicate the DMRS distribution status to the first apparatus.

With reference to the sixth aspect, in a possible implementation, the method according to the sixth aspect further includes: receiving capability information. The capability information includes at least one of the following: information indicating whether receiving of downlink scheduling without a DMRS is supported, information indicating a quantity of time domain units of the downlink scheduling without a DMRS, information indicating whether storage of a channel estimation result is supported, or information indicating duration for storing the channel estimation result. The channel estimation result is a channel estimation result determined based on a DMRS. To be specific, the second apparatus receives the capability information, so that the second apparatus can configure a DMRS distribution status in time domain and/or frequency domain based on the capability information, and indicate the DMRS distribution status to a receiving side. In this way, the DMRS design may match a capability of the receiving side, so that the receiving side can normally demodulate data.

It may be understood that the foregoing downlink scheduling without a DMRS may also be referred to as downlink transmission without a DMRS. The downlink scheduling without a DMRS may mean that there is no DMRS in a time domain unit (for example, a slot) of the downlink scheduling, and the DMRS may be a front-loaded DMRS and/or an additional DMRS. Further, the quantity of time domain units of the downlink scheduling without a DMRS may be a quantity of consecutive time domain units that are in time domain units of the downlink scheduling and in which there is no DMRS. It may be further understood that the storing the channel estimation result may alternatively be caching the channel estimation result, in other words, temporarily storing the channel estimation result. For example, after cache space reaches an upper limit, a first cached channel estimation result may be deleted. Alternatively, after storage duration of a channel estimation result reaches an upper limit, the channel estimation result may be deleted.

Further, the capability information may include whether channel estimation reuse across time domain units is supported. It may be understood that the channel estimation reuse across time domain units may mean: A channel estimation result corresponding to a DMRS in one of a plurality of time domain units may be reused in the plurality of time domain units.

According to a seventh aspect, a communication apparatus is provided, to implement the foregoing methods. The communication apparatus may be the first apparatus in any one of the first aspect, the third aspect, the fifth aspect, or the implementations thereof, an apparatus including the first apparatus, or an apparatus, for example, a chip, included in the first apparatus. Alternatively, the communication apparatus may be the second apparatus in any one of the second aspect, the fourth aspect, the sixth aspect, or the implementations thereof, an apparatus including the second apparatus, or an apparatus, for example, a chip, included in the second apparatus. The communication apparatus includes a corresponding module, unit, or means for implementing the foregoing method. The module, unit, or means may be implemented by hardware, software, or hardware executing corresponding software. The hardware or the software includes one or more modules or units corresponding to the foregoing functions.

In some possible designs, the communication apparatus may include a processing module and a transceiver module. The transceiver module may also be referred to as a transceiver unit, and is configured to implement a sending function and/or a receiving function in any one of the foregoing aspects and the possible implementations of the aspects. The transceiver module may include a transceiver circuit, a transceiver machine, a transceiver, or a communication interface. The processing module may be configured to implement a processing function in any one of the foregoing aspects and the possible implementations of the aspects.

In some possible designs, the transceiver module includes a sending module and a receiving module, respectively configured to implement the sending function and the receiving function in any one of the foregoing aspects and the possible implementations of the aspects.

According to an eighth aspect, a communication apparatus is provided, including at least one processor. The processor is configured to enable, by using a logic circuit and/or by executing a computer program or instructions stored in a memory, the communication apparatus to perform the method according to any one of the foregoing aspects.

In a possible implementation, the communication apparatus further includes the memory. Optionally, the memory is integrated with the processor, or the memory may be independent of the processor.

In a possible implementation, the memory is independent of the communication apparatus.

In a possible implementation, the communication apparatus further includes a communication interface, and the communication interface is configured to communicate with a module outside the communication apparatus.

The communication apparatus may be the first apparatus in any one of the first aspect, the third aspect, the fifth aspect, or the implementations thereof, an apparatus including the first apparatus, or an apparatus, for example, a chip, included in the first apparatus. Alternatively, the communication apparatus may be the second apparatus in any one of the second aspect, the fourth aspect, the sixth aspect, or the implementations thereof, an apparatus including the second apparatus, or an apparatus, for example, a chip, included in the second apparatus.

According to a ninth aspect, a computer-readable storage medium is provided. The computer-readable storage medium stores a computer program or instructions. When the computer program or the instructions are run on a communication apparatus, the communication apparatus is enabled to perform the method according to any one of the foregoing aspects or the implementations of the aspects.

According to a tenth aspect, a computer program product including instructions is provided. When the computer program product runs on a communication apparatus, the communication apparatus is enabled to perform the method according to any one of the foregoing aspects or the implementations of the aspects.

According to an eleventh aspect, a communication apparatus (for example, the communication apparatus may be a chip or a chip system) is provided. The communication apparatus includes a processor, configured to implement a function in any one of the foregoing aspects or the implementations of the aspects.

In some possible designs, the communication apparatus includes a memory, and the memory is configured to store necessary program instructions and data.

In some possible designs, when the apparatus is the chip system, the apparatus may include a chip, or may include a chip and another discrete component.

It may be understood that when the communication apparatus according to any one of the seventh aspect to the eleventh aspect is a chip, the foregoing sending action/function may be understood as output, and the foregoing receiving action/function may be understood as input.

For technical effects brought by any design scheme in the seventh aspect to the eleventh aspect, refer to the technical effects brought by different design schemes in the first aspect to the sixth aspect. Details are not described herein again.

According to a twelfth aspect, a communication method is provided. The communication method includes the method according to any one of the first aspect or the implementations of the first aspect and the method according to any one of the second aspect or the implementations of the second aspect; the communication method includes the method according to any one of the third aspect or the implementations of the third aspect and the method according to any one of the fourth aspect or the implementations of the fourth aspect; or the communication method includes the method according to any one of the fifth aspect or the implementations of the fifth aspect and the method according to any one of the sixth aspect or the implementations of the sixth aspect.

According to a thirteenth aspect, a communication system is provided. The communication system includes the first apparatus according to the first aspect and the second apparatus according to the second aspect; the communication system includes the first apparatus according to the third aspect and the second apparatus according to the fourth aspect; or the communication system includes the first apparatus according to the fifth aspect and the second apparatus according to the sixth aspect.

### BRIEF DESCRIPTION OF DRAWINGS

FIG. 1 is a diagram of resource elements REs occupied in a demodulation reference signal DMRS configuration type 1 according to an embodiment of this application;

FIG. 2 is a diagram of REs occupied in a DMRS configuration type 2 according to an embodiment of this application;

FIG. 3 is a diagram of an architecture of a communication system according to an embodiment of this application;

FIG. 4 is a diagram of a structure of a communication apparatus according to an embodiment of this application;

FIG. 5 is a first schematic flowchart of a resource allocation method according to an embodiment of this application;

FIG. 6 is a second schematic flowchart of a resource allocation method according to an embodiment of this application;

FIG. 7 is a third schematic flowchart of a resource allocation method according to an embodiment of this application;

FIG. 8 is a schematic flowchart of an information sending and receiving method according to an embodiment of this application;

FIG. 9 is a first diagram of a time domain resource for a DMRS in a time domain unit scheduled by using indication information according to an embodiment of this application;

FIG. 10 is a second diagram of a time domain resource for a DMRS in a time domain unit scheduled by using indication information according to an embodiment of this application;

FIG. 11 is a third diagram of a time domain resource for a DMRS in a time domain unit scheduled by using indication information according to an embodiment of this application;

FIG. 12 is a diagram of a frequency domain resource that is for a DMRS and that is scheduled by using indication information according to an embodiment of this application;

FIG. 13 is a diagram of a structure of a first apparatus according to an embodiment of this application; and

FIG. 14 is a diagram of a structure of a second apparatus according to an embodiment of this application.

### DESCRIPTION OF EMBODIMENTS

For ease of understanding of embodiments of this application, the following descriptions are provided before embodiments of this application are described.
1. In embodiments of this application, for ease of description, when numbering or indexing is involved, consecutive numbering may be performed starting from 1, 0, or any parameter.
2. “Predefinition”, “preconfiguration (or referred to as configuration in advance)”, and “agreement in a protocol” may be interchangeably used, and the predefinition may be implemented by pre-storing corresponding code or a corresponding table in an apparatus (for example, a terminal device or a network device), or implemented in another manner of indicating related information. A specific implementation thereof is not limited in embodiments of this application. “Storage” may mean storage in one or more memories.
3. In embodiments of this application, a symbol ┌ ┐ or a function ceil( ) represents a ceiling operation. For example, ┌a┐ represents a ceiling value of a, and ceil(a) may also represent a ceiling value of a. Further, a symbol └ ┘ or a function floor( ) represents a floor operation. For example, └a┘ represents a floor value of a, and floor(a) may also represent a floor value of a.
4. A “protocol” in embodiments of this application may be a standard protocol in the communication field, for example, may include a long term evolution (LTE) protocol, a new radio (NR) protocol, and a related protocol used in a future communication system. This is not limited in embodiments of this application.
5. In embodiments of this application, descriptions such as “when . . . ”, “in a case of . . . ”, and “if” all mean that a device (for example, a terminal device or a network device) performs corresponding processing in an objective case, are not intended to limit time, do not require the device to perform a determining action during implementation, and do not mean that there is another limitation.
6. In embodiments of this application, “sending information to . . . (a first apparatus)” may be understood as that destination end of the information is the first apparatus, and may include directly or indirectly sending the information to the first apparatus; and “receiving information from . . . (a second apparatus)” or “receiving information that is from . . . (a second apparatus)” may be understood as that a source end of the information is the second apparatus, and may include directly or indirectly receiving the information from the second apparatus. Necessary processing, for example, a format change, may be performed on information between a source end and a destination end of information sending. However, the destination end may understand valid information from the source end. A similar expression in this application may be understood similarly, and details are not described herein.
7. In descriptions of embodiments of this application, unless otherwise specified, “and/or” in embodiments of this application may indicate that three relationships exist. For example, A and/or B may represent the following three cases: Only A exists, both A and B exist, and only B exists, where A and B may be singular or plural. In addition, “at least one of the following items (pieces)” or a similar expression thereof indicates any combination of these items, including a single item (piece) or any combination of a plurality of items (pieces). In addition, to clearly describe technical solutions in embodiments of this application, terms such as “first” and “second” are used in embodiments of this application to distinguish between same items or similar items that provide basically same functions or purposes. A person skilled in the art may understand that the terms such as “first” and “second” do not limit a quantity or an execution sequence, and do not indicate a definite difference either. In addition, in embodiments of this application, terms such as “example” or “for example” represent giving an example, an illustration, or a description.

The following briefly describes a communication system to which this application is applicable and a related technology.

### 1. Communication System:

Embodiments of this application may be applied to an LTE system or an NR system (which may also be referred to as a 5th generation (5G) system), a vehicle-to-everything (V2X) system, a device-to-device (D2D) system, a machine-to-machine (M2M) communication system, an internet of things (IoT) system (for example, a narrowband internet of things (NB-IoT) system), a 6G communication system, and other next-generation communication systems. Alternatively, the communication system may be an open radio access network (O-RAN or ORAN) or a cloud radio access network (CRAN). This is not limited.

### 2. Time-Frequency Resource in an NR System:

The time-frequency resource may include a time domain resource and a frequency domain resource. To meet a communication traffic requirement, the NR system may support a larger frequency range (FR) and a larger system bandwidth in frequency domain. For example, for a low frequency band below 6 GHZ, for example, FR1 (410 MHz to 7125 MHz), a maximum system bandwidth supported by the NR system is 100 MHz. For another example, for a high-frequency band above 6 GHz and up to a millimeter wave band, for example, FR2 (24250 MHz to 52600 MHz) and FR2-2 (52600 MHz to 71000 MHz), a maximum system bandwidth supported by the NR system is 400 MHz. It may be understood that the FR may alternatively be another frequency range supported in a future next-generation communication system (for example, a 6th generation (6G) communication system) in addition to FR1, FR2, and FR2-2. This is not specifically limited in embodiments of this application.

Further, the time domain resource and the frequency domain resource are related to a transmission scheme in the NR system. An orthogonal frequency division multiplexing (OFDM) technology may be used in an uplink (UL) transmission scheme and a downlink (DL) transmission scheme in the NR system. A principle of the OFDM is: A plurality of subchannels are obtained through division in frequency domain, serial-to-parallel conversion is performed on to-be-transmitted data to obtain a plurality of groups of data to be transmitted in parallel, and then each group of data is modulated to a subcarrier corresponding to each subchannel for transmission, to be specific, the to-be-transmitted data may be transmitted through an OFDM waveform formed by a plurality of subcarriers that are superimposed in space. In other words, in the NR system, a minimum frequency domain resource may be one subcarrier, and a minimum time domain resource may be one OFDM symbol.

It may be understood that any two subcarriers in an OFDM symbol are orthogonal. Therefore, duration of the OFDM symbol (namely, a time length of the OFDM symbol) is inversely proportional to a subcarrier spacing (SCS). The subcarrier is located in a carrier on which the NR system operates, and a quantity of subcarriers is determined based on the subcarrier spacing (SCS) and a system bandwidth corresponding to the carrier.

Further, due to complexity of a radio channel, a multipath effect is generated, and consequently inter-symbol interference is caused. Generating an OFDM symbol by adding a cyclic prefix (CP) is equivalent to inserting a guard interval between different OFDM symbols, to reduce the inter-symbol interference. The CP may include a normal CP and an extended CP. It may be understood that, for the generating the OFDM symbol by adding the CP, the normal CP, the extended CP, and the like, refer to descriptions in a related 3GPP technical specification (TS), and details are not described herein.

It should be understood that different SCSs may be configured in the NR system to adapt to the foregoing different FRs. For example, for FR1 as the low frequency band, a small SCS is used, to avoid excessively large time domain overheads occupied by the CP. For another example, for FR2 and FR2-2 as high-frequency bands, a large SCS is used, to avoid large inter-subcarrier interference caused by a Doppler shift in the high-frequency bands.

The following further describes the time domain resource and the frequency domain resource with reference to a numerology.

### 2.1. Numerology:

A transmission numerology supported by the NR system is enumerated in Table 1. In Table 1, a 1^{st} column is a specific value of an SCS configuration μ, a 2^{nd} column is a specific value of an SCS, and a 3rd column is a specific type of a CP.

TABLE 1

| μ | Δf = 2^{μ} · 15 [kHz] | CP |
|---|---|---|
| 0 | 15 | Normal CP |
| 1 | 30 | Normal CP |
| 2 | 60 | Normal CP and extended CP |
| 3 | 120 | Normal CP |
| 4 | 240 | Normal CP |

When the SCS is 15 kHz, a time length of an OFDM symbol may be approximately 66.67 μs. When the SCS is 30 kHz, a time length of an OFDM symbol may be approximately 33.33 μs. When the SCS is 60 kHz, a time length of an OFDM symbol may be approximately 16.67 μs. When the SCS is 120 kHz, a time length of an OFDM symbol may be approximately 8.88 μs. When the SCS is 240 kHz, a time length of an OFDM symbol may be approximately 4.17 μs.

It may be understood that, for details about time lengths of the normal CP and the extended CP, refer to a specification in a related 3GPP protocol. Details are not described herein.

### 2.2. Time Domain Resource:

It should be understood that, in time domain, transmission may be performed in the NR system in a unit of a radio frame. The radio frame may include a plurality of subframes, and each subframe may include a plurality of slots. In other words, the NR system may include time domain resources at different granularities, such as the radio frame, the subframe, the slot, and an OFDM symbol.

Further, duration of each radio frame is 10 ms. Each radio frame may include 10 subframes whose duration is 1 ms. 10 subframes in a radio frame may be arranged in sequence. For example, 10 subframes in a radio frame may be sorted in ascending order of time as: a subframe #0 to a subframe #9. For another example, 10 subframes may be sorted in descending order of time as: a subframe #9 to a subframe #0. A subframe sorting manner is not specifically limited in embodiments of this application.

It should be understood that the foregoing subframe numbers are merely examples. For example, a start number may alternatively be #1. For example, 10 subframes in a radio frame may be represented as the subframe #1 to a subframe #10.

Further, for the SCS configuration μ, slots may be arranged in ascending order of numbers

$${n}_{s}^{μ} ∈ \{ 0 , … , {N}_{slot}^{subframe , μ} - 1 \}$$

in a subframe, and may be arranged in ascending order of numbers

$${n}_{s , f}^{μ} ∈ \{ 0 , … , {N}_{slot}^{frame , μ} - 1 \}$$

in a radio frame. There are

$${N}_{symb}^{slot}$$

consecutive OFDM symbols in one slot, where

$${N}_{symb}^{slot}$$

is related to a CP type used by the OFDM symbol. For

$${N}_{symb}^{slot}$$

corresponding to the normal CP, refer to Table 2. To be specific, one slot includes 14 OFDM symbols regardless of a value of the SCS. For

$${N}_{symb}^{slot}$$

corresponding to the extended CP, refer to Table 3. To be specific, when the SCS is 60 kHz, one slot includes 12 OFDM symbols.

It should be understood that a time domain start position of a slot

$${n}_{s}^{μ}$$

in a subframe is aligned with a time domain start position of an OFDM symbol

$${n}_{s}^{μ} {N}_{s y m b}^{slot}$$

in the same subframe. For example, when one slot includes 14 OFDM symbols, the OFDM symbols may be sorted in ascending order of time as an OFDM symbol #0 to an OFDM symbol #13. A time domain start position of the OFDM symbol #0 is the same as a time domain start position of the slot.

TABLE 2

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 3

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

### 2.3. Frequency Domain Resource:

According to the foregoing related descriptions of the OFDM, a minimum granularity of the frequency domain resource is one subcarrier. Therefore, a quantity of subcarriers may be for measuring a size of the frequency domain resource. In the NR system, the frequency domain resource may be classified into a resource element (RE), a resource block (RB), and a bandwidth part (BWP).

RE: One subcarrier in frequency domain and one OFDM symbol in time domain may be defined as the RE. The RE is a resource at a minimum granularity at a physical layer.

RB: In frequency domain, 12 consecutive subcarriers may be defined as one RB regardless of a value of a subcarrier spacing. A larger SCS indicates a larger actual bandwidth corresponding to one RB. It should be understood that at the physical layer, the RB may be referred to as a physical resource block (PRB).

BWP: Considering a capability limitation of a terminal device and an energy saving requirement, the NR system allows the terminal device to operate in a part of a system bandwidth, namely, the BWP. Alternatively, the BWP may be a part of a bandwidth corresponding to one carrier supported by one cell. For example, a cell covered by a network device (for example, a next-generation radio access network (next-generation radio access network, NG-RAN) device in the NR system) supports two carriers (a carrier #1 and a carrier #2). In the cell, a bandwidth of 40 MHz is allocated to the carrier #1, and a bandwidth of 60 MHz is allocated to the carrier #2. The BWP may be a bandwidth of 20 MHz in the bandwidth of 40 MHz corresponding to the carrier #1. The terminal device may operate only within the BWP. It may be understood that one BWP may include a plurality of RBs. In other words, a size of the BWP may be measured by using a quantity of RBs. It may be further understood that the size of the frequency domain resource may alternatively be represented by a bandwidth. For example, when the SCS is 15 kHz, a bandwidth of the RB is 12×15 kHz=180 kHz.

It should be understood that in the NR system, after the terminal device accesses a network through an initial access process, the network may configure an operating BWP for the terminal device by using higher layer signaling. One to four BWPs may be configured for each terminal device, but only one BWP is active at any moment. In addition to performing radio resource management (RRM) measurement, the terminal device only receives and sends data in the active BWP. A configuration of a BWP may include a frequency domain position, a bandwidth, or an SCS of the BWP or a CP type corresponding to the BWP. Assuming that the CP type corresponding to the BWP is not configured, it is agreed on in a protocol that the CP type corresponding to the BWP is the normal CP.

Further, before the terminal device sets up a radio resource control (RRC) connection, that is, in an initial search and initial access process, the network may configure an initial BWP by using system information (SI), for example, remaining minimum system information (RMSI). If the RMSI does not include configuration information for the initial BWP, it is agreed on in a protocol that a control resource set (CORESET) 0 may be used as the initial BWP.

It may be understood that in embodiments of this application, “carrier”, “carrier frequency”, and “frequency” may be interchangeably used for description. A unified description is provided herein, and details are not described below again.

Further, in embodiments of this application, meanings of “number” and “index” are the same. In other words, “number” and “index” may be interchangeably used for description. A unified description is provided herein, and details are not described below again.

It may be further understood that, in embodiments of this application, the index may correspond to an identity (ID). For example, an index of a slot may correspond to an identity of a time domain resource, an index of a cell may correspond to an identity of the cell, an index of a carrier may correspond to an identity of the carrier, and an index of an active BWP may correspond to an identity of the active BWP. A unified description is provided herein, and details are not described below again.

### 3. Frequency Domain Resource Allocation:

As described in the background, frequency domain resource allocation may be performed in an NR system by using a resource allocation type 0 and a resource allocation type 1. In the resource allocation type 0, a resource block group (RBG) is used as a unit of the frequency domain resource allocation, in other words, a granularity of the frequency domain resource allocation is an RBG. In the resource allocation type 1, an RB is used as a unit of the frequency domain resource allocation, in other words, a granularity of the frequency domain resource allocation is an RB. It may be understood that the RBG includes a plurality of RBs. In other words, the granularities of the frequency domain resource allocation in the resource allocation type 0 and the resource allocation type 1 are different.

It should be understood that the resource allocation type 0 and the resource allocation type 1 support static configuration and dynamic configuration. In the static configuration, a higher-layer parameter may indicate that a frequency domain resource allocation mode is the resource allocation type 0 or the resource allocation type 1. In the dynamic configuration, downlink control information (DCI) may indicate that a frequency domain resource allocation mode is the resource allocation type 0 or the resource allocation type 1. For example, in downlink frequency domain resource allocation, a physical downlink shared channel (PDSCH) configuration (namely, PDSCH-Config) information element (IE) in RRC signaling includes a resourceAllocation parameter, and the parameter may be configured as three types, including the resource allocation type 0 (resourceAllocationType0), the resource allocation type 1 (resourceAllocationType1), and dynamic switching (dynamicSwitch).

It may be understood that assuming that the resourceAllocation parameter indicates the resource allocation type 0 or the resource allocation type 1, it indicates that the static configuration is applied. In other words, before the resourceAllocation parameter is updated by using RRC signaling, a frequency domain resource allocation mode currently used in the system is the frequency domain resource allocation type 0 or the frequency domain resource allocation type 1.

It may be further understood that if the resourceAllocation parameter indicates the dynamic switching (dynamicSwitch), it indicates that the dynamic configuration is applied. In the dynamic configuration, a network device may indicate, by using a frequency domain resource assignment (FDRA) field in the DCI, that the frequency domain resource allocation mode is the resource allocation type 0 or the resource allocation type 1. Further, the FDRA field may further indicate an allocated RBG or RB.

For example, the FDRA field includes N bits, where N is an integer greater than 1. A most significant bit (MSB) in the N bits may indicate that the frequency domain resource allocation mode is the resource allocation type 0 or the resource allocation type 1, and remaining N−1 bits indicate the allocated RBG or RB. If the most significant bit is 0, the most significant bit may indicate that the frequency domain resource allocation mode is the resource allocation type 0; or if the most significant bit is 1, the most significant bit may indicate that the frequency domain resource allocation mode is the resource allocation type 1. Certainly, alternatively, if the most significant bit is 0, the most significant bit may indicate that the frequency domain resource allocation mode is the resource allocation type 1; or if the most significant bit is 1, the most significant bit may indicate that the frequency domain resource allocation mode is the resource allocation type 0. This is not specifically limited in this embodiment of this application.

It should be understood that, regardless of the static configuration or the dynamic configuration, for a frequency domain resource scheduled in a DCI format 1-0 or a DCI format 4-0, it is specified by default in a protocol that a frequency domain resource allocation mode of the frequency domain resource is the resource allocation type 1.

It should be further understood that uplink frequency domain resource allocation is similar to the foregoing downlink frequency domain resource allocation. For details, refer to related descriptions in Clause 6 in TS 38.214 (version h20), and the details are not described herein.

It may be understood that in embodiments of this application, “field” may alternatively be replaced with “field”. A unified description is provided herein, and details are not described below again.

The following further describes the resource allocation type 0 and the resource allocation type 1.

### 3.1. Resource Allocation Type 0:

As described above, the granularity of the frequency domain resource allocation in the resource allocation type 0 is the RBG, and the allocated RBG is indicated by a bitmap. In other words, the foregoing FDRA field includes a bitmap indicating the allocated RBG. Each bit in the bitmap corresponds to one RBG. In other words, indication overheads for the frequency domain resource allocation are directly proportional to a quantity of RBGs. For example, the network device allocates 16 RBGs to a terminal device. Therefore, indication overheads for frequency domain resource allocation are 16 bits.

Further, a quantity of RBs included in the RBG (or referred to as an RBG size P) is preconfigured in a protocol. Different size ranges of a BWP may correspond to different RBG sizes P. It should be understood that, to further support flexible frequency domain resource allocation, there are two candidate values of the RBG size P for a specific size range of the BWP. The two candidate values of the RBG size P respectively correspond to an RBG configuration 1 and an RBG configuration 2. The RBG configuration 1 and the RBG configuration 2 may be indicated by an rbg-Size parameter in the foregoing PDSCH-Config information element.

TABLE 4

| Size of the BWP | RBG configuration 1 | RBG configuration 2 |
|---|---|---|
| (quantity of RBs) | (quantity of RBs) | (quantity of RBs) |
| 1 to 36 | 2 | 4 |
| 37 to 72 | 4 | 8 |
| 73 to 144 | 8 | 16 |
| 145 to 275 | 16 | 16 |

Table 4 enumerates an RBG size P defined in TS 38.214. As enumerated in Table 4, RBG sizes corresponding to different size ranges of the BWP are agreed on in a protocol. It may be understood that, according to the related descriptions of the BWP in the foregoing “frequency domain resource”, a network configures a BWP for a terminal device, so that the terminal device can obtain a size of the corresponding BWP, and further determine indication overheads for frequency domain resource allocation in DCI with reference to Table 4.

For example, when the terminal device operates in FR1, and a system bandwidth is 100 MHz, the size of the BWP is 275 RBs, and a quantity of allocated RBGs is a ceiling value of 275/16, namely, 18. Therefore, the indication overheads (for example, the foregoing FDRA field) for the frequency domain resource allocation are 18 bits.

For another example, when the terminal device operates in FR2, and a system bandwidth is 400 MHz, the size of the BWP is 264 RBs, and a quantity of allocated RBGs is a ceiling value of 264/16, namely, 17. Therefore, the indication overheads for the frequency domain resource allocation are 17 bits.

It should be understood that because the BWP may be at any position in a bandwidth of a cell, in other words, the BWP is the entire bandwidth of the cell or a part of the bandwidth, when the BWP occupies a part of the bandwidth of the cell, a start position of the BWP is not necessarily aligned with a boundary between cell-level RBGs. In this case, as defined in a protocol, a quantity of RBs included in a 1^{st} RBG within the BWP may be less than the RBG size P defined in Table 4. Further, because a quantity of RBs included within the BWP may not be exactly divided by the RBG size P, a quantity of RBs included in a last RBG may also be less than the RBG size P. In other words, for the BWP, quantities of RBs included in the RBGs at head and tail ends may be less than or equal to the RBG size P, and a quantity of RBs included in a remaining RBG is equal to the RBG size P.

### 3.2. Resource Allocation Type 1:

As described above, the frequency domain resource allocation is performed at a granularity of the RB in the resource allocation type 1, and the allocated RB is indicated by a resource indicator value (RIV). In other words, the foregoing FDRA field includes a bit sequence indicating the RIV. The RIV indicates a start RB of an allocated frequency domain resource and a quantity of occupied RBs. It may be understood that, according to descriptions of the RIV in TS 38.214, indication overheads of the RIV are directly proportional to a size of a BWP. For example, for the downlink frequency domain resource allocation, the indication overheads of the RIV are

$$⌈ {log}_{2} ( {N}_{R B}^{DL \_ BWP} ( {N}_{R B}^{DL \_ BWP} + 1 ) / 2 ) ⌉ ,$$

where ┌ ┐ represents a ceiling operation, and

$${N}_{R B}^{DL \_ BWP}$$

represents a size of a downlink BWP, namely, a quantity of RBs included in the downlink BWP.

It should be understood that, for specific descriptions of the resource allocation type 1, an encoding and decoding scheme of the RIV, and the like, refer to TS 38.214. Details are not described herein.

### 4. Time Domain Resource Allocation:

For the time domain resource allocation, two mapping types, namely, a mapping type A and a mapping type B, of a data channel (for example, a PDSCH or a physical uplink shared channel (PUSCH)) are defined in TS 38.214. The mapping type A is mainly applicable to slot-based resource allocation, and the mapping type B is applied to non-slot (non-slot, also referred to as mini-slot)-based resource allocation. In other words, a granularity of time domain resource allocation in the mapping type A is a slot, and a granularity of time domain resource allocation in the mapping type B is a non-slot. A time length of the non-slot may be a part of OFDM symbols in one slot. For example, a time length of a downlink non-slot may be two, four, or seven OFDM symbols, and a time length of an uplink non-slot may be any time length within one to 14 OFDM symbols.

For example, Table 5 enumerates a time domain start position S and an allocated time length (or referred to as a quantity L of OFDM symbols) that correspond to the PDSCH and that are defined in TS 38.214. For the mapping type A, the time domain start position S of the PDSCH may be one of first four OFDM symbols in a slot, and the quantity L of allocated OFDM symbols may be 3 to 14. For the mapping type B, when a normal CP is used, the quantity L of OFDM symbols that can be allocated to the PDSCH is 2, 4, or 7; or when an extended CP is used, a quantity L of OFDM symbols that can be allocated to the PDSCH is 2, 4, or 6. The PDSCH in the mapping type B may start from any OFDM symbol in a slot.

TABLE 5

| PDSCH mapping | Normal CP | | | Extended CP | | |
|---|---|---|---|---|---|---|
| type | S | L | S + L | S | L | S + L |
| Mapping type A | [0, 1, 2, 3] | {3, . . . , 14} | {3, . . . , 14} | [0, 1, 2, 3] | {3, . . . , 12} | {3, . . . , 12} |
| Mapping type B | {0, . . . , 12} | [2, 4, 7] | {2, . . . , 14} | {0, . . . , 10} | [2, 4, 6] | {2, . . . , 12} |

It may be understood that, for the PUSCH, the mapping type A is applicable only to a case in which the PUSCH starts from a 1^{st} OFDM symbol in a slot. In other words, if a time domain start position S of the PUSCH is not the 1^{st} OFDM symbol in the slot, the mapping type B is applied. For the mapping type A, a quantity L of OFDM symbols allocated to the PUSCH may be 4 to 14. For the mapping type B, a quantity L of OFDM symbols allocated to the PUSCH may be 1 to 14, and the PUSCH may start from any OFDM symbol in a slot.

Further, in an NR system, a time domain resource allocation list may be configured by using RRC signaling. Each row of the time domain resource allocation list includes: a slot offset k0 or k2 (for cross-slot scheduling), a mapping type (the mapping type A or the mapping type B), and a start and length indicator value (SLIV). The SLIV includes the foregoing time domain start position S and the foregoing quantity L of OFDM symbols. k0 is a parameter in a time domain resource allocation list for the PDSCH, and k2 is a parameter in a time domain resource allocation list for the PUSCH.

Further, a field value of a time domain resource assignment (TDRA) field in DCI may indicate a row index of the time domain resource allocation list. For example, when the field value of the TDRA field is m, the TDRA field indicates a row index m+1 of the time domain resource allocation list. In this way, an allocated time domain resource may be determined from the configured time domain resource allocation list by using the TDRA field.

It may be further understood that for details about the mapping type of the PUSCH, the time domain resource allocation list, the parameters included in the time domain resource allocation list, and the like, refer to related descriptions in TS 38.214, and the details are not described.

It should be understood that, to further reduce overheads, the time domain resource allocation is enhanced in 3GPP Release 17, to support scheduling of a plurality of PDSCHs in time domain by using a single piece of DCI. Therefore, when the time domain resource allocation list is configured by using the RRC signaling, each row in the time domain resource allocation list includes a plurality of pieces of consecutive or non-consecutive time domain resource allocation information. In other words, a terminal device may obtain, by using the row index indicated by the field value of the TDRA field, time domain resource allocation information for one or more PDSCHs scheduled this time.

### 5. Demodulation Reference Signal (DMRS):

The DMRS may be for channel estimation. The DMRS may be mapped to the foregoing PDSCH and PUSCH. In other words, time domain resource allocation for both the PDSCH and the PUSCH includes the DMRS.

Further, DMRSs may be classified into a front-loaded DMRS (front-loaded DMRS) and an additional DMRS based on time domain positions of the DMRSs on a data channel. For the front-loaded DMRS, on each scheduled time domain resource, a time domain position at which the front-loaded DMRS appears for the first time should be as close as possible to a time domain start position of scheduling, to help reduce a demodulation and decoding delay and perform channel estimation as early as possible. The additional DMRS is for meeting an estimation precision requirement for a time-varying channel in a high-speed service application scenario. A time domain density of the additional DMRS is configurable. A pattern (namely, distribution of occupied time-frequency resources) of each group of additional DMRSs is a repetition of a pattern of a front-loaded DMRS.

It should be understood that, by default, the front-loaded DMRS needs to be configured; and the additional DMRS may not be configured. In other words, for each time of scheduling, there is a DMRS in each scheduled slot or non-slot.

The following separately describes a time domain start position and a frequency domain mapping density of the DMRS.

### 5.1. Time Domain Start Position of the DMRS:

It may be understood that the mapping types of the foregoing PUSCH or PDSCH may be classified into the mapping type A and the mapping type B, and the mapping type A and the mapping type B correspond to different start positions of DMRSs. For example, for the mapping type A, a 1^{st} DMRS position is mapped to a 3^{rd} or a 4^{th} OFDM symbol in a slot in which an allocated time domain resource is located. In other words, regardless of a specific time domain start position of actual transmission of the PDSCH or the PUSCH, the DMRS is fixed at a position near an edge of the slot. For another example, for the mapping type B, a 1^{st} DMRS position is mapped to a 1^{st} OFDM symbol in an allocated time domain resource. In other words, a position of the DMRS is not a start position of a slot, but is a time domain start position of the PDSCH or the PUSCH.

To be specific, the mapping type A is mainly applied to a scenario in which data transmission occupies a large part of OFDM symbols of a slot, and the mapping type B is mainly applied to a scenario in which data transmission occupies a small part of OFDM symbols of a slot, to reduce a transmission delay.

Further, when it is determined, by using a TDRA field in the indication manner described in the foregoing “time domain resource allocation”, that the mapping type is the mapping type A, the time domain start position of the DMRS may be determined by using a master information block (MIB) in a synchronization signal/physical broadcast channel block (SSB). For example, the MIB includes dmrs-TypeA-Position. If dmrs-TypeA-Position=pos2, the time domain start position of the DMRS is the 3^{rd} OFDM symbol in the slot; or if dmrs-TypeA-Position=pos3, the time domain start position of the DMRS is the 4^{th} OFDM symbol in the slot.

### 5.2. Frequency Domain Mapping Density of the DMRS:

Two DMRS types, namely, a DMRS configuration type 1 and a DMRS configuration type 2, are defined in TS 38.214. The following separately provides descriptions.

For the DMRS configuration type 1, frequency domain resources occupied by the DMRS are in spaced distribution (or referred to as comb distribution), and one RE in every two REs is occupied. In other words, a density of REs occupied by the DMRS is 50%. In every two REs, different REs correspond to different code division multiplexing (CDM) groups.

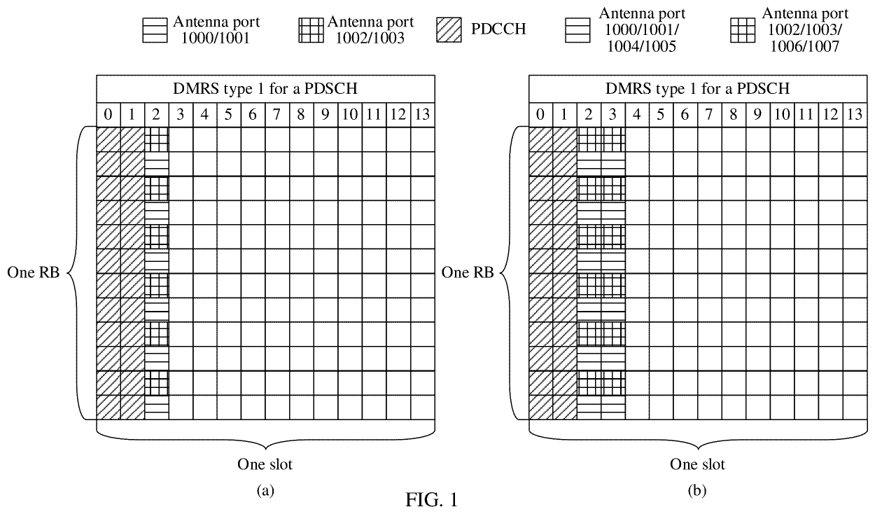

For example, FIG. 1 is a diagram of REs occupied in the DMRS configuration type 1 according to an embodiment of this application. As shown in FIG. 1, a DMRS is on an early OFDM symbol in a slot (including an OFDM symbol #0 to an OFDM symbol #13 in a column direction), and occupies six REs in an RB (including 12 REs in a row direction). (a) in FIG. 1 shows a single-symbol DMRS, the DMRS symbol occupies one symbol, namely, an OFDM symbol #2, and OFDM symbols before the OFDM symbol #2 may be occupied by a PDCCH or another signal or channel. Subcarriers occupied by the DMRS on the OFDM symbol #2 may be divided into two groups of frequency-division resources in a comb pattern, namely, two CDMs. One CDM group may correspond to an DMRS port 1000 or 1001, where the ports 1000 and 1001 are orthogonal; and the other CDM group may correspond to a DMRS port 1002 or 1003.

(b) in FIG. 1 shows a double-symbol DMRS. A difference between the double-symbol DMRS and the single-symbol DMRS lies in: The double-symbol DMRS further occupies an OFDM symbol #3, and a time domain orthogonal cover code (OCC) is added on a basis of a structure of the single-symbol DMRS. To be specific, orthogonality of four DMRS ports may be implemented by using the OCC for each CMD group, in other words, a maximum of eight orthogonal DMRS ports are supported. For example, one CDM group in (b) in FIG. 1 may correspond to a DMRS port 1000, 1001, 1004, or 1005, and the other CDM group may correspond to a DMRS port 1002, 1003, 1006, or 1007.

For the DMRS configuration type 2, a difference from the DMRS configuration type 1 lies in: The DMRS occupies RE groups that are spaced by four REs from each other, and each RE group includes two REs consecutive in frequency domain. In other words, a density of REs occupied by the DMRS is 33.3%, that is, the DMRS includes three CDM groups.

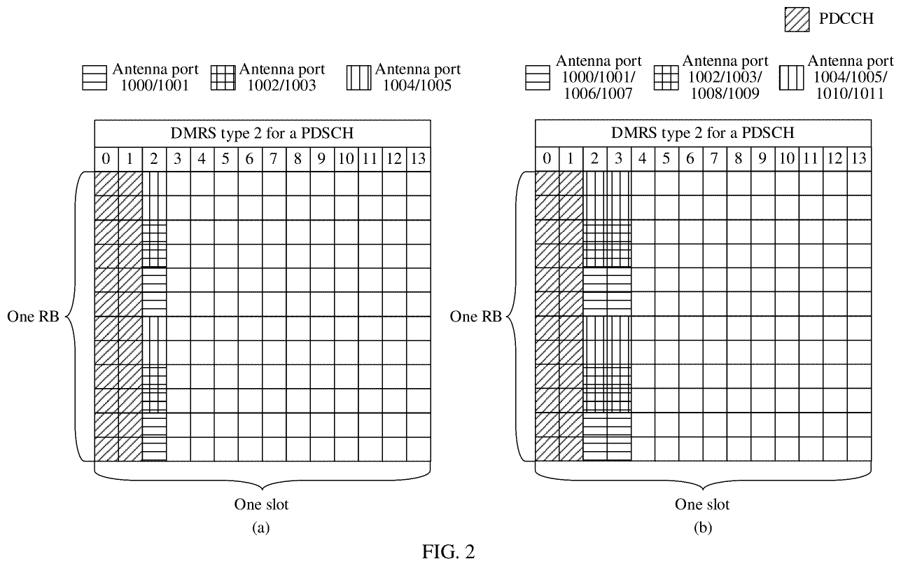

For example, FIG. 2 is a diagram of REs occupied in the DMRS configuration type 2 according to an embodiment of this application. As shown in FIG. 2, (a) in FIG. 2 shows a single-symbol DMRS. A difference from (a) in FIG. 1 lies in: The DMRS configuration type 2 further includes a third CMD group, and the CMD group may correspond to a DMRS port 1004 or 1005. (b) in FIG. 2 shows a double-symbol DMRS. A difference from (b) in FIG. 2 lies in: The DMRS configuration type 2 includes three CMD groups (for example, represented by a CMD group #0, a CDM group #1, and a CMD group #2), the CMD group #0 may correspond to a DMRS port 1000, 1001, 1006, or 1007, the CDM group #1 may correspond to a DMRS port 1002, 1003, 1008, or 1009, and the CMD group #2 may correspond to a DMRS port 1004, 1005, 1010, or 1011.

It should be understood that related configurations of the DMRS may be configured by using the foregoing RRC signaling. For example, a DMRS for the PDSCH may be configured by using a DMRS downlink configuration (DMRS-DownlinkConfig) field in the foregoing PDSCH-Config information element. The DMRS-DownlinkConfig field may include indication information of a DMRS configuration type, indication information of a time domain position of an additional DMRS, indication information of a maximum quantity of OFDM symbols occupied by a front-loaded DMRS, or the like. It may be understood that, if the DMRS type is not configured in the RRC signaling, it is specified by default in a protocol that the DMRS configuration type is the DMRS configuration type 1. It may be further understood that, for related configurations of a DMRS for the PUSCH, refer to related descriptions in TS 38.214. Details are not described herein.

It may be understood that because the NR system or the 6G communication system needs to support a plurality of different service application scenarios, for example, enhanced mobile broadband (eMBB), an ultra-reliable low-latency communication (URLLC) service, massive machine-type communications (mMTC), immersive communication, massive communication, ubiquitous connections, integrated artificial intelligence and communication, or integrated sensing and communication, to meet further requirements of the foregoing different service application scenarios for latency, reliability, coverage, and the like, more flexible resource allocation is needed.

However, the foregoing resource allocation modes specified in the protocol are not sufficiently flexible, and specifically have the following two problems:

Problem 1: For the frequency domain resource allocation, the foregoing frequency domain resource allocation mode specified in the protocol is not sufficiently flexible, and does not meet a further requirement of a service for reliability.

For example, in an application scenario with a small quantity of served terminal devices, the indication overheads for the foregoing frequency domain resource allocation are large (for example, overheads for transmitting the DCI are large), and a reliability requirement of a service for resource allocation indication is not met. For example, in a high-frequency scenario, energy is focused within a small beam width through beamforming (for example, hybrid beamforming (HBF)), to compensate for a transmission loss on a high-frequency carrier. Consequently, beam coverage is limited, and each beam can serve a small quantity of terminal devices (for example, one or two terminal devices). For another example, in an early stage of network construction or when network load is small, a quantity of terminal devices served in a cell is small. Further, because the quantity of served terminal devices is small, a larger frequency domain resource may be allocated to each terminal device. If frequency domain resource allocation is performed at a fine granularity, for example, the foregoing RBG or RB, DCI overheads are large, reliability of a PDCCH that carries the DCI is affected, and the further requirement of the service for the reliability cannot be met.

For another example, for a service (for example, a small data service) with a small size of transmitted data, the granularity of the foregoing frequency domain resource allocation is large. This causes a waste of an allocated resource and affects network transmission quality.

Problem 2: For a DMRS design in the time domain resource allocation, the foregoing DMRS design specified in the protocol is not sufficiently flexible, and cannot meet a further requirement of a service for a data transmission rate. For example, in a high-frequency indoor scenario or a night scenario, a moving speed of a terminal device is usually low, and channel coherence time is long. As a result, a channel slightly changes in short time (for example, basically does not change within 1 ms). It may be understood that, in a scenario in which the channel slowly changes with the time, the terminal device may use a channel estimation result determined by using a DMRS in one or more previous slots, and does not need to perform channel estimation by using a DMRS in each slot.

However, according to the foregoing related descriptions of the DMRS, for each time of scheduling, each scheduled slot includes a DMRS. In this case, DMRS redundancy occurs in the foregoing scenario in which the channel slowly changes with the time. Further, when an SCS is large (for example, a large SCS needs to be used in a high-frequency scenario to avoid inter-subcarrier interference caused by a Doppler shift), 1 ms (namely, one subframe) includes more slots (as enumerated in Table 2). Consequently, DMRS overheads are larger, and a quantity of time domain resources for data transmission is smaller. This affects an achievable rate of the terminal device. Therefore, the foregoing DMRS design specified in the protocol is not sufficiently flexible, and does not meet the further requirement of the service for the data transmission rate.

Based on the foregoing problems, embodiments of this application provide the following technical solutions. The following describes the technical solutions in embodiments of this application with reference to the accompanying drawings in embodiments of this application.

For ease of understanding of embodiments of this application, a service application scenario of this application is described by using an architecture of a communication system shown in FIG. 3 as an example. It should be understood that the architecture of the communication system and the service application scenario described in embodiments of this application are intended to describe the technical solutions in embodiments of this application more clearly, but are not intended to limit the technical solutions provided in embodiments of this application. A person of ordinary skill in the art may know that, as the communication architecture evolves and a new service application scenario emerges, the technical solutions provided in embodiments of this application are also applicable to a similar technical problem.

FIG. 3 is a diagram of an architecture of a communication system 300 according to an embodiment of this application. An example in which the communication system 300 includes at least one network device (for example, 310a or 310b in FIG. 3) and at least one terminal device (for example, 320a to 320j in FIG. 3) connected to the network device is used in FIG. 3 for description. It should be understood that the network device may be connected to a core network (CN) in a wireless or wired manner. A CN device in the CN and the network device may be different physical devices, or may be a same physical device that integrates a logical function of the CN and a logical function of a radio access network. It may be understood that quantities of network devices and terminal devices in FIG. 3 are merely examples, and may be larger or smaller. This is not specifically limited in this embodiment of this application.

The following separately describes the network device and the terminal device.

### Network Device:

In a possible implementation, the network device may be a device that communicates with the terminal device. The network device may also be referred to as a radio access network (RAN) device, an access node, a RAN entity, a RAN node, or the like. As shown in FIG. 3, a plurality of network devices in the communication system 300 may be nodes of a same type, or may be nodes of different types. In some scenarios, the network device and the terminal device are relative. For example, the network element 320i in FIG. 3 may be a helicopter or an uncrewed aerial vehicle, and may be configured as a mobile base station. For the terminal device 320j that accesses the communication system 300 via the network element 320i, the network element 320i may be a base station 310a. However, for the base station 310a, the network element 320i is a terminal device. Both the network device and the terminal device are sometimes referred to as communication apparatuses. For example, the network elements 310a and 310b in FIG. 3 may be understood as communication apparatuses having functions of a base station, and the network elements 320a to 320j may be understood as communication apparatuses having functions of a terminal.

In a possible scenario, the network device may be a transmission and reception point (TRP), a base station, a remote radio unit (RRU) or a baseband unit (BBU) (which may also be referred to as a digital unit (DU)) of a split base station, a broadband network gateway (BNG), an aggregation switch, a non-3GPP access device, a relay station, an access point, or the like. The network device may be a macro base station (for example, the network element 310a in FIG. 3), a micro base station or an indoor base station (for example, the network element 310b in FIG. 3), a relay node or a donor node, or a radio controller in a CRAN scenario. Optionally, the network device may alternatively be a server, a wearable device, a vehicle, a vehicle-mounted device, or the like. For example, a network device in a V2X system may be a road side unit (RSU). In addition, the network device in embodiments of this application may be an eNB or an eNodeB (evolved NodeB) in LTE, a radio controller in a CRAN scenario, a base station (for example, a next generation NodeB (gNodeB, gNB)) in a 5G communication system, a base station in a future evolved system (for example, a 6G communication system), or the like. This is not specifically limited herein.

In a possible implementation, the network device may include a central unit (CU), a DU, a CU-control plane (control plane, CP), a CU-user plane (user plane, UP), or a radio unit (RU). The network device may further include an active antenna unit (AAU). The CU implements some functions of the network device, and the DU implements some functions of the network device. For example, the CU is responsible for processing a non-real-time protocol and service, and implementing a function of an RRC layer and/or a function of a packet data convergence protocol (PDCP) layer. The DU is responsible for processing a physical layer protocol and a real-time service, and implementing functions of a radio link control (RLC) layer, a media access control (MAC) layer, and a PHY layer. The AAU implements a part of processing functions of the physical layer, radio frequency processing, and a function related to an active antenna. Because information at the RRC layer eventually becomes information at the physical (PHY) layer, or is converted from information at the PHY layer, in this architecture, higher layer signaling, for example, RRC signaling, may also be considered as being sent by the DU or sent by the DU and the AAU. It may be understood that the network device may be a device including one or more of a CU node, a DU node, or an AAU node. In addition, the CU may be categorized as a network device in a RAN or a network device in the CN. This is not limited in embodiments of this application.

Further, in different systems, the CU (or the CU-CP and the CU-UP), the DU, or the RU may alternatively have different names, but a person skilled in the art may understand meanings thereof. For example, in an ORAN system, the CU may also be referred to as an open CU (O-CU), the DU may also be referred to as an open DU (O-DU), the CU-CP may also be referred to as an open CU-CP (O-CU-CP), the CU-UP may also be referred to as an open CU-UP (O-CU-UP), and the RU may also be referred to as an open RU (O-RU). For ease of description, the CU, the CU-CP, the CU-UP, the DU, and the RU are used as examples in embodiments of this application for description. Any one of the CU (or the CU-CP and the CU-UP), the DU, and the RU in embodiments of this application may be implemented by a software module, a hardware module, or a combination of a software module and a hardware module.

### Terminal Device:

In a possible implementation, the terminal device may be a device, for example, a terminal or a chip that may be used in a terminal, configured to implement a wireless communication function. The terminal may be user equipment (UE), an access terminal, a terminal unit, a terminal station, a mobile station, a remote station, a remote terminal, a mobile device, a terminal agent, a terminal apparatus, or the like in a 5G network or a future evolved public land mobile network (PLMN). The access terminal may be a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a VR terminal device, an AR terminal device, a wireless terminal in industrial control, a wireless terminal in self-driving, a wireless terminal in telemedicine, a wireless terminal in a smart grid, a wireless terminal in transportation safety, a wireless terminal in a smart city, a wireless terminal in a smart home, or the like. In a possible implementation, the terminal device may be mobile or fixed.

The following describes structures of the network device and the terminal device.

In a possible implementation, the network device and the terminal device in embodiments of this application may also be referred to as communication apparatuses, and each may be a general-purpose device or a special-purpose device. This is not specifically limited in embodiments of this application.

In a possible implementation, related functions of the terminal device or the network device in embodiments of this application may be implemented by one device, may be jointly implemented by a plurality of devices, or may be implemented by one or more functional modules in one device. This is not specifically limited in embodiments of this application. It may be understood that the foregoing function may be a network element in a hardware device, a software function running on dedicated hardware, a combination of hardware and software, or a virtualization function instantiated on a platform (for example, a cloud platform).

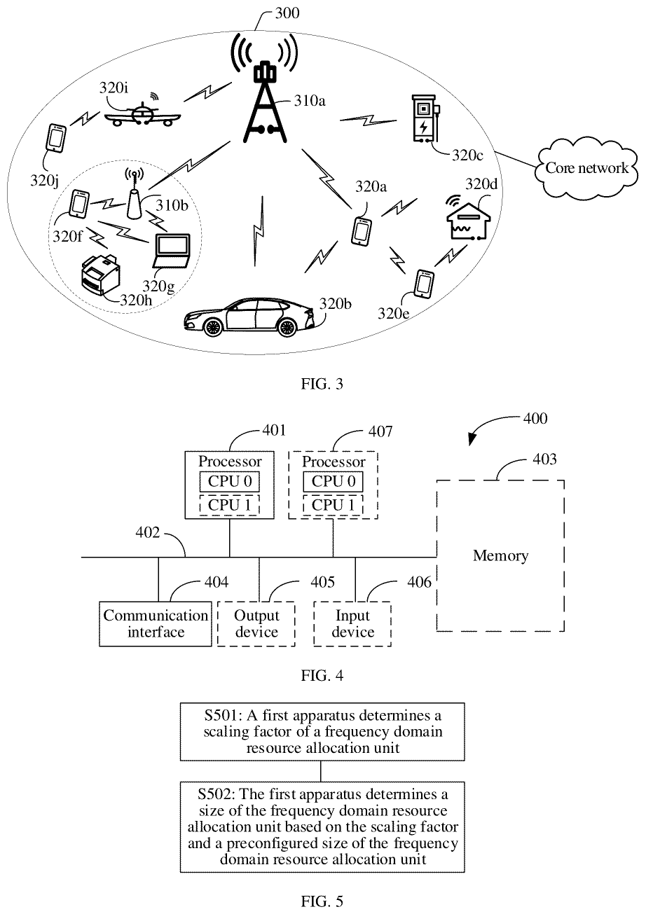

For example, the related functions of the network device or the terminal device in embodiments of this application may be implemented by a communication apparatus 400 in FIG. 4. FIG. 4 is a diagram of a structure of the communication apparatus 400 according to an embodiment of this application. The communication apparatus 400 includes one or more processors 401, a communication line 402, and at least one communication interface (an example in which a communication interface 404 and one processor 401 are included is merely used in FIG. 4 for description). Optionally, the communication apparatus 400 may further include a memory 403.

The processor 401 may be a general-purpose central processing unit (CPU), a microprocessor, an application-specific integrated circuit (ASIC), or one or more integrated circuits configured to control program execution of the solutions in this application.

The communication line 402 may include a channel for connecting different components.

The communication interface 404 may be a transceiver module configured to communicate with another device or a communication network, for example, an Ethernet, a RAN, or a wireless local area network (WLAN). For example, the transceiver module may be an apparatus like a transceiver or a transceiver machine. In a possible implementation, the communication interface 404 may alternatively be a transceiver circuit in the processor 401, and is configured to implement signal input and signal output of the processor.

The memory 403 may be an apparatus having a storage function. For example, the memory 403 may be a read-only memory (ROM) or another type of static storage device that can store static information and instructions, a random access memory (RAM) or another type of dynamic storage device that can store information and instructions, an electrically erasable programmable read-only memory (EEPROM), a compact disc read-only memory (CD-ROM) or another optical disk storage, an optical disc storage (including a compact disc, a laser disc, an optical disc, a digital versatile disc, a Blu-ray disc, or the like), a magnetic disk storage medium or another magnetic storage device, or any other medium that can carry or store expected program code in a form of instructions or a data structure and that can be accessed by a computer, but is not limited thereto. The memory may exist independently, and is connected to the processor through the communication line 402. The memory may alternatively be integrated with the processor.

Optionally, the memory 403 is configured to store computer-executable instructions for executing the solutions in this application, and the processor 401 controls the execution. The processor 401 is configured to execute the computer-executable instructions stored in the memory 403, to implement the methods provided in embodiments of this application.

Alternatively, in embodiments of this application, the processor 401 may implement a processing-related function in the methods provided in the following embodiments of this application, and the communication interface 404 is responsible for communicating with another device or a communication network. This is not specifically limited in embodiments of this application.

In a possible implementation, the memory 403 in this embodiment of this application may be further configured to store information or parameters, for example, a scaling factor, a preconfigured size of a frequency domain resource allocation unit, an FR, an SCS, or a candidate scaling factor set, described in the following embodiments.

The computer-executable instructions in embodiments of this application may also be referred to as application program code. This is not specifically limited in embodiments of this application.

During specific implementation, in an embodiment, the processor 401 may include one or more CPUs, for example, a CPU 0 and a CPU 1 in FIG. 4.

During specific implementation, in an embodiment, the communication apparatus 400 may include a plurality of processors, for example, the processor 401 and a processor 407 in FIG. 4. Each of these processors may be a single-core (single-CPU) processor, or may be a multi-core (multi-CPU) processor. The processor herein may be one or more devices, circuits, and/or processing cores configured to process data (for example, computer program instructions).

During specific implementation, in an embodiment, the communication apparatus 400 may further include an output device 405 and an input device 406. The output device 405 communicates with the processor 401, and may display information in a plurality of manners.

The communication apparatus 400 may be a general-purpose apparatus or a special-purpose apparatus. For example, the communication apparatus 400 may be a desktop computer, a portable computer, a network server, a personal digital assistant (PDA), a mobile phone, a tablet computer, a wireless terminal device, an embedded device, or a device having a structure similar to that in FIG. 4. A type of the communication apparatus 400 is not limited in this embodiment of this application.

It should be understood that, for the foregoing “problem 1”, embodiments of this application provide a resource allocation method. The method may be performed by a first apparatus. The first apparatus may be the terminal device in FIG. 3 and FIG. 4 or a module or unit of the terminal device (for example, a chip, a chip system, a chip circuit, or a circuit of the terminal device).

In a possible implementation, the first apparatus determines a scaling factor of a frequency domain resource allocation unit, and determines a size of the frequency domain resource allocation unit based on the scaling factor and a preconfigured size of the frequency domain resource allocation unit. In this way, the first apparatus may determine the scaling factor, and determine the size of the frequency domain resource allocation unit based on the scaling factor and the preconfigured size of the frequency domain resource allocation unit, so that an actual granularity of frequency domain resource allocation can be changed, to improve flexibility of the frequency domain resource allocation. Further, the flexibility of the frequency domain resource allocation is improved, so that a waste of an allocated resource can be avoided, or indication overheads for the frequency domain resource allocation can be reduced, to meet a further requirement of a service for reliability. Therefore, the further requirement of the service can be met according to the resource allocation method provided in embodiments of this application.

In another possible implementation, the first apparatus receives indication information, and determines a size of a frequency domain resource allocation unit based on the indication information. The indication information indicates that the size of the frequency domain resource allocation unit is a rounded value of a ratio of a size of a BWP to N, and N is an integer greater than or equal to 1. In this way, the first apparatus may receive the indication information, and determine, based on the indication information, that the size of the frequency domain resource allocation unit is the ratio of the size of the BWP to N, to improve flexibility of frequency domain resource allocation. Further, the flexibility of the frequency domain resource allocation is improved, so that a waste of an allocated resource can be avoided, or indication overheads for the frequency domain resource allocation can be reduced, to meet a further requirement of a service for reliability.

It should be further understood that, for the foregoing “problem 2”, embodiments of this application provide an information receiving method. The method may be performed by a first apparatus. The first apparatus may be the foregoing terminal device or a module or unit of the terminal device (for example, a chip, a chip system, a chip circuit, or a circuit of the terminal device).

In a possible implementation, the first apparatus receives indication information, where the indication information indicates whether there is a DMRS in a time domain unit scheduled by using the indication information. The first apparatus determines, based on the indication information, whether there is a DMRS in the time domain unit scheduled by using the indication information. In this way, the first apparatus may receive the indication information, and determine, based on the indication information, whether there is a DMRS in the time domain unit scheduled by using the indication information. In other words, there may be or may not be a DMRS in the scheduled time domain unit. This can improve flexibility of a DMRS design. Further, the flexibility of the DMRS design is improved, so that DMRS redundancy can be avoided, and time domain resource utilization during data transmission is improved, to meet a further requirement of a service for a data transmission rate. Therefore, the further requirement of the service can be met according to the information receiving method provided in embodiments of this application.

The foregoing methods provided in embodiments of this application are described below in detail with reference to FIG. 3 to FIG. 10.

It should be understood that, in the following embodiments of this application, a name of a signal between devices or apparatuses, a name of each parameter in a signal, a name of information carried in a signal, or the like is merely an example, and another name may alternatively be used in a specific implementation. This is not specifically limited in embodiments of this application.

FIG. 5 is a schematic flowchart of a resource allocation method according to an embodiment of this application. As shown in FIG. 5, the resource allocation method includes the following steps.
S501: A first apparatus determines a scaling factor of a frequency domain resource allocation unit.
S502: The first apparatus determines a size of the frequency domain resource allocation unit based on the scaling factor and a preconfigured size of the frequency domain resource allocation unit.

The first apparatus may be the terminal device in FIG. 3 and FIG. 4 or a module or unit of the terminal device. For example, the first apparatus may be a chip, a chip system, a chip circuit, or a circuit of the terminal device. A unified description is provided herein, and details are not described below again.

The following separately describes steps S501 and S502 in detail.

For step S501:

The frequency domain resource allocation unit and the scaling factor are first described, and then a manner of determining the scaling factor is described.

### 1. Frequency Domain Resource Allocation Unit

It should be understood that, in embodiments of this application, the frequency domain resource allocation unit represents (or referred to as “reflects” or “indicates”) a unit of frequency domain resource allocation. The size of the frequency domain resource allocation unit is a granularity of the frequency domain resource allocation. For example, for frequency domain resource allocation for a data channel (including a PDSCH and/or a PUSCH), a size (or referred to as a bandwidth) of a frequency domain resource allocated by a network is an integer multiple, for example, one, two, three, or more times, of a size of a frequency domain resource allocation unit.

It may be understood that, according to the related descriptions of the BWP in the “frequency domain resource” above, the first apparatus may operate in a BWP (for example, an active BWP) configured by the network for the first apparatus, so that the network can divide the BWP based on the size of the frequency domain resource allocation unit, to obtain a plurality of frequency domain resource allocation units in different frequency ranges.

Further, when the network allocates a frequency domain resource to the first apparatus, a plurality of allocated frequency domain resource allocation units may be consecutive or non-consecutive in frequency domain. This is not specifically limited in embodiments of this application.

It may be understood that, considering that a subcarrier or the RE described in the “frequency domain resource” above may be a minimum frequency domain resource in the network, the frequency domain resource allocation unit in embodiments of this application may include a plurality of subcarriers or REs, in other words, the size of the frequency domain resource allocation unit may be represented or reflected by a quantity of subcarriers or REs. For example, the size of the frequency domain resource allocation unit may be 1 subcarrier or RE, 2 subcarriers or REs, 3 subcarriers or REs, or more subcarriers or REs. This is not limited.

It should be understood that the size of the frequency domain resource allocation unit may alternatively be represented or reflected by a bandwidth, and a bandwidth of the frequency domain resource unit may be an integer multiple of an SCS. For example, the bandwidth of the frequency domain resource allocation unit may be one, two, three, or more times the SCS. It may be understood that for a value of the SCS, refer to the related descriptions in the “numerology” above. Details are not described herein again.

In a possible implementation, the frequency domain resource allocation unit may include a plurality of consecutive subcarriers. To be specific, when the network schedules the frequency domain resource, for example, performs frequency domain resource allocation, the scheduling may be performed by scheduling the plurality of consecutive subcarriers. Compared with performing scheduling by using a plurality of discrete subcarriers, this can reduce interaction complexity, to reduce interaction overheads.

Further, considering that an RB includes 12 consecutive subcarriers, the size of the frequency domain resource allocation unit may be represented (or referred to as “reflected” or “indicated”) by a quantity of RBs. For example, the size of the frequency domain resource allocation unit may be an integer multiple of an RB size. For example, the size of the frequency domain resource allocation unit may be equal to 1 RB (namely, 12 times the SCS), 2 RBs (namely, 24 times the SCS), 4 RBs (namely, 48 times the SCS), 8 RBs (namely, 96 times the SCS), or 16 RBs (namely, 192 times the SCS). It may be understood that the size of the frequency domain resource allocation unit may not be an integer multiple of the quantity of RBs. For example, the size of the frequency domain resource allocation unit may be 1.5 RBs or 2.5 RBs.

It should be understood that, to reduce signaling overheads during the frequency domain resource allocation, the preconfigured size of the frequency domain resource allocation unit may be agreed on in a protocol. The following describes the preconfigured size of the frequency domain resource allocation unit.

In a possible implementation, the preconfigured size of the frequency domain resource allocation unit is directly proportional to or approximately directly proportional to a size of the BWP. For example, “approximately directly proportional to” may be: When the preconfigured size of the frequency domain resource allocation unit is less than or equal to a first threshold, the preconfigured size of the frequency domain resource allocation unit is directly proportional to the size of the BWP; or when the preconfigured size of the frequency domain resource allocation unit is greater than a first threshold, the preconfigured size of the frequency domain resource allocation unit remains unchanged. The first threshold may be, for example, 144 RBs or 145 RBs. This is not specifically limited in this embodiment of this application. To be specific, different sizes of the BWP may correspond to different preconfigured sizes of the frequency domain resource allocation unit, in other words, the preconfigured size of the frequency domain resource allocation unit is related to the size of the BWP. In this way, flexibility of the frequency domain resource allocation can be improved.

For example, the frequency domain resource allocation unit includes a plurality of RBs, a division range of the size of the BWP is the division range that is of the size of the BWP and that corresponds to Table 4, and the first threshold is 144 RBs. Correspondences between different size ranges of the BWP and preconfigured sizes of the frequency domain resource allocation unit include:
a. When the size of the BWP is 1 to 36 RBs, the preconfigured size of the frequency domain resource allocation unit may be 2 RBs or 4 RBs.
b. When the size of the BWP is 37 to 72 RBs, the preconfigured size of the frequency domain resource allocation unit may be 4 RBs or 8 RBs.
c. When the size of the BWP is 73 to 144 RBs, the preconfigured size of the frequency domain resource allocation unit may be 8 RBs or 16 RBs.
d. When the size of the BWP is 145 to 275 RBs, the preconfigured size of the frequency domain resource allocation unit may be 16 RBs.

In other words, as the size of the BWP increases, the preconfigured size of the frequency domain resource allocation unit tends to increase.

In another possible implementation, the preconfigured size of the frequency domain resource allocation unit is irrelevant to the size of the BWP. In other words, regardless of a quantity of RBs in the size of the BWP, the preconfigured size of the frequency domain resource allocation unit remains unchanged. For example, regardless of the quantity of RBs in the size of the BWP, the preconfigured size of the frequency domain resource allocation unit may be 12 consecutive subcarriers, namely, 1 RB.

It may be understood that, for the size of the BWP, refer to the related descriptions of the BWP in the “frequency domain resource” and the “resource allocation type 0” above. Details are not described herein again.

It should be understood that, in embodiments of this application, the scaling factor (or scale factor) may be for adjusting the preconfigured size of the frequency domain resource allocation unit. An adjusted preconfigured size of the frequency domain resource allocation unit is the size of the frequency domain resource allocation unit, namely, an actual granularity of the frequency domain resource allocation. It may be understood that, in embodiments of this application, the size of the frequency domain resource allocation unit is the actual granularity of the frequency domain resource allocation, and the preconfigured size of the frequency domain resource allocation unit is a preconfigured granularity of the frequency domain resource allocation.

Further, in embodiments of this application, the scaling factor is merely an example of a name, and another name may alternatively be used. For example, the scaling factor may be replaced with an allocation factor, a resource allocation factor, a quantification factor, or a resource quantification factor. This is not specifically limited in embodiments of this application.

It may be understood that when the preconfigured size of the frequency domain resource allocation unit is related to the size of the BWP, the preconfigured granularity of the frequency domain resource allocation is a preconfigured size that is of the frequency domain resource allocation unit and that corresponds to the size of the BWP configured by the network for the first apparatus. For example, it may be agreed on in a protocol that a preconfigured size that is of the frequency domain resource allocation unit and that corresponds to a size range #1 (for example, 73 to 144 RBs) of the BWP is a preconfigured size #1 (for example, 8 RBs), and a preconfigured size that is of the frequency domain resource allocation unit and that corresponds to a size range #2 (for example, 145 to 275 RBs) of the BWP is a preconfigured size #2 (for example, 16 RBs). Therefore, when the size of the BWP configured by the network for the first apparatus is 264 RBs, the preconfigured granularity of the frequency domain resource allocation is the preconfigured size #2.

### 2. Scaling Factor

In a possible implementation, the size of the frequency domain resource allocation unit is the granularity of the frequency domain resource allocation, and the scaling factor is for determining a ratio between the actual granularity of the frequency domain resource allocation and the preconfigured granularity of the frequency domain resource allocation. In other words, the ratio between the actual granularity of the frequency domain resource allocation and the preconfigured granularity of the frequency domain resource allocation may be determined based on the scaling factor and the preconfigured granularity of the frequency domain resource allocation. That is, the actual granularity of the frequency domain resource allocation is a value obtained by scaling up or scaling down the preconfigured granularity of the frequency domain resource allocation.

For example, the scaling factor may be a logarithmic value of the actual granularity with a base of the preconfigured granularity of the frequency domain resource allocation, in other words, the ratio between the actual granularity of the frequency domain resource allocation and the preconfigured granularity of the frequency domain resource allocation may be determined by using a formula (1).

n=logₚP′ formula (1)

In the formula (1), n is the scaling factor, P′ is the actual granularity of the frequency domain resource allocation, namely, the size of the frequency domain resource allocation unit, and P is the preconfigured granularity of the frequency domain resource allocation, namely, the preconfigured size of the frequency domain resource allocation unit. It may be understood that, according to the formula (1), it may be determined that the ratio between the actual granularity of the frequency domain resource allocation and the preconfigured granularity of the frequency domain resource allocation is Pⁿ⁻¹. In other words, the actual granularity of the frequency domain resource allocation is P′=Pⁿ.

It should be understood that, in the formula (1), the ratio between the actual granularity P′ of the frequency domain resource allocation and the preconfigured granularity P of the frequency domain resource allocation is adjusted by using P as a baseline. For example, assuming that P is 4 RBs, when the scaling factor n is 2, P′ is 16 RBs; or when the scaling factor n is 3, P′ is 64 RBs.

For another example, the scaling factor may alternatively be a logarithmic value of a ratio of P′ to P with a base of 2, in other words, the ratio between the actual granularity of the frequency domain resource allocation and the preconfigured granularity of the frequency domain resource allocation may be determined by using a formula (2).

$$n = {log}_{2} \frac{{P}^{′}}{P} \qquad formula ( 2 )$$

For meanings of the parameters in the formula (2), refer to the formula (1). For the formula (2), the actual granularity of the frequency domain resource allocation is P′=P·2ⁿ In other words, an adjustment amplitude of the ratio of P′ to P is 2ⁿ. For example, when P is 8 RBs, and when the scaling factor n is 1, P′ is 16 RBs; or when the scaling factor n is 2, P′ is 32 RBs. It may be understood that in comparison with the scaling factor in the formula (1), flexibility of adjusting the ratio of P′ to P may be improved for the scaling factor in the formula (2).

It should be understood that, in the foregoing formula (1) and formula (2), the actual granularity P′ of the frequency domain resource allocation may be a rounded value. The rounded value may be a ceiling value or a floor value. For example, for the formula (1), P is 8 RBs, n is ½, and P′=┌\sqrt{8}┐=3, or P′=└\sqrt{8}┘=2. For another example, for the formula (2), P′=┌\sqrt{8}┐=12, or P′=└\sqrt{8}┘=11.

It may be understood that, according to the foregoing related descriptions of the size of the frequency domain resource allocation unit, representation of P by the quantity of RBs is merely an example, and P may alternatively be represented by a quantity of subcarriers or a multiple of the SCS in addition to the quantity of RBs.

In a possible implementation, the size of the frequency domain resource allocation unit is the granularity of the frequency domain resource allocation, and the scaling factor may be a ratio between the actual granularity of the frequency domain resource allocation and the preconfigured granularity of the frequency domain resource allocation. In other words, a ratio of scaling up or scaling down the preconfigured granularity of the frequency domain resource allocation may be determined based on the scaling factor and the preconfigured granularity of the frequency domain resource allocation, to determine the actual granularity of the frequency domain resource allocation. That is, the preconfigured size of the frequency domain resource allocation unit is scaled up or scaled down by using the scaling factor, to flexibly adjust the size of the frequency domain resource allocation unit.

The scaling factor n may be determined by using a formula (3) or a formula (4).

$$n = \frac{{P}^{′}}{P} \qquad formula ( 3 )$$

For meanings of the parameters in the formula (3), refer to the formula (1). Details are not described herein again.

It may be understood that, when the scaling factor is

$$n = \frac{{P}^{′}}{P} ,$$

the actual granularity of the frequency domain resource allocation is P′=P·n. For example, the preconfigured size of the frequency domain resource allocation unit, namely, the preconfigured granularity of the frequency domain resource allocation, is 16 RBs, and the scaling factor is

$$n = \frac{{P}^{′}}{P} = 2 .$$

Therefore, the actual granularity of the frequency domain resource allocation is P′=P·n=32 RBs.

Optionally, P′ may be a ceiling value or a floor value of P·n. For example, when the preconfigured granularity of the frequency domain resource allocation is 16 RBs, and the scaling factor is

$$n = \frac{{P}^{′}}{P} = 1.2 ,$$

the actual granularity of the frequency domain resource allocation is P′=┌P·n┐=┌19.2┐=20 or P′=└P·n┘=└19.2┘=19.

$$n = \frac{P}{{P}^{′}} \qquad formula ( 4 )$$

For meanings of the parameters in the formula (4), refer to the formula (1). Details are not described herein again.

It may be understood that, when the scaling factor is

$$n = \frac{P}{{P}^{′}} ,$$

the actual granularity of the frequency domain resource allocation is

$${P}^{′} = \frac{P}{n} .$$

For example, when the preconfigured size of the frequency domain resource allocation unit, namely, the preconfigured granularity of the frequency domain resource allocation, is 16 RBs, and the scaling factor is

$$n = \frac{P}{{P}^{′}} = 2 ,$$

the actual granularity of the frequency domain resource allocation is

$${P}^{′} = \frac{P}{n} = 8 RBs .$$

Optionally, P′ may be a ceiling value or a floor value of P/n. For example, when the n preconfigured granularity of the frequency domain resource allocation is 16 RBs, and the scaling factor is

$$n = \frac{{P}^{′}}{P} = 1.2 ,$$

the actual granularity of the frequency domain resource allocation is

$${P}^{′} = ⌈ \frac{P}{n} ⌉ = ⌈ 13.3 ⌉ = 14 or {P}^{′} = ⌊ \frac{P}{n} ⌋ = ⌊ 13.3 ⌋ = 13 .$$

It should be understood that, for the scaling factor

$$n = \frac{{P}^{′}}{P}$$

in the foregoing formula (3), a value of the scaling factor in the formula (3) may be equal to

$$\frac{{P}^{′}}{P}$$

in the foregoing formula (1) or formula (2). Therefore, a relationship between the value of the scaling factor in the foregoing formula (3) and the scaling factor in the foregoing formula (1) or formula (2) may be represented by a formula (5).

$$n 3 = \frac{{P}^{′}}{P} = {P}^{n 1 - 1} = {2}^{n 2} \qquad formula ( 5 )$$

In the formula (5), n3 represents the scaling factor in the formula (3), n1 represents the scaling factor in the formula (1), and n2 represents the scaling factor in the formula (2). A relationship between n1 and n2 may also be determined by using the formula (5).

Further, because the scaling factor in the formula (4) is a reciprocal of the scaling factor in the formula (3), a value of the scaling factor n4 in the formula (4) may be equal to P¹⁻ⁿ¹ or 2⁻ⁿ².

It may be understood that, in this embodiment of this application, a scaling-up or scaling-down case of the frequency domain resource allocation unit varies with the frequency domain resource allocation unit. The following uses a case 1 and a case 2 for separate description.

### Case 1:

In a possible implementation, the frequency domain resource allocation unit may be an RBG or an RB. To be specific, the preconfigured size of the frequency domain resource allocation unit may be an original RBG size or an original RB size. Therefore, when the frequency domain resource allocation is performed at a granularity of the RBG (to be specific, in a case corresponding to a resource allocation type 0), or the frequency domain resource allocation is performed at a granularity of the RB (to be specific, in a case corresponding to a resource allocation type 1), the original RBG size or the original RB size may be scaled up or scaled down by using the scaling factor to obtain an RBG size or an RB size, to flexibly adjust the granularity of the frequency domain resource allocation, and improve the flexibility of the frequency domain resource allocation.

It may be understood that, for the RB, a preconfigured size of the RB is 12 subcarriers. For the RBG, a preconfigured size of the RBG may be determined based on an rbg-Size parameter (indicating that an RBG configuration is an RBG configuration 1 or an RBG configuration 2) in a PDSCH-Config information element and the size of the BWP configured by the network for the first apparatus. For a specific determining manner, refer to the related descriptions of the resource allocation type 0 in the “frequency domain resource allocation”. Details are not described herein again.

It should be understood that, in the resource allocation type 1, scaling up or scaling down an RB size may be scaling up or scaling down an RB size for the data channel (for example, the PDSCH or the PUSCH). In other words, when the RB size is scaled up or scaled down, an RB size of an RB corresponding to at least one of the following may not be changed: a resource element group (REG), an REG bundle, a physical uplink control channel (PUCCH), or a sounding reference signal (SRS).

Further, if a precoding resource block group (PRG) is indicated as a non-full-band PRG, an RB size of an RB included in the PRG is consistent with an RB size of an RB for data transmission. In addition, for virtual RB-to-PRB interleaved mapping, an RB size of an RB included in a unit (namely, an RB bundle) of the VRB-to-PRB interleaved mapping is consistent with the RB size of the RB for the data transmission. It may be understood that, for details about the PRG and the VRB-to-PRB interleaved mapping, refer to descriptions in a related 3GPP TS, and the details are not described herein.

It should be further understood that, in the resource allocation type 0, an RB size may remain unchanged when the RBG size is scaled up or scaled down.

It may be understood that, in the case 1, the RBG size or the RB size may be separately scaled up or scaled down. In this embodiment of this application, the RBG size and the RB size may be both scaled up or scaled down. The following provides descriptions with reference to the case 2.

### Case 2:

In a possible implementation, the frequency domain resource allocation unit includes an RBG and an RB. In other words, an RBG size and an RB size may be both scaled up or scaled down by using the scaling factor.

For example, assuming that the scaling factor is the scaling factor in the formula (3), scaling factors respectively corresponding to the RBG and the RB are both 2, an original RBG size is 2 original RB sizes, and the original RB size is 12 subcarriers, a scaled-up RB size is 24 subcarriers, and a scaled-up RBG size is 4 scaled-up RB sizes, namely, 8 original RB sizes.

For another example, assuming that the scaling factor is the scaling factor in the formula (3), scaling factors respectively corresponding to the RBG and the RB are both 0.5, an original RBG size is 2 original RB sizes, and the original RB size is 12 subcarriers, a scaled-down RB size is 6 subcarriers, and a scaled-down RBG size is 1 scaled-down RB size, namely, 0.5 times the original RB size.

It should be understood that the scaling factor corresponding to the RBG may be different from the scaling factor corresponding to the RB. For example, assuming that the scaling factor is the scaling factor in the formula (3), the scaling factor corresponding to the RBG is 3, the scaling factor corresponding to the RB is 2, an original RBG size is 2 original RB sizes, and the original RB size is 12 subcarriers, a scaled-up RB size is 24 subcarriers, and a scaled-up RBG size is 6 scaled-up RB sizes, namely, 12 original RB sizes.

It may be understood that the scaling factor corresponding to the RBG may be for scaling up the original RBG size, and the scaling factor corresponding to the RB may be for scaling down the original RB size; the scaling factor corresponding to the RBG may be for scaling up the original RBG size, and the scaling factor corresponding to the RB may be for scaling up the original RB size; the scaling factor corresponding to the RBG may be for scaling down the original RBG size, and the scaling factor corresponding to the RB may be for scaling down the original RB size; or the scaling factor corresponding to the RBG may be for scaling down the original RBG size, and the scaling factor corresponding to the RB may be for scaling up the original RB size. This is not specifically limited in this embodiment of this application.

The following further describes a relationship between a value of the scaling factor and scaling-up or scaling-down of the preconfigured granularity of the frequency domain resource allocation.

In a possible implementation, the value of the scaling factor is greater than 1.

To be specific, for the formula (3), that is, the scaling factor is the ratio between the actual granularity of the frequency domain resource allocation and the preconfigured granularity of the frequency domain resource allocation, if the scaling factor is greater than 1, the preconfigured granularity of the frequency domain resource allocation, for example, the original RBG size or the original RB size, may be scaled up, so that the actual granularity of the frequency domain resource allocation becomes larger. Further, the actual granularity of the frequency domain resource allocation becomes larger, so that indication overheads for the frequency domain resource allocation can be reduced, to improve reliability of the indication overheads (for example, DCI) for the frequency domain resource allocation and a channel (for example, a PDCCH) that carries the indication overheads for the frequency domain resource allocation.

It should be understood that the scaling-up of the preconfigured granularity of the frequency domain resource allocation is applicable to, for example, the “application scenario with a small quantity of served terminal devices” described in the “problem 1” above. In this way, a further requirement of a service for reliability can be met.

For example, when the frequency domain resource allocation unit is the RBG, according to the related descriptions in the “resource allocation type 0” above, when the size of the BWP is 275 RBs, the RBG size is 16 RBs. Therefore, when the frequency domain resource allocation is indicated by an FDRA field in the DCI, bit overheads of the FDRA field in the DCI are [275/16]=18 bits. Assuming that the preconfigured size of the frequency domain resource allocation unit is adjusted by using the scaling factor n=2, the size of the frequency domain resource allocation unit (namely, the actual granularity of the frequency domain resource allocation) is 32 RBs. In this way, the bit overheads of the FDRA field in the DCI are [275/32]=9 bits, so that the indication overheads for the frequency domain resource allocation can be reduced, to improve reliability of the DCI.

It may be understood that, when the frequency domain resource allocation unit is the RB, according to the related descriptions in the “resource allocation type 1” above, bit overheads of an FDRA field in the DCI are directly proportional to a size of a downlink BWP. Therefore, for the frequency domain resource allocation, when the RB size is scaled up, a quantity of RBs included in the downlink BWP decreases accordingly, in other words, the size of the downlink BWP decreases. In this way, the bit overheads of the FDRA field in the DCI are reduced accordingly.

For example, the scaling factor may be 2, 3, 4, or a larger positive integer value. Further, because a value of an RBG size P is usually an exponential multiple of 2, in consideration of a compromise between scheduling flexibility and scheduling overheads, the value of the scaling factor may be an exponential value of 2, for example, 2, 4, or 8. This can achieve a match with the original RBG size.

It should be understood that, for the scaling factor in the foregoing formula (1), when the value of the scaling factor is greater than 1, the actual granularity of the frequency domain resource allocation may also be scaled up, to reduce indication overheads for the frequency domain resource allocation. For the scaling factor in the foregoing formula (2), when the value of the scaling factor is greater than 0, indication overheads for the frequency domain resource allocation may be reduced.

Further, for the scaling factor in the foregoing formula (1) or formula (3), when the value of the scaling factor is 1, the actual granularity of the frequency domain resource allocation is equal to the preconfigured granularity of the frequency domain resource allocation, in other words, the actual granularity of the frequency domain resource allocation does not change. Similarly, when the value of the scaling factor in the formula (2) is 0, the actual granularity of the frequency domain resource allocation does not change either.

It may be understood that, the scaling factor in the formula (4) and the scaling factor in the formula (3) are reciprocal to each other, and correspond to opposite functions. For example, when the value of the scaling factor is less than 1, the scaling factor in the formula (4) is equivalent to scaling up the actual granularity of the frequency domain resource allocation. For another example, when the value of the scaling factor is greater than 1, the scaling factor in the formula (4) is equivalent to scaling down the preconfigured granularity of the frequency domain resource allocation, in other words, the actual granularity of the frequency domain resource allocation becomes smaller.

In another possible implementation, the value of the scaling factor is less than 1.

To be specific, for the formula (3), if the scaling factor is less than 1, the preconfigured granularity of the frequency domain resource allocation, for example, the original RBG size or the original RB size, may be scaled down, so that the actual granularity of the frequency domain resource allocation becomes smaller. Further, that the actual granularity of the frequency domain resource allocation becomes smaller is applicable to, for example, the “service with a small size of transmitted data” described in the “problem 1” above, so that a waste of an allocated resource can be avoided, and network quality can be improved.

For example, when the frequency domain resource allocation unit is the RBG, according to the related descriptions in the “resource allocation type 0” above, when the size of the BWP is 275 RBs, the preconfigured size of the frequency domain resource allocation unit is 16 RBs. Assuming that a service type is a small data service, the preconfigured size of the frequency domain resource allocation unit may be adjusted by using the scaling factor n=½, to scale down the original RBG size (16 RBs) by 8 RBs, to avoid a waste of an allocated resource.

It may be understood that, when the frequency domain resource allocation unit is the RB, according to the related descriptions in the “resource allocation type 1” above, the original RBG size (namely, 12 subcarriers) may be scaled down to 6 subcarriers by using the scaling factor, for example, n=½.

Further, according to the foregoing related descriptions of the “resource allocation type 0”, when the original RBG size is scaled down, bit overheads of an FDRA field increase when the frequency domain resource allocation is indicated by the FDRA field in DCI. For example, when the original RBG size is scaled down from 16 RBs to 8 RBs, the bit overheads of the FDRA field are ┌275/8┐=35 bits. Certainly, alternatively, a specific frequency domain position that is in an original RBG and at which an allocated RBG is located after scaling-down may be indicated by position indication information based on the original RBG size. In this way, overheads of the DCI can be avoided from being multiplied.

For example, when the scaling factor is ½, to be specific, a scaled-down RBG size is 8 RBs, and an RBG size before scaling-down is 16 RBs, 1-bit position indication information may be added to indicate whether the 8 RBs are located in first half or second half of the 16 RBs. In this way, the bit overheads of the FDRA field in the DCI are 18+1=19 bits, and 26 bit overheads may be reduced in comparison with 35 bits. Further, a bit occupied by the position indication information may start from an MSB of the FDRA field. For 1 bit included in the position indication information, if the bit is 1, the bit may indicate the first half; or if the bit is 0, the bit may indicate the second half. Certainly, 1 may alternatively indicate the second half, and 0 indicates the first half. In addition, the bit occupied by the position indication information may alternatively be an LSB. This is not specifically limited in this embodiment of this application.

Alternatively, the position indication information may be indicated by a reserved (reserved) bit or another field in the DCI. In other words, the position indication information may alternatively be located in a field other than the FDRA field in the DCI. In this way, a conflict can be avoided when the MSB in the FDRA field is occupied (for example, when the resourceAllocation parameter in the “frequency domain resource allocation” above indicates dynamic switching, the MSB in the FDRA field is occupied to indicate a resource allocation type).

It may be understood that bit overheads of the position indication information are inversely proportional to the foregoing scaling factor. For example, when the scaling factor is ½, the bit overheads of the position indication information are 1 bit. When the scaling factor is ¼, to be specific, a scaled-down RBG size is 4 RBs, and an RBG size before scaling-down is 16 RBs, the indication overheads of the position indication information are 2 bits, where the 2 bits may indicate a segment that is in the 16 RBs and in which the 4 RBs are located.

For example, the 16 RBs included in an RBG are an RB #1 to an RB #16, the RB #1 to the RB #16 may be divided into four segments, a segment #1 may include first four RBs (namely, the RB #1 to the RB #4) in the 16 RBs, a segment #2 may include last four RBs (namely, the RB #5 to the RB #8) in first eight RBs, and a segment #3 may include first four RBs in last eight RBs. Therefore, 2 bits 00 may indicate the segment #1, 2 bits 01 may indicate the segment #2, 2 bits 10 may indicate the segment #3, and 2 bits 11 may indicate a segment #4. It may be understood that the foregoing correspondence between 2 bits and a segment is merely an example, and another correspondence may be used. For example, 2 bits 00 indicate the segment #3, 2 bits 01 indicate the segment #2, 2 bits 10 may indicate the segment #4, and 2 bits 11 may indicate the segment #3. This is not specifically limited in this embodiment of this application.

It should be understood that for the resource allocation type 1, an allocated RB may also be indicated in the foregoing frequency domain resource allocation indication manner. Details are not described herein again.

For example, the scaling factor may be 0.8, 0.6, 0.5, 0.25, or a smaller positive value. Further, because a value of an RBG size P is usually an exponential multiple of 2, in consideration of a compromise between scheduling flexibility and scheduling overheads, the value of the scaling factor may be an exponential value of 2, for example, 0.5, 0.25, or 0.125. This can achieve a match with the original RBG size.

It should be understood that, for the scaling factor in the foregoing formula (1), when the value of the scaling factor is less than 1, the actual granularity of the frequency domain resource allocation may be scaled down, to avoid the waste of the allocated resource. For the scaling factor in the foregoing formula (2), when the value of the scaling factor is less than 0, the actual granularity of the frequency domain resource allocation may be scaled down.

### 3. Manner of Determining the Scaling Factor

In a possible implementation, the scaling factor is preconfigured, or the scaling factor is indicated. In other words, the scaling factor may be agreed on in a protocol. In this way, indication overheads for the scaling factor can be reduced. Alternatively, the scaling factor may be indicated by the network, so that the network can flexibly adjust the actual granularity of the frequency domain resource allocation based on a requirement of a service.

For example, service types in the network include a small data service and a large data service, and the network may indicate a value range of the scaling factor based on the service type, to flexibly adjust the actual granularity of the frequency domain resource allocation. For example, when the service type is the small data service, the network may indicate a scaling factor for scaling down the preconfigured granularity of the frequency domain resource allocation; or when the service type is the large data service, the network may indicate a scaling factor for scaling up the preconfigured granularity of the frequency domain resource allocation.

It may be understood that the scaling factor may alternatively be negotiated between the first apparatus and the network. For example, the first apparatus is a terminal device, and the terminal device and a network device may negotiate the specific value of the scaling factor.

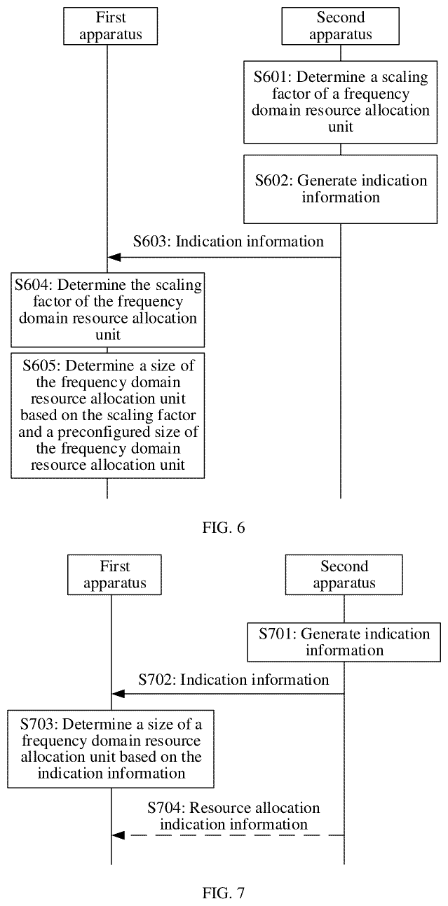

In a possible implementation, the network may indicate the scaling factor before step S501. For a specific implementation of indicating the scaling factor by the network, refer to the following method procedure shown in FIG. 6.

It may be understood that, that the scaling factor is indicated may be replaced with: The scaling factor is configured. A unified description is provided herein, and details are not described below again.

In a possible implementation, that the first apparatus determines the scaling factor of the frequency domain resource allocation unit (namely, step S501) includes: The first apparatus determines the scaling factor from a candidate scaling factor set based on a configured FR and/or a configured SCS, where the candidate scaling factor set includes at least two scaling factors.

The configured FR and/or SCS may be configured by the network. For example, the network device may configure the FR and/or the SCS for the first apparatus. For specific ranges or values of the FR and the SCS, refer to the related descriptions in the “time-frequency resource in an NR system” above. Details are not described herein again.

The candidate scaling factor set may be preconfigured. For example, one or more candidate scaling factor sets may be predefined in a protocol. The scaling factors in the candidate scaling factor set include at least one of the following types of scaling factors: a scaling factor for scaling up the preconfigured granularity of the frequency domain resource allocation, a scaling factor for scaling down the preconfigured granularity of the frequency domain resource allocation, or a scaling factor for not changing the preconfigured granularity of the frequency domain resource allocation.

In other words, the first apparatus may select an appropriate scaling factor from the candidate scaling factor set based on the configured FR and/or the configured SCS, so that the granularity of the frequency domain resource allocation matches the service requirement.

For example, for the foregoing formula (3), that is, the scaling factor is the ratio between the actual granularity of the frequency domain resource allocation and the preconfigured granularity of the frequency domain resource allocation, a value of the scaling factor for scaling up the preconfigured granularity of the frequency domain resource allocation is greater than 1, for example, 2, 4, or 8, a value of the scaling factor for scaling down the preconfigured granularity of the frequency domain resource allocation is less than 1, for example, 0.5, 0.25, or 0.125, and a value of the scaling factor for not changing the preconfigured granularity of the frequency domain resource allocation may be equal to 1.

The following describes the candidate scaling factor set.

It may be understood that the candidate scaling factor set preconfigured for the first apparatus may include the scaling factor for not changing the preconfigured granularity of the frequency domain resource allocation and the scaling factor for scaling up the preconfigured granularity of the frequency domain resource allocation. For example, it may be agreed on in a protocol that the candidate scaling factor set is [1, 2], [1, 4], or [1, 8]. Further, that the first apparatus determines the scaling factor from the candidate scaling factor set based on the configured FR may include the following cases:

Case A: When the configured FR falls within a frequency range corresponding to FR1, the first apparatus may select an element 1 in the candidate scaling factor set as the value of the scaling factor.

Case B: When the configured FR falls within a frequency range (for example, FR2) higher than FR1, the first apparatus may select an element greater than 1 in the candidate scaling factor set as the value of the scaling factor.

Further, that the first apparatus determines the scaling factor from the candidate scaling factor set based on the configured SCS may include the following cases:

Case C: When the configured SCS is less than or equal to 60 kHz, the first apparatus may select the element 1 in the candidate scaling factor set as the value of the scaling factor.

Case D: When the configured SCS is greater than 60 kHz (for example, 120 kHz or 240 kHz), the first apparatus may select an element greater than 1 in the candidate scaling factor set as the value of the scaling factor.

It may be further understood that the first apparatus may determine the scaling factor from the candidate scaling factor set based on the configured FR and the configured SCS, for example:

Case E: When the configured FR falls within a frequency range corresponding to FR1, and the configured SCS is less than or equal to 60 kHz, the first apparatus may select the element 1 in the candidate scaling factor set as the value of the scaling factor.

Case F: When the configured FR falls within a frequency range higher than FR1, and the configured SCS is greater than 60 kHz, the first apparatus may select an element greater than 1 in the candidate scaling factor set as the value of the scaling factor.

It should be understood that the candidate scaling factor set preconfigured for the first apparatus may include the scaling factor for not changing the preconfigured granularity of the frequency domain resource allocation and the scaling factor for scaling down the preconfigured granularity of the frequency domain resource allocation. For example, it may be agreed on in a protocol that the candidate scaling factor set is [0.5, 1], [0.25, 1], or [0.125, 1].

Further, the first apparatus may select, when determining that the service is a small data service, an element less than 1 in the candidate scaling factor set as the value of the scaling factor. For example, the first apparatus may determine, based on an application type, that the service is a small data service, and then report the service type to the network, so that the first apparatus and the network may determine that the scaling factor during the frequency domain resource allocation is the element less than 1 in the candidate scaling factor set. Certainly, the network may alternatively notify the first apparatus that the service is a small data service, or notify the first apparatus to select an element less than 1 in the candidate scaling factor set, so that the first apparatus and the network may determine that the scaling factor during the frequency domain resource allocation is the element less than 1 in the candidate scaling factor set. It may be understood that, when the first apparatus does not determine that the service is a small data service, or is indicated not to scale down the preconfigured granularity of the frequency domain resource allocation, the first apparatus may select the element 1 in the candidate scaling factor set as the value of the scaling factor.

It should be further understood that the candidate scaling factor set preconfigured for the first apparatus may include the scaling factor for not changing the preconfigured granularity of the frequency domain resource allocation, the scaling factor for scaling up the preconfigured granularity of the frequency domain resource allocation, and the scaling factor for scaling down the preconfigured granularity of the frequency domain resource allocation. For example, it may be agreed on in a protocol that the candidate scaling factor set is [0.5, 1, 2], [0.25, 1, 2], [0.125, 1, 2], or [0.5, 1, 4].

Further, when the first apparatus does not determine that the service is a small data service, or is indicated not to scale down the preconfigured granularity of the frequency domain resource allocation, the first apparatus may select a corresponding scaling factor from the candidate scaling factor set based on the foregoing cases A to F; or when the first apparatus determines that the service is a small data service or is indicated to scale down the preconfigured granularity of the frequency domain resource allocation, the first apparatus selects an element less than 1 in the candidate scaling factor set as the value of the scaling factor.

In a possible implementation, that the first apparatus determines the scaling factor from the candidate scaling factor set based on the configured FR and/or the configured SCS includes: The first apparatus determines the scaling factor from the candidate scaling factor set based on a correspondence between the FR and the scaling factor and/or a correspondence between the SCS and the scaling factor.

The candidate scaling factor set may be [1, 4, 8], [1, 2, 4, 8], or the like. For details, refer to the foregoing related descriptions of the candidate scaling factor set, and the details are not described herein again.

For example, for the scaling factor in the formula (3), that is, the scaling factor is the ratio between the actual granularity of the frequency domain resource allocation and the preconfigured granularity of the frequency domain resource allocation, a scaling factor corresponding to FR1 is less than a scaling factor corresponding to FR2, and the scaling factor corresponding to FR2 is less than a scaling factor corresponding to FR2-2. For another example, when the SCS is less than or equal to 60 kHz, a corresponding scaling factor is 1, and a larger SCS indicates a larger value of the scaling factor.

In other words, the first apparatus may further select a more appropriate scaling factor from the candidate scaling factor set based on the correspondence between the FR and the scaling factor and/or the correspondence between the SCS and the scaling factor, so that the granularity of the frequency domain resource allocation better matches the requirement of the service.

For example, the candidate scaling factor set may include the scaling factor for not changing the preconfigured granularity of the frequency domain resource allocation and the scaling factor for scaling up the preconfigured granularity of the frequency domain resource allocation. It may be agreed on in a protocol that the candidate scaling factor set is [1, 2, 4], [1, 4, 8], [1, 2, 4, 8], or the like. An example in which the candidate scaling factor set is [1, 4, 8] is used. The scaling factor corresponding to FR1 is the element 1, the scaling factor corresponding to FR2 is the element 4, and the scaling factor corresponding to FR-2 is the element 8. When the SCS is less than or equal to 60 kHz, the corresponding scaling factor is the element 1; when the SCS is equal to 120 kHz, a corresponding scaling factor is the element 4; or when the SCS is equal to 240 kHz, a corresponding scaling factor is the element 8.

It should be understood that, according to the related descriptions in the “time-frequency resource in an NR system” above, there may be a correspondence between an FR and an SCS. For example, a small SCS, for example, an SCS less than or equal to 60 kHz, is usually configured for FR1 correspondingly, to avoid excessively large time domain overheads occupied by a CP. For another example, a large SCS, for example, 120 kHz or 240 kHz, is usually configured for FR2 and FR2-2 correspondingly, to avoid large inter-subcarrier interference caused by a Doppler shift in a high-frequency band. In other words, when the configured FR is FR2, the SCS may be 120 kHz or 240 kHz; or when the configured FR is FR2-2, the SCS may be 120 kHz or 240 kHz.

Further, when the configured FR is FR2, and the SCS is 240 kHz, it may be agreed on in a protocol that a smaller value (for example, 4) in scaling factors respectively corresponding to the FR and the SCS is selected as the value of the scaling factor. Certainly, it may alternatively be agreed on in a protocol that a larger value (for example, 8) in scaling factors respectively corresponding to the FR and the SCS is selected as the value of the scaling factor.

It should be further understood that an example in which the candidate scaling factor set is [1, 4, 8] is merely used above for description. When the candidate scaling factor set is [1, 2, 4], the scaling factor corresponding to FR1 is 1, the scaling factor corresponding to FR2 is 2, and the scaling factor corresponding to FR2-2 is 4. When the SCS is less than or equal to 60 kHz, the corresponding scaling factor is 1; when the SCS is equal to 120 kHz, the corresponding scaling factor is the element 2; or when the SCS is equal to 240 kHz, the corresponding scaling factor is the element 4.

It may be understood that the scaling-up of the preconfigured granularity of the frequency domain resource allocation is merely used as an example above. In correspondence to the scaling-down of the preconfigured granularity of the frequency domain resource allocation, the correspondence between the FR and the scaling factor may include, for example: When the service type is a small data service, or it is determined to scale down the preconfigured granularity of the frequency domain resource allocation, a scaling factor corresponding to FR1 is 1, a scaling factor corresponding to FR2 is 0.5, and a scaling factor corresponding to FR2-2 is 0.25.

Further, the correspondence between the SCS and the scaling factor may include, for example: When the service type is a small data service, or it is determined to scale down the preconfigured granularity of the frequency domain resource allocation, and when the SCS is less than or equal to 60 kHz, a corresponding scaling factor is 1; when the SCS is equal to 120 kHz, a corresponding scaling factor is the element 0.5; or when the SCS is equal to 240 kHz, a corresponding scaling factor is the element 0.25.

It should be understood that the foregoing example is described by using an example in which the scaling factor is the scaling factor in the formula (3). A scaling factor in the formula (1), the formula (2), or the formula (4) may be determined based on a relationship between the foregoing formula (1) to formula (4), and details are not described herein.

For step S502: It may be understood that, according to the related descriptions of the formula (1) to formula (4) in step S501, the first apparatus may determine the size of the frequency domain resource allocation unit (namely, the actual granularity P′ of the frequency domain resource allocation) based on the scaling factor n and the preconfigured size of the frequency domain resource allocation unit (namely, the preconfigured granularity P of the frequency domain resource allocation). Details are as follows:

For the formula (1), n=logₚ P′, and P′=P″, P′ is a ceiling value P′=┌P″┐ of Pⁿ, or P′ is a floor value P′=└Pⁿ┘ of Pⁿ.

For the formula (2),

$$n = {log}_{2} \frac{{P}^{′}}{P} ,$$

and P′=P·2ⁿ, P′ is a ceiling value P′=┌P·2ⁿ┐ of P·2ⁿ, or P′ is a floor value P′=└P·2ⁿ┘ of P·2ⁿ.

For the formula (3),

$$n = \frac{{P}^{′}}{P} ,$$

and P′=P·n, P′ is a ceiling value P′=┌P·n┐ of P·n, or P′ is a floor value P′=└P·n┘ of P·n.

For the formula (3),

$$n = \frac{P}{{P}^{′}} , and {P}^{′} = \frac{P}{n} ,$$

P′ is a ceiling value

$${P}^{′} = ⌈ \frac{P}{n} ⌉$$

of P/n, or P′ is a floor value

$${P}^{′} = ⌊ \frac{P}{n} ⌋ of \frac{P}{n} .$$

For example, using the scaling factor n in the formula (3) as an example, when the frequency domain resource allocation unit is the RBG, the RBG size may be determined by using the following table.

TABLE 6

| Size of the BWP | RBG configuration 1 | RBG configuration 2 |
|---|---|---|
| (quantity of RBs) | (quantity of RBs) | (quantity of RBs) |
| 1 to 36 | 2 · n | 4 · n |
| 37 to 72 | 4 · n | 8 · n |
| 73 to 144 | 8 · n | 16 · n |
| 145 to 275 | 16 · n | 16 · n |

A value set of the scaling factor n in Table 6 is [1, 2, 4, 8], and the first apparatus may determine the specific value of the scaling factor based on the configured FR and/or the configured SCS.

For example, using the scaling factor n in the formula (3) as an example, when the frequency domain resource allocation unit is the RB, the RB size may be P′=12·n, namely, 12·n subcarriers.

It may be understood that, with reference to the related descriptions of the “frequency domain resource allocation” above, the first apparatus may determine, by using RRC signaling and the DCI, that the frequency domain resource allocation unit is the RBG or the RB. For example, it may be determined by using a resourceAllocation field in the PDSCH-Config information element in the RRC signaling that a frequency domain resource allocation mode is the resource allocation type 0, the resource allocation type 1, or the dynamic switching. When the resourceAllocation field indicates the resource allocation type 0, it may be determined by using the rbg-Size parameter in the PDSCH-Config information element that the RBG configuration is the RBG configuration 1 or the RBG configuration 2. In this way, the first apparatus may determine a scaled-up RBG size P, namely, the actual granularity of the frequency domain resource allocation, based on the configured FR and/or the configured SCS, the configured BWP, and Table 6.

Further, during the frequency domain resource allocation, the FDRA field in the DCI is a bitmap for an allocated RBG, so that the first apparatus can determine, based on the FDRA field in the DCI, one or more RBGs allocated by the network to the first apparatus.

It should be understood that, as indicated in the “resource allocation type 0” above, when RBG-based resource allocation is performed, quantities of RBs included in RBGs at head and tail ends may be less than the RBG size Pin Table 4. When the RBG size is scaled up or scaled down by using the scaling factor, quantities of RBs included in a 1^{st} scaled-up or scaled-down RBG and a last scaled-up or scaled-down RBG may be less than or equal to a quantity of RBs included in an RBG other than the 1^{st} RBG and the last RBG within the BWP.

When the resourceAllocation field indicates the resource allocation type 1, the first apparatus may determine that the frequency domain resource allocation unit is the RB, so that the first apparatus can determine a scaled-up or scaled-down RB size based on the configured FR and/or the configured SCS, the configured BWP, and P′=12·n.

Further, during the frequency domain resource allocation, the FDRA field in the DCI is a RIV value, so that the first apparatus can determine, based on the RIV value, one or more RBs allocated by the network to the first apparatus.

It may be further understood that when the resourceAllocation field indicates the dynamic switching, the first apparatus may determine, by using the MSB in the FDRA field in the DCI, that the resource allocation type is the resource allocation type 0 or the resource allocation type 1, to determine that the frequency domain resource allocation unit is the RBG or the RB.

It should be understood that, in this embodiment of this application, the size that is of the frequency domain resource allocation unit and that is determined by using the scaling factor may be for downlink frequency domain resource allocation and/or uplink frequency domain resource allocation. Further, the foregoing related example is described by using the PDSCH in the downlink frequency domain resource allocation as an example. The foregoing implementation is also applicable to downlink frequency domain resource allocation for another channel and frequency domain resource allocation for the PUSCH or another uplink channel. A unified description is provided herein, and details are not described below again.

In this embodiment of this application, the first apparatus may determine the scaling factor, and determine the size of the frequency domain resource allocation unit based on the scaling factor and the preconfigured size of the frequency domain resource allocation unit, so that the actual granularity of frequency domain resource allocation can be changed, to improve the flexibility of the frequency domain resource allocation. Further, the flexibility of the frequency domain resource allocation is improved, so that the waste of the allocated resource can be avoided, or the indication overheads for the frequency domain resource allocation can be reduced, to meet the further requirement of the service for the reliability. Therefore, the further requirement of the service can be met according to the resource allocation method provided in this embodiment of this application.

The processor 401 in the communication apparatus 400 shown in FIG. 4 may instruct the communication apparatus 400 to perform the actions of the first apparatus in steps S501 and S502, or the processor 401 in the communication apparatus 400 shown in FIG. 4 may invoke the application program code stored in the memory 403 to instruct the communication apparatus 400 to perform the actions of the first apparatus in steps S501 and S502. This is not specifically limited in this embodiment of this application.

It should be understood that, as described above, before step S501, the network may indicate the scaling factor. In this way, the network may flexibly adjust the actual granularity of the frequency domain resource allocation based on the service requirement. The following uses an example in which a second apparatus indicates the scaling factor to the first apparatus, to describe the specific implementation of indicating the scaling factor by the network.

FIG. 6 is a schematic flowchart of another resource allocation method according to an embodiment of this application. As shown in FIG. 6, the resource allocation method includes the following steps S601 to S605. Steps S604 and S605 are the same as steps S501 and S502 above. Details are not described herein again.
S601: A second apparatus determines a scaling factor of a frequency domain resource allocation unit.

The second apparatus may be the network device in FIG. 3 and FIG. 4 or a module or unit of the network device. For example, the second apparatus may be a chip, a chip system, a chip circuit, or a circuit of the network device. A unified description is provided herein, and details are not described below again.

It should be understood that the second apparatus may select, based on a service type, network load, or the like, a scaling factor for scaling up a preconfigured granularity of frequency domain resource allocation or a scaling factor for scaling down the preconfigured granularity of the frequency domain resource allocation, to flexibly adjust an actual granularity of the frequency domain resource allocation. For a specific implementation, refer to the related descriptions in step S501. Details are not described herein again.
S602: The second apparatus generates indication information, where the indication information indicates the scaling factor of the frequency domain resource allocation unit.
S603: The second apparatus sends the indication information to a first apparatus.

Correspondingly, the first apparatus receives the indication information.

The following specifically describes steps S602 and S603.

For step S602:

The indication information may be classified into two types. The following separately provides descriptions.

### A. Type 1

In a possible implementation, the indication information includes first indication information and second indication information. The first indication information indicates a candidate scaling factor set, and the second indication information is for determining the scaling factor from the candidate scaling factor set. The candidate scaling factor set includes at least two scaling factors.

It should be understood that a difference between the candidate scaling factor set in step S602 and the candidate scaling factor set in step S501 lies in: The candidate scaling factor set in step S602 is indicated by the first indication information, to be specific, the candidate scaling factor set in step S602 may be configured by a network by using higher layer signaling, where the higher layer signaling may be RRC signaling. The candidate scaling factor set may be [1, 4, 8], [1, 2, 4, 8], [0.5, 1], [0.25, 1], [0.125, 1], [0.25, 0.5, 1, 2, 4], [0.25, 0.5, 1, 2, 4, 8], or the like. Certainly, the first indication information may alternatively indicate a plurality of candidate scaling factor sets. It may be understood that for a specific value of the element in the candidate scaling factor set, refer to the candidate scaling factor set in step S501. Details are not described herein again.

Further, the second indication information may include an ID or an index of the scaling factor in the candidate scaling factor set. The ID of the scaling factor in the candidate scaling factor set may be agreed on in a protocol. For example, in the candidate scaling factor set [1, 2, 4, 8], it may be agreed on in the protocol that an ID corresponding to the scaling factor 1 is an ID 1, an ID corresponding to the scaling factor 2 is an ID 2, and so on. In this way, a value of a scaling factor corresponding to an ID in the candidate scaling factor set may be determined based on the ID. Alternatively, an index corresponding to each scaling factor in the candidate scaling factor set may be agreed on in a protocol. For example, in the candidate scaling factor set [1, 2, 4, 8], an index corresponding to the scaling factor 1 is #1, and an index corresponding to the scaling factor 2 is #2. In this way, a scaling factor corresponding to an index in the candidate scaling factor set may be determined based on the index. It may be understood that, alternatively, a bit sequence may be agreed on in a protocol to indicate the scaling factor in the candidate scaling factor set. For example, in the candidate scaling factor set [1, 2, 4, 8], a bit sequence 00 may indicate 1, a bit sequence 01 may indicate 2, a bit sequence 10 may indicate 4, and a bit sequence 11 may indicate 8. Certainly, a bit sequence having more bits may indicate the scaling factor. For example, a bit sequence 000 indicates 1. This is not specifically limited in this embodiment of this application.

Alternatively, the second indication information may implicitly indicate the scaling factor in the candidate scaling factor set. For example, the second indication information may be indication overheads for the frequency domain resource allocation. It may be understood that, according to the related descriptions in step S501, when a size of a BWP is determined, a length of a bitmap (for example, bit overheads of an FDRA field) indicating an allocated RBG varies with the scaling factor. Therefore, the scaling factor may be determined from the candidate scaling factor set by using bit overheads of indication information for the frequency domain resource allocation in DCI.

For example, when the frequency domain resource allocation unit is an RBG, according to the related descriptions in the “resource allocation type 0” above, when the size of the BWP is 275 RBs, an RBG size is 16 RBs. Therefore, when the frequency domain resource allocation is indicated by the FDRA field in the DCI, the bit overheads of the FDRA field in the DCI are [275/16]=18 bits. Assuming that the bit overheads of the FDRA field in the DCI are 9 bits, that is, the bit overheads are reduced by half, it may be determined that an RBG size is twice the original RBG size, to be specific, the scaling factor is the element 2 in the candidate scaling factor set [1, 2, 4, 8].

In other words, the second apparatus may configure the candidate scaling factor set by using the first indication information, and indicate the specific scaling factor in the candidate scaling factor set by using the second indication information, to indicate the scaling factor, so that overheads of the second indication information can be reduced, to improve reliability of the second indication information.

### B. Type 2

In another possible implementation, the indication information indicates a value of the scaling factor. In other words, the indication information may not need to indicate a candidate scaling factor set, but directly indicate the specific value of the scaling factor. For example, the indication information may indicate that the scaling factor is 2, 4, 8, 0.5, 0.25, or 0.125. This is not specifically limited in this embodiment of this application.

For step S603:

It should be understood that, as described in step S602, the indication information has two types. The type 1 is that the indication information includes the first indication information and the second indication information, and the type 2 is that the indication information directly indicates the specific value of the scaling factor. The second apparatus may send the indication information to the first apparatus by using one or a combination of the higher layer signaling, MAC layer signaling, or physical layer signaling based on different types of the indication information. The following separately provides descriptions.

For the type 1:

In a possible implementation, the first indication information is carried in the RRC signaling, and the second indication information is carried in the DCI or a MAC CE. To be specific, the candidate scaling factor set may be configured by using the RRC signaling, to increase effective duration of the configured candidate scaling factor set; and the second indication information may be carried in the DCI or the MAC CE, so that the scaling factor can be dynamically indicated. Therefore, this is applicable to a service scenario in which the actual granularity of the frequency domain resource allocation is frequently changed in an RRC connection period.

The following separately describes the first indication information and the second indication information by using an indication manner 1 and an indication manner 2.

### A1. Indication Manner 1:

In the indication manner 1, the RRC signaling and the MAC CE may jointly indicate the scaling factor.

For example, when the candidate scaling factor set indicated by the first indication information is configured by using the RRC signaling, the second indication information carried in the MAC CE may indicate the specific scaling factor in the candidate scaling factor set. A newly added information element in the RRC signaling carries the first indication information. Alternatively, an existing information element in the RRC signaling may be reused, and a parameter carrying the first indication information is newly added to the existing information element. For example, for downlink frequency domain resource allocation, a parameter or field carrying the first indication information may be newly added to a PDSCH-Config information element.

Further, for the MAC CE, a MAC CE indicating the scaling factor may be defined in a protocol. The MAC CE may indicate a scaling factor corresponding to each of at least one BWP and/or a scaling factor corresponding to each of at least one cell. The cell may be a serving cell of the first apparatus or a neighboring cell of the first apparatus. This is not specifically limited in this embodiment of this application. The at least one BWP may include a plurality of BWPs configured by the network for the first apparatus in the “frequency domain resource” above and/or an initial BWP. This is not specifically limited in this embodiment of this application.

For example, Table 7 enumerates a format of the MAC CE. The MAC CE includes two octets, namely, octet1 and octet2. octet1 may include a serving cell ID and a BWP ID, and octet2 may include the second indication information. In Table 7, the second indication information may be an ID or an index of a scaling factor corresponding to the BWP ID.

It may be understood that an octet may include 8 bits, and the 8 bits may be arranged from an LSB to an MSB, or may be arranged from an MSB to an LSB. A part of bits may be reserved bits. It should be understood that the format of the MAC CE enumerated in Table 7 is merely an example, and another form may be used in a specific implementation. This is not specifically limited in this embodiment of this application.

TABLE 7

| Reserved | Serving cell ID | | | | BWP ID | octet1 |
|---|---|---|---|---|---|---|
| Reserved | Reserved | Reserved | Reserved | Reserved | Scaling factor | octet2 |

It may be understood that, after receiving the MAC CE that carries the second indication information, the first apparatus may perform corresponding processing, and determine to perform frequency domain resource allocation by using the scaling factor indicated by the second indication information. The MAC CE may have a processing delay. Therefore, a moment at which the scaling factor indicated in the MAC CE takes effect may not be a moment at which the first apparatus receives the MAC CE.

For example, the moment at which the scaling factor indicated in the MAC CE takes effect may be a sum of a first moment and a first time offset to. The first moment may be a moment at which the second apparatus receives acknowledgment (ACK) information for a TB including the MAC CE or a moment at which the second apparatus receives an ACK feedback for a TB including the MAC CE.

Further, the first time offset to may be agreed on in a protocol; the first time offset to may be negotiated between the first apparatus and the second apparatus in advance; or the first time offset to may be configured by the second apparatus for the first apparatus. For example, the first time offset to may be 1 ms, 2 ms, or 3 ms. This is not specifically limited in this embodiment of this application.

It may be understood that, starting from the moment at which the scaling factor indicated in the MAC CE takes effect, the first apparatus may adjust the preconfigured granularity of the frequency domain resource allocation based on the scaling factor indicated by the second indication information in the MAC CE.

It may be further understood that effective time, namely, effective duration, of the scaling factor indicated by the second indication information in the MAC CE may be predefined or indicated. For example, that the effective time is indicated may be: When the first apparatus receives second indication information in a new MAC CE, or the second apparatus indicates a new scaling factor by using other signaling (for example, RRC signaling or DCI), a scaling factor indicated by second indication information in a previously received MAC CE loses effect.

For example, that the effective time is predefined may be: The first apparatus may start a timer at the moment at which the scaling factor indicated in the MAC CE takes effect, and the scaling factor indicated by the second indication information in the MAC CE loses effect after the timer expires.

Further, during a period in which the MAC CE loses effect, if the second apparatus does not indicate a scaling factor by using second indication information, the first apparatus may use a default scaling factor agreed on in a protocol. The default scaling factor agreed on in the protocol may be equal to 1.

### A2. Indication Manner 2:

In the indication manner 2, the RRC signaling and the DCI may jointly indicate the scaling factor. The indication manner 2 is similar to the indication manner 1, and a difference lies in that the second indication information is carried in the DCI. The indication manner 2 may be classified into an indication manner 2a and an indication manner 2b based on different DCI. The following provides separate descriptions.

### Indication Manner 2a:

In a possible implementation, the DCI includes a field indicating the scaling factor. The field indicating the scaling factor may carry the second indication information. For example, information indicated by the field indicating the scaling factor may be the specific value of the scaling factor or an ID (for example, an index) of the indicated scaling factor in the candidate scaling factor set. This is not specifically limited in this embodiment of this application.

It may be understood that, it may be defined in a protocol that a name of the field that is in the DCI and that indicates the scaling factor is a scaling factor or another name, for example, an allocation factor, a quantification factor, or a resource allocation factor. This is not specifically limited in embodiments of this application.

It may be understood that, when the candidate scaling factor set is not configured at a higher layer, the first apparatus may use a default scaling factor agreed on in a protocol, and the DCI may not include the field indicating the scaling factor. The default scaling factor agreed on in the protocol may be equal to 1.

### Indication Manner 2b:

In a possible implementation, the second indication information is carried in 2^{nd}-stage DCI. It should be understood that when the scaling factor is indicated by the DCI, 2-stage DCI may be used for indication. The 2-stage DCI includes 1^{st}-stage DCI and the 2^{nd}-stage DCI, and the 1^{st}-stage DCI indicates a time-frequency resource position for receiving the 2^{nd}-stage DCI. In other words, the time-frequency resource position for the 2^{nd}-stage DCI may be determined by using the 1^{st}-stage DCI, to avoid blind detection performed by the first apparatus on the 2^{nd}-stage DCI. Further, the second indication information is carried in the 2^{nd}-stage DCI, so that a volume of data carried in the 2^{nd}-stage DCI can be reduced.

To be specific, the second indication information is carried in the 2^{nd}-stage DCI, so that blind detection complexity of obtaining the second indication information by the first apparatus can be reduced, to reduce power consumption.

Further, the 2^{nd}-stage DCI includes a field indicating the scaling factor. For details about the field that is in the 2^{nd}-stage DCI and that indicates the scaling factor, refer to the field that is in the foregoing DCI and that indicates the scaling factor, and the details are not described herein again.

Optionally, indication overheads for the frequency domain resource allocation in the 2^{nd}-stage DCI may be for determining the scaling factor from the candidate scaling factor set. For a specific implementation of determining the scaling factor by using the indication overheads for the frequency domain resource allocation, refer to the related descriptions of step S602. Details are not described herein again.

To be specific, indication information of the frequency domain resource allocation in the 2^{nd}-stage DCI may implicitly indicate the specific scaling factor in the candidate scaling factor set, so that both the scaling factor and an allocated frequency domain resource can be indicated, to reduce overheads of the DCI and improve reliability of the DCI.

### Type 2:

In a possible implementation, the indication information is carried in an RRC setup message, an RRC resume message, or an RRC reconfiguration message. To be specific, the scaling factor indicated by the indication information may remain effective in an RRC connection period, and the scaling factor does not need to be indicated during each time of scheduling. This is applicable to a service scenario in which the scaling factor does not need to be frequently changed in the RRC connection period but the actual granularity of the frequency domain resource allocation is changed by using RRC signaling due to movement, energy saving, a service requirement change, or the like.

For example, during initial access or location update of the first apparatus, the first apparatus may set up an RRC connection to the second apparatus, and the second apparatus may include the indication information in the RRC setup message or the RRC reconfiguration message, to indicate the scaling factor to the first apparatus. In other words, the scaling factor indicated by the RRC setup message may be used in the RRC connection period to perform frequency domain resource allocation. For another example, the first apparatus may enter an RRC inactive (RRC_INACTIVE) state from an RRC connected (RRC_CONNECTED) state due to a current service cause, an energy saving requirement, or the like. Therefore, when the first apparatus resumes an RRC connection, the second apparatus may include the indication information in the RRC resume message, to indicate the scaling factor to the first apparatus. For still another example, due to poor radio link quality, a handover, or the like, the first apparatus and the second apparatus may re-establish an RRC connection through an RRC reconfiguration procedure, and the second apparatus may include the indication information in the RRC reconfiguration message, to indicate the scaling factor to the first apparatus.

It should be understood that, in the foregoing period in which the RRC connection is not set up, for example, in an RRC reconfiguration period, a default scaling factor agreed on in a protocol may be used. The default scaling factor agreed on in the protocol may be equal to 1.

It should be further understood that the RRC signaling in the type 1 may be carried in the RRC setup message, the RRC resume message, or the RRC reconfiguration message.

It may be understood that, to ensure alignment of the scaling factor between the first apparatus and the second apparatus, when the first apparatus receives the indication information from the second apparatus, the first apparatus may feed back acknowledgment information to the second apparatus, to notify the second apparatus that the indication information has been received. In this way, the second apparatus may learn whether the first apparatus has received the indication information, and send the indication information to the first apparatus again when determining that the first apparatus does not receive the indication information, to ensure the alignment of the scaling factor between the second apparatus and the first apparatus.

In this embodiment of this application, the second apparatus may flexibly indicate the scaling factor of the frequency domain resource allocation unit to the first apparatus based on the service type, so that the first apparatus determines a size of the frequency domain resource allocation unit based on the scaling factor and a preconfigured size of the frequency domain resource allocation unit, to change the actual granularity of frequency domain resource allocation, and therefore improve flexibility of the frequency domain resource allocation. Further, the flexibility of the frequency domain resource allocation is improved, so that a waste of an allocated resource can be avoided, or the indication overheads for the frequency domain resource allocation can be reduced, to meet a further requirement of a service for reliability. Therefore, the further requirement of the service can be met according to the resource allocation method provided in this embodiment of this application.

The processor 401 in the communication apparatus 400 shown in FIG. 4 may instruct the communication apparatus 400 to perform the actions of the first apparatus in steps S601 to S605, or the processor 401 in the communication apparatus 400 shown in FIG. 4 may invoke the application program code stored in the memory 403 to instruct the communication apparatus 400 to perform the actions of the first apparatus in steps S601 to S605. The processor 401 in the communication apparatus 400 shown in FIG. 4 may instruct the communication apparatus 400 to perform the actions of the second apparatus in steps S601 to S605, or the processor 401 in the communication apparatus 400 shown in FIG. 4 may invoke the application program code stored in the memory 403 to instruct the communication apparatus 400 to perform the actions of the second apparatus in steps S601 to S605. This is not specifically limited in this embodiment of this application.

In the foregoing, the actual granularity of the frequency domain resource allocation is adjusted by scaling up or scaling down the preconfigured size (for example, the RBG size or the RB size) of the frequency domain resource allocation unit, to improve the flexibility of the frequency domain resource allocation. The following provides a new granularity of frequency domain resource allocation, to improve flexibility of the frequency domain resource allocation, and therefore reduce indication overheads for the frequency domain resource allocation or avoid a waste of an allocated resource, so that a further requirement of a service for reliability can be met.

FIG. 7 is a schematic flowchart of still another resource allocation method according to an embodiment of this application. As shown in FIG. 7, the resource allocation method includes the following steps.
S701: A second apparatus generates indication information, where the indication information indicates that a size of a frequency domain resource allocation unit is a rounded value of a ratio of a size of a BWP to N, and Nis an integer greater than or equal to 1.
S702: The second apparatus sends the indication information to a first apparatus.

Correspondingly, the first apparatus receives the indication information from the second apparatus.
S703: The first apparatus determines the size of the frequency domain resource allocation unit based on the indication information.

It should be understood that, for details about the first apparatus and the second apparatus in steps S701 to S703, refer to the embodiments shown in FIG. 5 and FIG. 6, and the details are not described herein again.

The following specifically describes steps S701 to S703.

For step S701:

In a possible implementation, the BWP may be an initial BWP or an active BWP.

For example, when an RRC connection has not been set up between the second apparatus and the first apparatus, for example, during initial access, the BWP may be an initial BWP corresponding to a control resource set (CORSET) 0 or an initial BWP configured in remaining minimum system information (RMSI). For another example, in a period in which an RRC connection has been set up between the second apparatus and the first apparatus, the BWP may be an active BWP.

It may be understood that, in this embodiment of this application, the rounded value of the ratio of the size of the BWP to N may be a ceiling value or a floor value. For example, when the size of the BWP is 275 RBs, and N is 2, the rounded value of the ratio of the size of the BWP to N may be [275/2]=138 or [275/2]=137. In this way, a frequency domain resource may be divided into two segments, where a granularity of one segment is 137 RBs, and a granularity of the other segment is 138 RBs. In other words, in this embodiment of this application, the BWP may be divided into N segments, and a granularity of frequency domain resource allocation is approximately 1/N of the size of the BWP. If a value of Nis large, the granularity of the frequency domain resource allocation is small, and is applicable to a small data service in the “problem 1” above, to avoid a waste of an allocated resource. If a value of N is small, the granularity of frequency domain resource allocation is large, and is applicable to the application scenario with a small quantity of served terminal devices in the “problem 1” above, to reduce indication overheads for the frequency domain resource allocation, and further improve reliability.

For example, the size of the BWP is 275 RBs, a granularity of frequency domain resource allocation corresponding to a resource allocation type 0 is an RBG, and an RBG size is 16 RBs. When the value of N is 1, a rounded value of a ratio of the size of the BWP to 1 is 275 RBs. When a maximum value of N is 16, a floor value of the ratio of the size of the BWP to Nis 17 RBs. In other words, the granularity of the frequency domain resource allocation is greater than the RBG size and an RB size, so that the indication overheads for the frequency domain resource allocation can be reduced, to improve the reliability.

It may be understood that, as the value of N increases, the rounded value of the ratio of the size of the BWP to N is less than the RBG size, in other words, the granularity of the frequency domain resource allocation is less than the RBG size, to avoid a waste of an allocated frequency domain resource.

It should be understood that there may be three implementations in which the indication information indicates that the size of the frequency domain resource allocation unit is the ratio of the size of the BWP to N: an implementation 1, an implementation 2, and an implementation 3. The following separately provides descriptions.

### Implementation 1:

In a possible implementation, that the indication information indicates that the size of the frequency domain resource allocation unit is the rounded value of the ratio of the size of the BWP to N includes: The indication information indicates that a frequency domain resource allocation type is a first resource allocation type, and a size that is of the frequency domain resource allocation unit and that corresponds to the first resource allocation type is the rounded value of the ratio of the size of the BWP to N.

To be specific, a new resource allocation type may be agreed on in a protocol on a basis of the resource allocation type 0 and a resource allocation type 1, and a granularity that is of the frequency domain resource allocation and that corresponds to the new resource allocation type is the rounded value of the ratio of the size of the BWP to N.

It should be understood that a frequency domain resource allocation unit (namely, a granularity of frequency domain resource allocation) corresponding to the first resource allocation type may be referred to as a fraction-bandwidth part (fraction-BWP, F-BWP). For ease of description, in the following, the F-BWP represents the frequency domain resource allocation unit corresponding to the first resource allocation type. A unified description is provided herein. Certainly, the F-BWP is merely an example of a name. The frequency domain resource allocation unit corresponding to the first resource allocation type may alternatively have another name. This is not specifically limited in embodiments of this application.

Further, in embodiments of this application, the first resource allocation type may also be referred to as a resource allocation type 2. Certainly, the resource allocation type 2 is merely an example, and the first resource allocation type may alternatively have another name, for example, a resource allocation type 3. This is not specifically limited in embodiments of this application.

For example, it may be agreed on in a protocol that uplink frequency domain resource allocation and the downlink frequency domain resource allocation support the following three resource allocation types:
1. resource allocation type 0: frequency domain resource allocation is performed based on the RBG in the resource allocation type;
2. resource allocation type 1: frequency domain resource allocation is performed based on the RB in the resource allocation type; and
3. first resource allocation type: frequency domain resource allocation is performed based on the F-BWP in the resource allocation type.

Further, a manner of configuring or indicating the first resource allocation type may be the manner of configuring or indicating the resource allocation type 0 or the resource allocation type 1 above. For example, a plurality of F-BWP sizes, namely, rounded values that are of ratios of the size of the BWP to N and that correspond to a plurality of values of N, may be agreed on in a protocol.

For example, N is equal to 2 or 4. It may be agreed on in a protocol that F-BWP configurations include a configuration 1 and a configuration 2. As enumerated in Table 8, it may be agreed on in a protocol that an F-BWP size corresponding to the F-BWP configuration 1 is ceil (BWP/2), namely, a ceiling value of a ratio of the size of the BWP to 2, and an F-BWP size corresponding to the F-BWP configuration 2 is ceil (BWP/4), namely, a ceiling value of a ratio of the size of the BWP to 4.

TABLE 8

| Size of the BWP | Configuration 1 | Configuration 2 |
|---|---|---|
| (quantity of RBs) | (quantity of RBs) | (quantity of RBs) |
| 1 to 275 | ceil(BWP/2) | ceil(BWP/4) |

It should be understood that the F-BWP configurations enumerated in Table 8 are merely examples. F-BWP configurations corresponding to more values of N may be further agreed on in the protocol. For example, the value of N may be equal to 1, 3, 5, 6, 16, or 32. Further, an F-BWP size corresponding to the value of N being 3 is ceil (BWP/3) or floor (BWP/3), an F-BWP size corresponding to the value of N being 5 is ceil (BWP/5) or floor (BWP/5), and so on. This is not specifically limited in this embodiment of this application.

Further, in Table 8, regardless of a range within which the size of the BWP falls, each configuration corresponds to one F-BWP size. In a specific implementation, different size ranges of the BWP may correspond to different F-BWP sizes, for example, a configuration 1 and a configuration 2 enumerated in Table 9.

TABLE 9

| Size of the BWP | Configuration 1 | Configuration 2 |
|---|---|---|
| (quantity of RBs) | (quantity of RBs) | (quantity of RBs) |
| 1 to 36 | ceil(BWP/1) | ceil(BWP/2) |
| 37 to 72 | ceil(BWP/2) | ceil(BWP/4) |
| 73 to 144 | ceil(BWP/4) | ceil(BWP/8) |
| 145 to 275 | ceil(BWP/8) | ceil(BWP/8) |

It may be understood that, for the configuration that is of the first resource allocation type and that is enumerated in Table 9, the F-BWP size may be determined based on Table 9, the size of the BWP, and a configuration (for example, the configuration 1 or the configuration 2) indicated by a higher layer.

Different configurations (for example, the configuration 1 and the configuration 2) of the first resource allocation type may be indicated based on higher layer signaling. Information indicating the configuration of the first resource allocation type may be, for example, a newly added information element in the higher layer signaling or an existing information element that is reused. For example, a data channel configuration information element (for example, a PDSCH-Config information element) in the higher layer signaling may include a parameter indicating the configuration of the first resource allocation type.

Optionally, the indication information may further indicate the configuration corresponding to the first resource allocation type. To be specific, the indication information may indicate that the frequency domain resource allocation type is the first resource allocation type and indicate the configuration 1 or the configuration 2 in the first resource allocation type, to determine the rounded value of the ratio of the size of the BWP to N.

In the foregoing, the size of the frequency domain resource allocation unit is indicated as the rounded value of the ratio of the size of the BWP to N by introducing a new resource allocation type. The following describes the implementation 2 and the implementation 3. In the implementation 2 and the implementation 3, when no new resource allocation type is introduced, the size of the frequency domain resource allocation unit may be indicated as the rounded value of the ratio of the size of the BWP to N based on a condition that the frequency domain resource allocation unit is the RBG.

### Implementation 2:

In a possible implementation, the frequency domain resource allocation unit is the RBG; and that the indication information indicates that the size of the frequency domain resource allocation unit is the rounded value of the ratio of the size of the BWP to N includes: The indication information indicates that a configuration of the RBG is a first configuration, and an RBG size corresponding to the first configuration is the rounded value of the ratio of the size of the BWP to N.

In other words, a new RBG configuration may be agreed on in a protocol on a basis of the resource allocation type 0, and an RBG size corresponding to the new RBG configuration is the rounded value of the ratio of the size of the BWP to N.

It may be understood that a newly added RBG configuration, namely, the first configuration, may be agreed on in a protocol on a basis of an RBG configuration 1 and an RBG configuration 2. For example, as enumerated in Table 10, N=2, and the RBG size corresponding to the first configuration is a ceiling value of the ratio of the size of the BWP to 2.

TABLE 10

| Size of the | RBG | RBG | First |
|---|---|---|---|
| BWP (quantity | configuration 1 | configuration 2 | configuration |
| of RBs) | (quantity of RBs) | (quantity of RBs) | (quantity of RBs) |
| 1 to 36 | 2 | 4 | ceil(BWP/2) |
| 37 to 72 | 4 | 8 | ceil(BWP/2) |
| 73 to 144 | 8 | 16 | ceil(BWP/2) |
| 145 to 275 | 16 | 16 | ceil(BWP/2) |

It should be understood that Table 10 is merely an example, and N may alternatively be another value, for example, 1, 3, 4, or 5. In addition, different size ranges of the BWP in Table 10 may correspond to different values of N. For example, when the size of the BWP is 1 to 36 RBs, the range corresponds to ceil (BWP/2); or when the size of the BWP is 37 to 72 RBs, the range corresponds to ceil (BWP/4). This is not specifically limited.

It should be further understood that the first configuration may also be referred to as an RBG configuration 3. Certainly, the RBG configuration 3 is merely an example, and the first configuration may alternatively have another name. This is not specifically limited in embodiments of this application.

### Implementation 3:

In a possible implementation, the frequency domain resource allocation unit is the RBG; and that the indication information indicates that the size of the frequency domain resource allocation unit is the rounded value of the ratio of the size of the BWP to N includes: The indication information indicates that a type of the RBG is a first type, and an RBG size corresponding to the first type is the rounded value of the ratio of the size of the BWP to N.

In other words, a new RBG type may be agreed on in a protocol on a basis of the resource allocation type 0, and an RBG size corresponding to the new RBG type is the rounded value of the ratio of the size of the BWP to N.

It may be understood that it may be agreed on in a protocol that RBGs in the resource allocation type 0 include two RBG types: a type corresponding to an original RBG and the new RBG type, namely, the first type. For example, the type corresponding to the original RBG may be referred to as an RBG type 1, and the first type may be referred to as an RBG type 2. For an RBG size corresponding to the RBG type 1, refer to Table 4. The RBG type 2 may include at least one RBG configuration, and different RBG configurations may correspond to different values of N. For example, table 11 enumerates that in the RBG type 2, an RBG size corresponding to an RBG configuration 1 is ceil (BWP/2), and an RBG size corresponding to an RBG configuration 2 is ceil (BWP/4).

TABLE 11

| Size of the BWP | RBG configuration 1 | RBG configuration 2 |
|---|---|---|
| (quantity of RBs) | (quantity of RBs) | (quantity of RBs) |
| 1 to 275 | ceil(BWP/2) | ceil(BWP/4) |

It should be understood that Table 11 is merely an example, and N may alternatively be another value, for example, 1, 3, 4, or 5. In addition, different size ranges of the BWP in Table 11 may correspond to different values of N. For example, when the size of the BWP is 1 to 36 RBs, the range corresponds to ceil (BWP/2); or when the size of the BWP is 37 to 72 RBs, the range corresponds to ceil (BWP/4). This is not specifically limited.

Further, the RBG type 2 may alternatively include one RBG configuration, or may include three, four, or more configurations. This is not specifically limited in this embodiment of this application.

It should be further understood that the RBG type 1 and the RBG type 2 are examples of names, and the type corresponding to the original RBG and the first type may have other names. For example, the original RBG may alternatively be referred to as an RBG definition type 1 or an RBG type 0, and the first type may alternatively be referred to as an RBG definition type 1 or an RBG type 1. This is not specifically limited in embodiments of this application.

In a possible implementation, a size of a 1^{st} RBG within the BWP is the same as a size of an RBG other than a last RBG and the 1^{st} RBG within the BWP. To be specific, when the RBG size is the rounded value of the ratio of the size of the BWP to N, determining of the size of the 1^{st} RBG within the BWP is irrelevant to a frequency domain start position of the BWP, and the size of the 1^{st} RBG may be the same as a size of a middle RBG.

For step S702:

It may be understood that, in step S701, the implementations 1 to 3 respectively correspond to different protocol-predefined cases. A manner of sending the indication information in step S702 varies with a protocol-predefined case. The following separately provides descriptions.

### Implementation 1:

In the implementation 1, the first resource allocation type may be predefined in a protocol.

In a possible implementation, the indication information is carried in RRC signaling. In other words, a resource allocation type may be indicated as a first frequency domain resource allocation type by using the RRC signaling.

It may be understood that, according to the related descriptions in the “frequency domain resource allocation” above, higher layer signaling may indicate that resource allocation is one of the foregoing three resource allocation types. For example, using a PDSCH-Config information element in the RRC signaling as an example, four types, including the resource allocation type 0, the resource allocation type 1, the first resource allocation type, and dynamic switching, may be configured in a resourceAllocation field. Further, the indication information may include a resourceAllocation field, and the resourceAllocation field indicates the first resource allocation type.

In another possible implementation, the indication information is carried in DCI. To be specific, the second apparatus may dynamically indicate, in an indication message of each time of scheduling, that the resource allocation type is the first resource allocation type.

It may be understood that when the resourceAllocation field indicates the dynamic switching, the indication information may be carried in the DCI, to indicate that the resource allocation type is the first resource allocation type. For example, an FDRA field in the DCI may indicate that the resource allocation type is the first resource allocation type.

It may be further understood that when it is predefined in a protocol that the first resource allocation type corresponds to a plurality of configurations, the higher layer signaling may indicate one of the plurality of configurations.

### Implementation 2:

In the implementation 2, the first configuration is predefined in a protocol.

In a possible implementation, the indication information is carried in RRC signaling. In other words, the RBG configuration may be indicated as the first configuration by using the RRC signaling.

For example, for the downlink frequency domain resource allocation, the indication information may be an rbg-Size parameter in a PDSCH-Config information element in the RRC signaling, and the rbg-Size parameter indicates that the RBG configuration is the first configuration.

### Implementation 3:

In the implementation 3, the first type is predefined in a protocol.

In a possible implementation, the indication information is carried in RRC signaling. In other words, the type of the RBG may be indicated as the first type by using the RRC signaling.

Further, when it is predefined in a protocol that the first type corresponds to a plurality of configurations, higher layer signaling indicates that the type of the RBG is the first type and indicates one of the plurality of configurations corresponding to the first type.

For step S703:

It may be understood that for a specific implementation in which the first apparatus may determine, based on the indication information, that the size of the frequency domain resource allocation unit is the rounded value of the ratio of the size of the BWP to N, refer to the related descriptions in steps S701 and S702. Details are not described herein again.

It should be understood that the first configuration and the first type predefined in the protocol are configurations newly added on the basis of the resource allocation type 0, and therefore, an indication manner of the frequency domain resource allocation corresponding to the resource allocation type 0 may be used. For the first resource allocation type predefined in the protocol, indication manners A to C are separately described below in detail.

### Indication Manner A:

In a possible implementation, the resource allocation method shown in FIG. 7 further includes the following step:

S704: The second apparatus sends resource allocation indication information. Correspondingly, the first apparatus receives the resource allocation indication information from the second apparatus. The resource allocation indication information includes first resource allocation indication information and second resource allocation indication information. The first resource allocation indication information indicates a candidate time-frequency resource set, and the second resource allocation indication information is for determining an allocated time-frequency resource from the candidate time-frequency resource set. A frequency domain resource in the candidate time-frequency resource set is a frequency domain resource determined based on the size of the frequency domain resource allocation unit.

In other words, during resource allocation indication, the candidate time-frequency resource set may be configured by using the first resource allocation indication information, and a specific time-frequency resource in the candidate time-frequency resource set may be indicated by the second resource allocation indication information, so that both a frequency domain resource and a time domain resource can be indicated by one field, to reduce indication overheads for resource allocation and improve reliability.

For example, the candidate time-frequency resource set may include a plurality of time-frequency resources (or referred to as a plurality of groups of time-frequency resources), and each of the plurality of time-frequency resources may include a timing parameter, a time domain mapping type, an indication parameter for time domain resource allocation, and an indication parameter for frequency domain resource allocation. The timing parameter may be a slot offset k0 (for a downlink direction) or k2 (for an uplink direction) in the “time domain resource allocation” above, the time domain mapping type may be a mapping type A or a mapping type B, and the indication parameter for the time domain resource allocation may be an SLIV.

Further, the indication parameter for the frequency domain resource allocation may indicate at least one of the N segments of frequency domain resources within the BWP. It may be understood that because the size of the frequency domain resource allocation unit is the rounded value of the ratio of the size of the BWP to N, the BWP may be divided into the N segments, so that during the frequency domain resource allocation, only a specific segment or specific segments in the N segments need to be indicated as an allocated frequency domain resource. In other words, there are 20-1 selections in a possible selection set corresponding to the allocated frequency domain resource, and the indication overheads for the frequency domain resource allocation are N bits.

For example, when N is equal to 2, the BWP may be divided into a frequency domain resource #1 and a frequency domain resource #2. A frequency domain position corresponding to the frequency domain resource #1 is higher than a frequency domain position corresponding to the frequency domain resource #2, in other words, a center frequency or a start frequency of the frequency domain resource #1 is greater than a center frequency or a start frequency of the frequency domain resource #2. Therefore, the possible selection set of the allocated frequency domain resource is as follows: the frequency domain resource #1, the frequency domain resource #2, and the frequency domain resource #1 and the frequency domain resource #2. In this way, during the frequency domain resource allocation, the allocated frequency domain resource may be indicated by 2 bits. For example, a bit sequence 01 indicates a 1^{st} resource (namely, the frequency domain resource #1), a bit sequence 10 indicates a 2^{nd} resource (namely, the frequency domain resource #1), and a bit sequence 11 indicates both the resources (namely, the frequency domain resource #1 and the frequency domain resource #2).

Similarly, when N is equal to 4, there are 15 possible selections of the allocated frequency domain resource, and the allocated frequency domain resource may be indicated by 4 bits.

In a possible implementation, the first resource allocation indication information is carried in RRC signaling, and the second resource allocation indication information is carried in DCI.

In other words, the candidate time-frequency resource set may be configured by using the RRC signaling, to be specific, the first resource allocation indication information is sent once to make the candidate time-frequency resource set effective in an RRC connection period. In this way, during each time of resource allocation, the second resource allocation indication information may be sent by using the DCI to complete time-frequency resource allocation, to reduce the indication overheads for the resource allocation and improve the reliability.

For example, for resource allocation for a PDSCH, a PDSCH configuration common (PDSCH-ConfigCommon) information element or a PDSCH-Config information element in higher layer signaling may include first resource allocation indication information. The first resource allocation indication information may be a time-frequency domain resource allocation list field. The candidate time-frequency resource set may be configured in a form of a list by using the time-frequency domain resource allocation list field, to be specific, each row in a time-frequency domain resource allocation list is one time-frequency resource in the candidate time-frequency resource set. Further, the second resource allocation indication information may indicate a row index in the foregoing list, so that the first apparatus can determine the allocated time domain resource and frequency domain resource by using the row index.

It should be understood that the second resource allocation indication information may be a TDRA field in the DCI. Alternatively, a field for the second resource allocation indication information, for example, a time-frequency domain resource allocation field, may be newly added to the DCI.

### Indication Manner B:

In a possible implementation, the resource allocation indication information is carried in DCI. The DCI includes a resource allocation indication field, for example, an FDRA field. Overheads of the field are related to N in the foregoing F-BWP. For details, refer to the indication manner A.

### Indication Manner C:

In a possible implementation, the resource allocation indication information is indicated by a PDCCH scrambling sequence. In other words, an allocated frequency domain resource may be used as a newly added parameter in an initialization formula for the PDCCH scrambling sequence. Therefore, when a higher layer indicates that the resource allocation type is the first resource allocation type, the first apparatus may obtain the resource allocation indication information by blindly detecting the PDCCH scrambling sequence. It may be understood that, for the initialization formula for the PDCCH scrambling sequence, refer to descriptions in a related 3GPP TS, for example, TS 38.211. Details are not described herein.

In this embodiment of this application, the second apparatus may indicate, to the first apparatus based on a service type, that the size of the frequency domain resource allocation unit is the rounded value of the ratio of the size of the BWP to N. Therefore, the first apparatus can determine, based on the indication information, that the size of the frequency domain resource allocation unit is the rounded value of the ratio of the size of the BWP to N, to improve flexibility of the frequency domain resource allocation. Further, the flexibility of the frequency domain resource allocation is improved, so that the waste of the allocated resource can be avoided, or the indication overheads for the frequency domain resource allocation can be reduced, to meet a further requirement of a service for reliability.

The processor 401 in the communication apparatus 400 shown in FIG. 4 may instruct the communication apparatus 400 to perform the actions of the first apparatus in steps S701 to S704, or the processor 401 in the communication apparatus 400 shown in FIG. 4 may invoke the application program code stored in the memory 403 to instruct the communication apparatus 400 to perform the actions of the first apparatus in steps S701 to S704. The processor 401 in the communication apparatus 400 shown in FIG. 4 may instruct the communication apparatus 400 to perform the actions of the second apparatus in steps S701 to S704, or the processor 401 in the communication apparatus 400 shown in FIG. 4 may invoke the application program code stored in the memory 403 to instruct the communication apparatus 400 to perform the actions of the second apparatus in steps S701 to S704. This is not specifically limited in this embodiment of this application.

It may be understood that, the frequency domain resource allocation can be enhanced in the foregoing method embodiments, to meet the requirement of the service for the reliability. The following describes an embodiment of enhancement of time domain resource allocation, to meet a further requirement of the service for a data transmission rate.

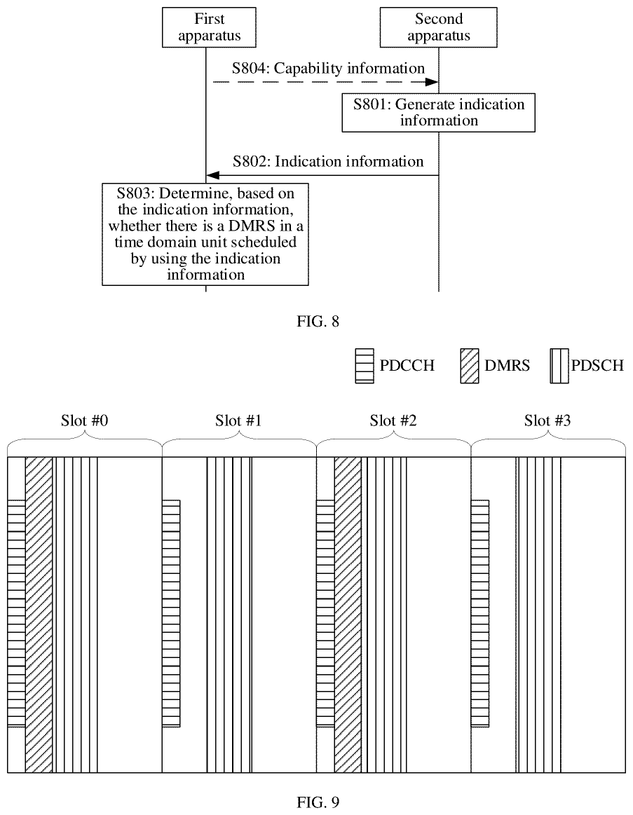

FIG. 8 is a schematic flowchart of an information sending and receiving method according to an embodiment of this application. As shown in FIG. 8, the information sending and receiving method includes the following steps:
S801: A second apparatus generates indication information, where the indication information indicates whether there is a DMRS in a time domain unit scheduled by using the indication information.
S802: The second apparatus sends the indication information to a first apparatus.

Correspondingly, the first apparatus receives the indication information from the second apparatus.
S803: The first apparatus determines, based on the indication information, whether there is a DMRS in the time domain unit scheduled by using the indication information.

The first apparatus may be the terminal device in FIG. 3 and FIG. 4 or a module or unit of the terminal device. For example, the first apparatus may be a chip, a chip system, a chip circuit, or a circuit of the terminal device. In addition, the first apparatus may alternatively be the first apparatus in FIG. 5 to FIG. 7.

The second apparatus may be the network device in FIG. 3 and FIG. 4 or a module or unit of the network device. For example, the second apparatus may be a chip, a chip system, a chip circuit, or a circuit of the network device. In addition, the second apparatus may alternatively be the second apparatus in FIG. 5 to FIG. 7.

The following specifically describes steps S801 to S803.

For S801:

It should be understood that, as described in the “frequency domain resource allocation” above, DCI may be for scheduling one slot, or may be for scheduling a plurality of slots. The following provides descriptions by using a scenario 1 and a scenario 2 based on a status of the time domain unit scheduled by using the indication information.

### Scenario 1:

In a possible implementation, the indication information may be carried in DCI, or the indication information may be a field in DCI. One time domain unit is scheduled by using the DCI. The time domain unit may be a slot. It may be understood that, as evolution occurs, the time domain unit may alternatively be a time unit, for example, a non-slot, with a granularity smaller than the slot; or the time domain unit may be a time unit, for example, a subframe, with a granularity greater than the slot. This is not specifically limited in embodiments of this application. Further, the DCI includes a field indicating whether there is a DMRS (DMRS on/off), in other words, the field indicates whether there is a DMRS in the scheduled time domain unit.

That is, there may be or may not be a DMRS in the scheduled slot or non-slot, so that flexibility of a DMRS design can be improved. Further, the flexibility of the DMRS design is improved, so that DMRS redundancy can be avoided, and time domain resource utilization during data transmission is improved, to meet a further requirement of a service for a data transmission rate.

For example, as described in the “problem 2” above, in a high-frequency indoor scenario or a night scenario, a moving speed of the first apparatus is usually low, and channel estimation does not need to be performed by using a DMRS in each slot. In other words, DMRS redundancy occurs in the foregoing scenario in which a channel changes slowly with time. In this case, the second apparatus may indicate, by using the indication information, that no DMRS exists in the scheduled time domain unit. In this way, no DMRS may be sent during uplink and downlink data transmission, and more time domain resources may be occupied during the data transmission, to improve time domain resource utilization for the data transmission, and increase the data transmission rate.

It may be understood that, in a scenario in which the first apparatus moves at a high speed, the second apparatus may indicate, by using the indication information, that there is a DMRS in the scheduled time domain unit, so that the first apparatus or the second apparatus performs channel estimation by using a DMRS in each time domain unit, to reduce a bit error rate of data transmission.

It should be understood that the second apparatus may generate the indication information based on estimation of the moving speed of the first apparatus, a service data volume of the first apparatus, or the like.

For example, as shown in FIG. 9, in the scenario 1, the indication information may indicate whether there is a DMRS in each of slots #0 to #3 that are separately scheduled. There is a DMRS in the slot #0 and the slot #2, and there is no DMRS in the slot #1 and the slot #3.

In a possible implementation, the DMRS includes a front-loaded DMRS and/or an additional DMRS. In other words, the indication information may indicate whether there is a front-loaded DMRS and/or an additional DMRS in the scheduled time domain unit, to further improve the flexibility of the DMRS design.

It may be understood that, for details about the front-loaded DMRS and the additional DMRS, refer to the related descriptions in the “DMRS” above, and the details are not described herein again.

### Scenario 2:

It should be understood that in the scenario 2, a plurality of time domain units are scheduled by using the DCI.

In a possible implementation, that the indication information indicates whether there is a DMRS in the time domain unit scheduled by using the indication information includes: The indication information indicates that there is a DMRS every K time domain units in Y time domain units scheduled by using the indication information, where K is an integer greater than 1, and Y is an integer greater than K.

In other words, when the indication information is for scheduling a plurality of time domain units, the indication information may indicate that the DMRS is distributed in a comb pattern in the plurality of slots, that is, there is no DMRS in a part of slots. In this way, the flexibility of the DMRS design can be further improved.

It may be understood that, that there is a DMRS every K time domain units may mean: There is a DMRS in an i^{th} time domain unit in the K time domain units, where 1≤i≤K. i may be agreed on in a protocol, may be negotiated between the first apparatus and the second apparatus in advance, or may be indicated by the second apparatus. This is not specifically limited in this embodiment of this application. It should be understood that, that there is a DMRS every K time domain units in the Y time domain units may be replaced with: There is a DMRS at an interval of j time domain units in the Y time domain units, where 1≤j<Y. In other words, K may be equal to j+1. It may be understood that K may also represent a comb parameter.

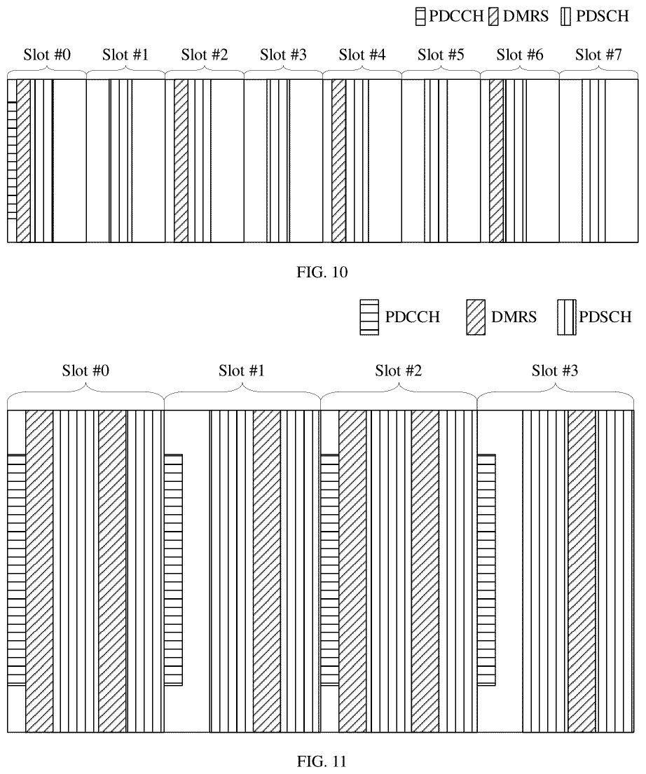

For example, K may be 2, and Y may be 8. As shown in FIG. 10, in eight slots scheduled by using the indication information, there is a DMRS every two slots. In the two slots, there may be a DMRS in a 2^{nd} slot. Further, the DMRS may be a front-loaded DMRS or an additional DMRS. For example, as shown in FIG. 11, in four slots scheduled by using the indication information, it may be indicated that there is no front-loaded DMRS in a 2^{nd} slot of every two slots.

In a possible implementation, the indication information includes first indication information and second indication information, the first indication information indicates a candidate scheduling configuration set, and the second indication information is for determining Y and K from the candidate scheduling configuration set.

The candidate scheduling configuration set may include a plurality of scheduling configurations. Each of the plurality of scheduling configurations may include Y scheduled time domain units and a value of K. The Y time domain units may be Y scheduled slots, and the value of K may indicate spaced distribution of the DMRS in time domain. For example, using an example in which there is a DMRS in an i^{th} time domain unit in the K time domain units, the candidate scheduling configuration set may include a configuration #1 to a configuration #4. Details are as follows:
Configuration #1: It is configured that the DCI is for scheduling Y=2 consecutive slots, and K=1, to be specific, there is a DMRS in each of the two slots.
Configuration #2: It is configured that the DCI is for scheduling Y=2 consecutive slots, and K=2, to be specific, there is a DMRS in a 1^{st} slot in the two slots.
Configuration #3: It is configured that the DCI is for scheduling Y=4 consecutive slots, and K=1, to be specific, there is a DMRS in each of the four slots.
Configuration #4: It is configured that the DCI is for scheduling Y=4 consecutive slots, and K=2, to be specific, there is a DMRS in a 1^{st} slot in every two slots. Further, the second indication information may be an index of the configuration #1 to the configuration #4, so that Y and K can be determined.

In other words, the candidate scheduling configuration set may be first configured by using the first indication information, and then the second indication information indicates that there is a DMRS every K time domain units in the Y scheduled time domain units. In this way, indication overheads can be reduced.

Further, in a possible implementation, the first indication information is carried in RRC signaling, and the second indication information is carried in DCI.

In other words, the candidate scheduling configuration set may be configured by using the RRC signaling, to be specific, the first indication information is sent once to make the candidate scheduling configuration set effective in an RRC connection period. In this way, during each time of scheduling, the DCI may indicate that there is a DMRS every K time domain units in the Y time domain units, to reduce indication overheads and improve reliability.

In a possible implementation, the indication information further indicates that there is a DMRS every M frequency domain units in S frequency domain units scheduled by using the indication information, where M is an integer greater than 1, and S is an integer greater than M. The frequency domain unit may be the frequency domain resource allocation unit in the embodiments shown in FIG. 5 to FIG. 7, for example, an RBG, an RB, or an F-BWP.

It may be understood that, that there is a DMRS every M frequency domain units may mean: There is a DMRS in an r^{th} frequency domain unit in the M frequency domain units, where 1≤r≤M. r may be agreed on in a protocol, may be negotiated between the first apparatus and the second apparatus in advance, or may be indicated by the second apparatus. This is not specifically limited in this embodiment of this application. It should be understood that, that there is a DMRS every M frequency domain units in the S frequency domain units may be replaced with: There is a DMRS at an interval of t frequency domain units in the S frequency domain units, where 1≤t<S. In other words, M may be equal to t+1. In other words, the indication information may indicate comb-pattern distribution of the DMRS in a plurality of RBs, that is, there is no DMRS in a part of RBs. In this way, the flexibility of the DMRS design can be further improved, and frequency domain resource utilization during the data transmission can be improved.

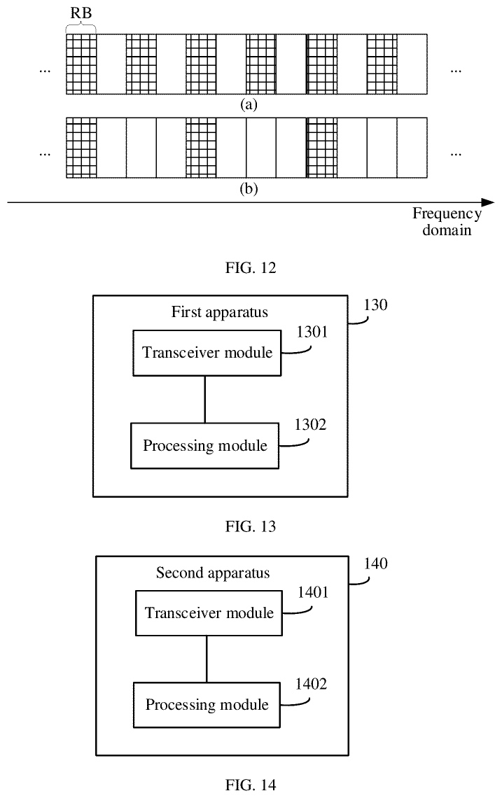

For example, as shown in (a) in FIG. 12, the S scheduled frequency domain units may be 12 RBs. M=2, that is, there is a DMRS every two RBs in the 12 RBs.

For another example, as shown in (b) in FIG. 12, the S scheduled units may be 12 RBs. M=4, that is, there is a DMRS every four RBs in the 12 RBs.

For step S802:

It may be understood that the indication information may be sent by using RRC signaling or may be jointly sent by using RRC signaling and DCI. For details, refer to the related descriptions in step S801, and the details are not described herein again.

For step S803:

It may be understood that the first apparatus may determine a DMRS status in the scheduled time domain unit based on the indication information. For details, refer to the related descriptions in step S801, and the details are not described herein again.

In a possible implementation, the method shown in FIG. 8 further includes the following step:

S804: The first apparatus sends capability information to the second apparatus. Correspondingly, the second apparatus receives the capability information from the first apparatus. The capability information includes at least one of the following: information indicating whether receiving of downlink scheduling without a DMRS (downlink scheduling without a DMRS) is supported, information indicating a quantity of time domain units of the downlink scheduling without a DMRS, information indicating whether storage of a channel estimation result is supported, or information indicating duration for storing the channel estimation result. The channel estimation result is a channel estimation result determined based on the DMRS.

It may be understood that the downlink scheduling without a DMRS may also be referred to as downlink transmission without a DMRS. The downlink scheduling without a DMRS may mean that there is no DMRS in a time domain unit (for example, a slot) of the downlink scheduling, and the DMRS may be a front-loaded DMRS and/or an additional DMRS. For details, refer to the related descriptions in step S801, and the details are not described again.

Further, the quantity of time domain units of the downlink scheduling without a DMRS may be a quantity of consecutive time domain units that are in time domain units of the downlink scheduling and in which there is no DMRS.

It may be further understood that the storing the channel estimation result may alternatively be caching the channel estimation result, in other words, temporarily storing the channel estimation result. For example, after cache space reaches an upper limit, a first cached channel estimation result may be deleted. Alternatively, after storage duration of a channel estimation result reaches an upper limit, the channel estimation result may be deleted.

Further, the capability information may include whether channel estimation reuse across time domain units is supported. It may be understood that the channel estimation reuse across time domain units may mean: A channel estimation result corresponding to a DMRS in one of a plurality of time domain units may be reused in the plurality of time domain units.

It may be understood that when configuring the indication information, the second apparatus may configure the indication information based on a capability of the first apparatus, for example, whether the first apparatus supports the downlink transmission without a DMRS. Further, because the DMRS may not be sent in a part of slots, it means that the first apparatus needs to cache a channel estimation result determined based on a previous DMRS, to demodulate data. In other words, the second apparatus may configure a DMRS distribution status in time domain and/or frequency domain based on the capability information reported by the first apparatus, and indicate the DMRS distribution status to the first apparatus, so that a DMRS design matches the capability of the first apparatus, and the first apparatus can normally demodulate the data.

In this embodiment of this application, the first apparatus may receive the indication information, and determine, based on the indication information, whether there is a DMRS in the time domain unit scheduled by using the indication information. In other words, there may be or may not be a DMRS in the scheduled time domain unit. This can improve the flexibility of the DMRS design. Further, the flexibility of the DMRS design is improved, so that DMRS redundancy can be avoided, and the time domain resource utilization during the data transmission is improved, to meet the further requirement of the service for the data transmission rate. Therefore, the further requirement of the service can be met according to the information sending and receiving method provided in this embodiment of this application.

The processor 401 in the communication apparatus 400 shown in FIG. 4 may instruct the communication apparatus 400 to perform the actions of the first apparatus in steps S801 to S804, or the processor 401 in the communication apparatus 400 shown in FIG. 4 may invoke the application program code stored in the memory 403 to instruct the communication apparatus 400 to perform the actions of the first apparatus in steps S801 to S804. The processor 401 in the communication apparatus 400 shown in FIG. 4 may instruct the communication apparatus 400 to perform the actions of the second apparatus in steps S801 to S804, or the processor 401 in the communication apparatus 400 shown in FIG. 4 may invoke the application program code stored in the memory 403 to instruct the communication apparatus 400 to perform the actions of the second apparatus in steps S801 to S804. This is not specifically limited in this embodiment of this application.

It should be understood that the procedure for the information sending and receiving method shown in FIG. 8 or any possible implementation thereof may be combined with the procedures for the resource allocation methods shown in FIG. 5 to FIG. 7 or any possible implementation thereof. For example, the first apparatus may perform step S802 before, after, or simultaneously when the first apparatus performs step S501. Further, step S502 and step S803 may be performed simultaneously or separately. This is not specifically limited in embodiments of this application.

The foregoing mainly describes the solutions provided in embodiments of this application from a perspective of interaction between network elements. Correspondingly, embodiments of this application further provide a communication apparatus, and the communication apparatus is configured to implement the foregoing methods. The communication apparatus may be the first apparatus in the foregoing method embodiments, an apparatus including the foregoing first apparatus, or a component that may be used in the first apparatus. Alternatively, the communication apparatus may be the second apparatus in the foregoing method embodiments, an apparatus including the foregoing second apparatus, or a component that may be used in the second apparatus. It may be understood that, to implement the foregoing functions, the communication apparatus includes a corresponding hardware structure and/or software module for performing each function. A person skilled in the art should easily be aware that, in combination with units and algorithm steps of the examples described in embodiments disclosed in this specification, this application can be implemented by hardware or a combination of hardware and computer software. Whether a function is performed by hardware or hardware driven by computer software depends on particular applications and design constraint conditions of the technical solutions. A person skilled in the art may use different methods to implement the described functions for each particular application, but it should not be considered that the implementation goes beyond the scope of this application.

In embodiments of this application, the communication apparatus may be divided into functional modules based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be understood that division into modules in embodiments of this application is an example, and is merely logical function division. During actual implementation, there may be another division manner.

For example, the communication apparatus is the first apparatus in the foregoing method embodiments. FIG. 13 is a diagram of a structure of a first apparatus 130. The first apparatus 130 includes a transceiver module 1301 and a processing module 1302. The transceiver module 1301 may also be referred to as a transceiver unit, is configured to implement receiving and sending functions, and for example, may be a transceiver circuit, a transceiver machine, a transceiver, or a communication interface.

The processing module 1302 is configured to implement a processing function corresponding to the first apparatus in the foregoing method embodiments, and the transceiver module 1301 is configured to implement receiving and sending functions corresponding to the first apparatus in the foregoing method embodiments. Therefore, all related content of the steps in the foregoing method embodiments may be referenced to function descriptions of corresponding functional modules. Details are not described herein again.

In this embodiment of this application, the first apparatus 130 is presented in a form of functional modules obtained through division in an integrated manner. The “module” herein may be a specific ASIC, a circuit, a processor that executes one or more software or firmware programs and a memory, an integrated logic circuit, and/or another component capable of providing the foregoing functions. In a simple embodiment, a person skilled in the art may figure out that the first apparatus 130 may be in a form of the communication apparatus 400 shown in FIG. 4.

For example, the processor 401 in the communication apparatus 400 shown in FIG. 4 may invoke the computer-executable instructions stored in the memory 403, to enable the communication apparatus 400 to perform the communication methods in the foregoing method embodiments.

Specifically, functions/implementation processes of the transceiver module 1301 and the processing module 1302 in FIG. 13 may be implemented by the processor 401 in the communication apparatus 400 shown in FIG. 4 by invoking the computer-executable instructions stored in the memory 403. Alternatively, a function/an implementation process of the processing module 1302 in FIG. 13 may be implemented by the processor 401 in the communication apparatus 400 shown in FIG. 4 by invoking the computer-executable instructions stored in the memory 403, and a function/an implementation process of the transceiver module 1301 in FIG. 13 may be implemented by the communication interface 404 in the communication apparatus 400 shown in FIG. 4.

Because the first apparatus 130 provided in this embodiment of this application may perform the foregoing methods, for technical effects that can be achieved by the first apparatus 130, refer to the foregoing method embodiments. Details are not described herein again.

Alternatively, for example, the communication apparatus is the second apparatus in the foregoing method embodiments. FIG. 14 is a diagram of a structure of a second apparatus 140. The second apparatus 140 includes a transceiver module 1401 and a processing module 1402. The transceiver module 1401 may also be referred to as a transceiver unit, is configured to implement receiving and sending functions, and for example, may be a transceiver circuit, a transceiver machine, a transceiver, or a communication interface.

The processing module 1402 is configured to implement a processing function corresponding to the second apparatus in the foregoing method embodiments, and the transceiver module 1401 is configured to implement receiving and sending functions corresponding to the second apparatus in the foregoing method embodiments. Therefore, all related content of the steps in the foregoing method embodiments may be referenced to function descriptions of corresponding functional modules. Details are not described herein again.

In this embodiment of this application, the second apparatus 140 is presented in a form of functional modules obtained through division in an integrated manner. The “module” herein may be a specific ASIC, a circuit, a processor that executes one or more software or firmware programs and a memory, an integrated logic circuit, and/or another component capable of providing the foregoing functions. In a simple embodiment, a person skilled in the art may figure out that the second apparatus 140 may be in a form of the communication apparatus 400 shown in FIG. 4.

For example, the processor 401 in the communication apparatus 400 shown in FIG. 4 may invoke the computer-executable instructions stored in the memory 403, to enable the communication apparatus 400 to perform the communication methods in the foregoing method embodiments.

Specifically, functions/implementation processes of the transceiver module 1401 and the processing module 1402 in FIG. 14 may be implemented by the processor 401 in the communication apparatus 400 shown in FIG. 4 by invoking the computer-executable instructions stored in the memory 403. Alternatively, a function/an implementation process of the processing module 1402 in FIG. 14 may be implemented by the processor 401 in the communication apparatus 400 shown in FIG. 4 by invoking the computer-executable instructions stored in the memory 403, and a function/an implementation process of the transceiver module 1401 in FIG. 14 may be implemented by the communication interface 404 in the communication apparatus 400 shown in FIG. 4.

Because the second apparatus 140 provided in this embodiment may perform the foregoing methods, for technical effects that can be achieved by the second apparatus 140, refer to the foregoing method embodiments. Details are not described herein again.

It should be understood that one or more of the modules or units may be implemented by software, hardware, or a combination thereof. When any one of the modules or units is implemented by software, the software exists in a form of computer program instructions, and is stored in a memory, and a processor may be configured to execute the program instructions and implement the foregoing method procedures. The processor may be built into a SoC (system on a chip) or an ASIC, or may be an independent semiconductor chip. In addition to a core configured to perform calculation or processing by executing software instructions, the processor may further include a necessary hardware accelerator, for example, a field programmable gate array (FPGA), a PLD (programmable logic device), or a logic circuit that implements a dedicated logic operation.

When the foregoing modules or units are implemented by hardware, the hardware may be any one or any combination of a CPU, a microprocessor, a digital signal processing (DSP) chip, a microcontroller unit (MCU), an artificial intelligence processor, an ASIC, a SoC, an FPGA, a PLD, a dedicated digital circuit, a hardware accelerator, or a non-integrated discrete component, and the hardware may run necessary software or does not depend on software, to perform the foregoing method procedures.

Optionally, an embodiment of this application further provides a communication apparatus (for example, the communication apparatus may be a chip or a chip system). The communication apparatus includes a processor, configured to implement the method in any one of the foregoing method embodiments. In a possible design, the communication apparatus further includes a memory. The memory is configured to store necessary program instructions and necessary data. The processor may invoke program code stored in the memory, to instruct the communication apparatus to perform the method in any one of the foregoing method embodiments. Certainly, the communication apparatus may not include a memory. When the communication apparatus is a chip system, the communication apparatus may include a chip, or may include a chip and another discrete component. This is not specifically limited in this embodiment of this application.

In a possible implementation, an embodiment of this application further provides a computer-readable storage medium. The computer-readable storage medium stores a computer program or instructions. When the computer program or instructions are run on a communication apparatus, the communication apparatus is enabled to perform the method in any one of the foregoing method embodiments or the implementations of the foregoing method embodiments.

In a possible implementation, an embodiment of this application further provides a communication system. The communication system includes the first apparatus in the foregoing method embodiments and the management network element in the foregoing method embodiments. Further, optionally, the communication system further includes the second apparatus in the foregoing method embodiments.

In a possible implementation, an embodiment of this application further provides a communication method. The communication method includes the method in any one of the foregoing method embodiments or the implementations of the foregoing method embodiments.

All or some of the foregoing embodiments may be implemented by software, hardware, firmware, or any combination thereof. When a software program is for implementing embodiments, embodiments may be implemented completely or partially in a form of a computer program product. The computer program product includes one or more computer instructions. When the computer program instructions are loaded and executed on a computer, all or some of the procedures or functions according to embodiments of this application are generated. The computer may be a general-purpose computer, a special-purpose computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

Although this application is described with reference to embodiments, in a process of implementing this application that claims protection, a person skilled in the art may understand and implement another variation of disclosed embodiments by viewing the accompanying drawings, disclosed content, and the appended claims. In the claims, “comprising” does not exclude another component or another step, and “a” or “one” does not exclude a case of multiple. A single processor or another unit may implement several functions enumerated in the claims. Some measures are recorded in dependent claims that are different from each other, but this does not mean that these measures cannot be combined to produce a good effect.

Although this application is described with reference to specific features and embodiments thereof, it is clear that various modifications and combinations may be made to them without departing from the spirit and scope of this application. Correspondingly, the specification and accompanying drawings are merely example descriptions of this application defined by the appended claims, and are considered as covering any or all of modifications, variations, combinations or equivalents within the scope of this application. It is clear that a person skilled in the art can make various modifications and variations to this application without departing from the spirit and scope of this application. This application is intended to cover these modifications and variations of this application provided that they fall within the scope of the claims of this application and their equivalent technologies.

1. A resource allocation method, comprises:
determining a scaling factor of a frequency domain resource allocation unit; and
determining a size of the frequency domain resource allocation unit based on the scaling factor and a preconfigured size of the frequency domain resource allocation unit.

2. The resource allocation method according to claim 1, wherein the scaling factor is preconfigured, or the scaling factor is indicated.

3. The resource allocation method according to claim 1, wherein determining the scaling factor of the frequency domain resource allocation unit includes:
determining the scaling factor from a candidate scaling factor set based on a configured frequency range (FR) or a configured subcarrier spacing (SCS), wherein the candidate scaling factor set includes at least two scaling factors.

4. The resource allocation method according to claim 3, wherein determining the scaling factor from the candidate scaling factor set based on the configured FR or the configured SCS includes:
determining the scaling factor from the candidate scaling factor set based on a correspondence between the FR and the scaling factor and/or a correspondence between the SCS and the scaling factor.

5. The resource allocation method according to claim 1, wherein the size of the frequency domain resource allocation unit is a granularity of frequency domain resource allocation, and the scaling factor is a ratio between an actual granularity of the frequency domain resource allocation and a preconfigured granularity of the frequency domain resource allocation.

6. The resource allocation method according to claim 1, wherein the frequency domain resource allocation unit is a resource block (RB) or a resource block group (RBG).

7. The resource allocation method according to claim 1, wherein a value of the scaling factor is greater than 1.

8. A resource allocation method, comprises:
determining a size of a frequency domain resource allocation unit;
generating indication information, wherein the indication information is usable to indicate a scaling factor of the frequency domain resource allocation unit; and
sending the indication information.

9. The resource allocation method according to claim 8, wherein the indication information includes first indication information and second indication information, the first indication information is usable to indicate a candidate scaling factor set, the second indication information is for determining the scaling factor from the candidate scaling factor set, and the candidate scaling factor set includes at least two scaling factors.

10. The resource allocation method according to claim 9, wherein the first indication information is carried in radio resource control (RRC) signaling, and the second indication information is carried in downlink control information (DCI) or a media access control control element (MAC CE).

11. The resource allocation method according to claim 10, wherein the second indication information is carried in 2^{nd}-stage DCI.

12. The resource allocation method according to claim 8, wherein the indication information is carried in an RRC setup message, an RRC resume message, or an RRC reconfiguration message.

13. The resource allocation method according to claim 8, wherein the size of the frequency domain resource allocation unit is a granularity of frequency domain resource allocation, and the scaling factor is a ratio between an actual granularity of the frequency domain resource allocation and a preconfigured granularity of the frequency domain resource allocation.

14. The resource allocation method according to claim 8, wherein the frequency domain resource allocation unit is a resource block (RB) or a resource block group (RBG).

15. The resource allocation method according to claim 8, wherein a value of the scaling factor is greater than 1.

16. A communication apparatus, comprises a processing module, wherein
the processing module is configured to determine a scaling factor of a frequency domain resource allocation unit; and
the processing module is further configured to determine a size of the frequency domain resource allocation unit based on the scaling factor and a preconfigured size of the frequency domain resource allocation unit.

17. The communication apparatus according to claim 16, wherein the scaling factor is preconfigured, or the scaling factor is indicated.

18. The communication apparatus according to claim 16, wherein the processing module is further configured to determine the scaling factor from a candidate scaling factor set based on a configured frequency range (FR) or a configured subcarrier spacing (SCS), wherein the candidate scaling factor set includes at least two scaling factors.

19. The communication apparatus according to claim 18, wherein the processing module is further configured to determine the scaling factor from the candidate scaling factor set based on a correspondence between the FR and the scaling factor and/or a correspondence between the SCS and the scaling factor.

20. The communication apparatus according to claim 16, wherein the size of the frequency domain resource allocation unit is a granularity of frequency domain resource allocation, and the scaling factor is a ratio between an actual granularity of the frequency domain resource allocation and a preconfigured granularity of the frequency domain resource allocation.
